(19) United States
(12) Patent Application Publication
(10) Pub. No.: US 2007/0263669 A1
(43) Pub. Date: Nov. 15, 2007

(54) NETWORKABLE DECODER

(75) Inventors: Michael A. Maginity, Greencastle, IN (US); Allen J. Studer, Indianapolis, IN (US)

Correspondence Address: BARNES & THORNBURG LLP, 11 SOUTH MERIDIAN, INDIANAPOLIS, IN, 46204, US

(73) Assignee: TRILITHIC, INC., Indianapolis, IN (US)

(21) Appl. No.: 11/682,337

(22) Filed: Mar. 6, 2007

Related U.S. Application Data
(60) Provisional application No. 60/789,500, filed on Apr. 5, 2006.

(51) Int. Cl. H04J 3/06

(52) U.S. Cl. 370/503

(57) ABSTRACT

A method and apparatus for delivering a decoded first signal related to a current or predicted condition of a geographic area across a network serving the geographical area to user apparatus. The network includes a headend, at least one source for providing an undecoded first signal related to the current or predicted condition of the geographic area, at least one decoder and at least one encoder. The method comprises decoding the first signal, transmitting the decoded first signal across the network, receiving the decoded first signal and generating a second signal for transmitting across the network to user apparatus in the geographic area. The apparatus and methods permit the collection of information, bringing of the information to a common point, decoding of the information if necessary, and distribution of the information to the appropriate address(es) on the network to which data can be addressed, received, assembled and displayed or played back. Networks of this type include, for example, CATV (cable) systems and IPTV.

### CROSS-REFERENCE TO RELATED APPLICATIONS

This regular utility patent application claims benefit under 35 U. S. C. §119(e) to U.S. Ser. No. 60/789,500 filed Apr. 5, 2006. The disclosure of U.S. Ser. No. 60/789,500 is incorporated herein by reference.

### FIELD OF THE INVENTION

This invention is disclosed in the context of an improved method and apparatus for handling emergency alert system (hereinafter sometimes EAS) signals within a network. It is disclosed in the context of a CATV (hereinafter sometimes cable television, or cable) system. However, it is believed to be useful in other applications, such as Internet Protocol Television (hereinafter sometimes IPTV), and other service providers as well.

### BACKGROUND OF THE INVENTION

Governments typically mandate that emergency alert facilities be made available by, among others, licensed communications carriers such as broadcasters, CATV (hereinafter sometimes cable television, or cable) operators, providers of data transmission (for example, Internet and IPTV) services, and the like. In the U.S., for example, many FCC licensed carriers must provide EAS compatibility to permit the transmission of emergency information in the event of for example, natural catastrophe, such as earthquake, flood, fire, or the like. Reference is here made to 47 C. F. R., Part 11 for further explanation of FCC requirements.

The following illustrate and describe a number of different methods and apparatus for displaying messages of various types, including emergency messages, on video displays: U.S. Pat. Nos. 3,860,746; 3,891,792; 3,975,583; 4,015,074; 4,155,042; 4,331,973; 4,331,974; 4,439,784; 4,476,488; 4,616,214; 4,658,290; 4,887,152; 5,027,208; 5,027,211; 5,121,430; 5,140,419; 5,260,778; 5,495,283; and, 6,020,913. There are also the systems illustrated and described in: Dynatech Cable Products Group, ACM, All Channel Message System, Operations Manual, Jun. 24, 1992 Revision 3; Quanta Corporation, QCG-38 Specifications, 2 pages; Chyron Corporation, The Chyron ACG, A product of The Chyron Group, brochure, 1989, 2 sheets, 4 pages; TV Technology, Frontline Develops Digital EAS by Lauren Rooney, newspaper article, Apr. 24, 1997; TV Technology, CG Design and Application by Dennis Hamilton, newspaper article, Apr. 24, 1997; Laird Telemedia Inc., Price List—Apr. 1, 1988, Graphics Products, 2 pages; Laird The Telemedia Company, brochure, March 1988, 4 sheets, 7 pages; Quanta Pocket Price List, Effective Apr. 28, 1989, 2 pages; and, Comments of the Society of Cable Television Engineers, Before the Federal Communications Commission, Washington, D.C. 20554, Jan. 15, 1993. The disclosures of these references are hereby incorporated herein by reference. The above listing is not intended to be a representation that a complete search of all relevant art has been made, or that no more pertinent art than that listed exists, or that the listed art is material to patentability. Nor should any such representation be inferred.

With consolidations among cable systems, a cable system can extend from a headend to locations several tens to hundreds of miles remote from the headend. Consequently, Emergency Alert System signals can be received some distance from the headend. EAS signals may be required to be transmitted to the headend from other locations which are geographically remote, but coupled to the network.

### DISCLOSURE OF THE INVENTION

According to an aspect of the invention, a network serves a geographical area. The network includes a headend, and at least one source for providing a first signal related to a current or predicted condition of the geographic area. An apparatus according to this aspect of the invention further includes a decoder for decoding the first signal. The decoder transmits the decoded first signal across the network. The apparatus according to this aspect of the invention further includes an encoder for receiving the decoded first signal from the network, and generating a second signal for transmitting across the network to user apparatus in the geographic area for reproduction by the user apparatus.

Illustratively according to this aspect of the invention, the decoder provides the capability for the encoder to request at least one of an audio file and audio packets.

Illustratively according to this aspect of the invention, the decoder is adapted to determine if the first signal is valid, and if the decoder determines that the first signal is not valid, not to transmit the decoded first signal across the network.

Illustratively according to this aspect of the invention, the decoder is adapted to determine if the first signal is a duplicate of a previously received first signal, and if the decoder determines that the first signal is a duplicate, not to transmit the decoded first signal across the network.

Illustratively according to this aspect of the invention, the decoder is adapted to permit at least one parameter to be established, and if the decoder determines that the received first signal does not meet the established at least one parameter, not to transmit the decoded first signal across the network.

Illustratively, the at least one parameter is at least one of a specific geographical area and a specific event.

Illustratively according to this aspect of the invention, the decoder includes memory for storing the at least one parameter and maintaining a log of received first signals.

Illustratively according to this aspect of the invention, the apparatus further includes a computer coupled to the network. The at least one parameter is provided to the decoder from the computer.

Illustratively according to this aspect of the invention, the decoder is adapted to run a web server. The network is coupled to the Internet. The at least one parameter is provided to the decoder via the web server.

Illustratively according to this aspect of the invention, the decoder is adapted to record an audio first signal.

Illustratively according to this aspect of the invention, the apparatus includes multiple encoders serving different geographical areas. The decoder is adapted to determine which of the multiple encoders serves the geographical area to which a first signal received by the decoder relates and transmit the decoded first signal across the network to that encoder.

Illustratively according to this aspect of the invention, the decoder is adapted to determine if the encoder is conditioned to receive the decoded first signal and generate the second signal for transmitting across the network to user apparatus in the geographic area, and if the decoder determines that the encoder is not conditioned to receive the decoded first signal and generate the second signal for transmitting across the network to user apparatus in the geographic area, the decoder is adapted to queue the decoded first signal.

Illustratively according to this aspect of the invention, the decoder is adapted to queue the decoded first signal until at least one of the following events transpires: a subsequent first signal having greater priority than said first signal is received; the encoder is conditioned to receive the decoded first signal; and, a time stamp associated with the first signal expires.

Illustratively according to this aspect of the invention, the decoder is adapted to respond to a request by the encoder for a decoded first signal by sending the requested decoded first signal over the network to the encoder.

Illustratively according to this aspect of the invention, the decoder includes memory for maintaining a log of received first signals.

Illustratively according to this aspect of the invention, the apparatus is adapted to decode Frequency Shift Keying.

Illustratively according to this aspect of the invention, the apparatus is adapted to decode Dual Tone Multi-Frequency (DTMF) tones.

Illustratively according to this aspect of the invention, the apparatus is adapted to decode a sensor input via an analog-to-digital (A/D) converter.

Illustratively according to this aspect of the invention, the decoder is coupled to the network through an Ethernet port.

Illustratively according to this aspect of the invention, the network includes multiple branches. Each branch includes at least one source for providing a first signal related to a current or predicted condition of the geographic area served by that branch. Each branch includes a decoder for decoding first signals from the at least one source for providing first signals related to a current or predicted condition of the geographic area served by that branch. The decoder transmits the decoded first signal from the at least one source for providing first signals related to a current or predicted condition of the geographic area served by that branch across the network. The apparatus further includes an encoder for receiving the decoded first signal and generating a second signal for transmitting across the network to user apparatus in the geographic area for reproduction by the user apparatus.

According to another aspect of the invention, a method is provided for delivering a decoded first signal related to a current or predicted condition of a geographic area across a network serving the geographical area to user apparatus. The network includes a headend, and at least one source for providing an undecoded first signal related to the current or predicted condition of the geographic area. The method comprises decoding the first signal, transmitting the decoded first signal across the network, receiving the decoded first signal, generating a second signal for transmitting across the network to user apparatus in the geographic area and reproducing the second signal on the user apparatus.

Illustratively according to this aspect of the invention, the method includes requesting at least one of an audio file and audio packets.

Illustratively according to this aspect of the invention, the method includes determining if the first signal is valid, and if the first signal is determined not to be valid, not transmitting the decoded first signal across the network.

Illustratively according to this aspect of the invention, the method includes determining if the first signal is a duplicate of a previously received first signal, and if the first signal is determined to be a duplicate, not transmitting the decoded first signal across the network.

Illustratively according to this aspect of the invention, the method includes permitting at least one parameter to be established, determining whether the received first signal meets the established parameter or parameters, and if the received first signal is determined not to meet the established parameter or parameters, not transmitting the decoded first signal across the network.

Illustratively according to this aspect of the invention, permitting at least one parameter to be established includes permitting at least one of a specific geographical area and a specific event to be established as said at least one parameter.

Illustratively according to this aspect of the invention, the method includes storing the at least one parameter and maintaining a log of received first signals.

Illustratively according to this aspect of the invention, the method further includes providing the at least one parameter to the decoder from a computer.

Illustratively according to this aspect of the invention, the method includes coupling the network to the Internet and providing the at least one parameter to the decoder via a web server.

Illustratively according to this aspect of the invention, the method includes recording an audio first signal.

Illustratively according to this aspect of the invention, receiving the decoded first signal and generating a second signal for transmitting across the network to user apparatus in the geographic area includes providing multiple encoders, each serving different geographical areas, determining which of the multiple encoders serves the geographical area to which a received first signal relates and transmitting the decoded first signal across the network to that encoder.

Illustratively according to this aspect of the invention, the method includes determining if the encoder is conditioned to receive the decoded first signal and generate the second signal for transmitting across the network to user apparatus in the geographic area, and if the encoder is determined not to be in conditioned to receive the decoded first signal and generate the second signal for transmitting across the network to user apparatus in the geographic area, queueing the decoded first signal for subsequent transmission.

Illustratively according to this aspect of the invention, queueing the decoded first signal for subsequent transmission includes queueing the decoded first signal for subsequent transmission until at least one of the following events transpires: a subsequent first signal having greater priority than said first signal is received; the encoder is conditioned to receive the decoded first signal; and, a time stamp associated with the first signal expires.

Illustratively according to this aspect of the invention, the method includes responding to a request by the encoder for a decoded first signal by sending the requested decoded first signal over the network to the encoder.

Illustratively according to this aspect of the invention, the method includes maintaining a log of received first signals.

Illustratively according to this aspect of the invention, the method includes decoding Frequency Shift Keying.

Illustratively according to this aspect of the invention, the method includes coupling the decoder to the network through an Ethernet port.

Illustratively according to this aspect of the invention, the network includes multiple branches. Each branch includes at least one source for providing a first signal related to a current or predicted condition of the geographic area served by that branch. The method includes decoding first signals from the at least one source for providing first signals related to a current or predicted condition of the geographic area served by that branch, transmitting the decoded first signal from the at least one source for providing first signals related to a current or predicted condition of the geographic area served by that branch across the network, receiving the decoded first signal, and generating a second signal for transmitting across the network to user apparatus in the geographic area for reproduction by the user apparatus in the geographic area.

According to another aspect of the invention, a device is provided for receiving at an input port of the device Emergency Alert System (EAS)-formatted information, translating the EAS-formatted information to a second format, and providing the information in the second format at an output port of the device.

Illustratively according to this aspect of the invention, the second format is Transmission Control Protocol/Internet Protocol (TCP/IP).

### BRIEF DESCRIPTION OF THE DRAWINGS

The invention may best be understood by referring to the following description and accompanying drawings which illustrate the invention. In the drawings:

FIG. 1 diagrammatically illustrates a system useful in understanding the apparatus and methods according to the invention;

FIG. 2 diagrammatically illustrates another system useful in understanding the apparatus and method according to the invention;

FIGS. 3a-c illustrate a front elevational view, a rear elevational view, and a left side elevational view, respectively, of an apparatus useful in the system illustrated in FIG. 2;

FIGS. 4a-b diagrammatically illustrate another system useful in understanding the apparatus and methods;

FIG. 5 diagrammatically illustrates another system useful in understanding the apparatus and methods;

FIG. 6 diagrammatically illustrates an apparatus useful in the systems illustrated in FIGS. 1, 2, 4a and 5; and,

FIGS. 7a-k, 8a-d, 9a-g, 10a-f, 11a-e, 12a-d, 13, 14a-b, 15, 16a-i, 17a-h, 18a-i, 19a-f, 20a-c and 21 illustrate block and schematic circuit diagrams of circuits useful in the apparatus and methods.

### DETAILED DESCRIPTIONS OF ILLUSTRATIVE EMBODIMENTS

In a cable system 20, a single cable headend 22 can service a geographical area 24 having a radius in excess of one hundred miles. Systems 20 of this size have difficulty receiving all of the required EAS monitoring stations at a central location 22, and may be required to monitor more monitoring stations than a typical EAS encoder/decoder can handle. A single decoder may present a bottleneck in a geographically widely distributed cable system, resulting in EAS messages being rejected.

A decoder 26 according to the invention permits multiple decoders 26 to be networked together, distributing decoding tasks across all of the networked decoders 26. The networked decoders 26 can be distributed across the cable system 20, permitting monitoring ports 30 to be located wherever EAS signals are present. Any number of monitoring ports 30 can be accommodated by adding decoders 26 at various points throughout the cable system 20. The bottleneck which might otherwise be presented by a single decoder 26 is further reduced by queueing messages in the networked decoders 26 until (an) appropriate encoder(s) 36 or playback device(s) is (are) available.

The decoder 26 meets the requirements of 47 C. F. R., Part 11. The decoder 26 includes at least one EAS monitoring port 30. Illustratively, the decoder 26 includes two EAS monitoring ports 30. Illustratively, the decoder 26 includes a 10/100 BaseT Ethernet port 32. The decoder 26 contacts the encoder(s) 36 via the 10/100 BaseT Ethernet port 32 upon receipt of a valid alert. The monitoring port(s) 30 is (are) configured as (an) internal radio receiver(s) (AM, FM or NOAA), or to receive audio from (an) external audio source(s). Each monitoring port 30 permits up to two minutes of audio to be recorded for playback. All EAS messages are logged to non-volatile memory 40 in decoder 26. A communication protocol is established between the decoder(s) 26 and encoder(s) 36 to provide efficient, failsafe handling and distribution of EAS messages.

The networkable decoder 26 receives EAS messages from its monitoring port(s) 30, records any applicable audio messages and transfers the messages across a network connection 32 to the appropriate encoder device(s) 36. Illustratively, the encoder 36 is a networked encoder 36, such as the EASyPLUS™ networked encoder with Network Interface Card (hereinafter sometimes NIC) board option available from Trilithic, Inc., 9710 Park Davis Drive, Indianapolis, Ind. 46235, http://www.trilithic.com. The illustrative decoder 26 is capable of real-time (simultaneous) decoding of all of its input ports 30. It rejects invalid messages, duplicate messages and messages that do not meet user-selected parameters, such as messages which do not relate to specific locations and events. It records up to two minutes of audio for alert messages that do not use live audio. Upon receipt of a valid EAS message, the decoder 26 contacts, via port 32, the appropriate encoder device(s) 36. If the encoder(s) 36 is (are) not ready to receive the message, the decoder 26 queues the message until either a new message with sufficient priority is received, or until the encoder(s) 36 is (are) able to handle the message, or until the alert expires, whichever occurs first. The decoder 26 provides the capability for the encoder(s) 36 to request an audio file or audio packets (for incoming or live audio of undetermined length). Logs of received EAS messages and configuration parameters are stored in non-volatile memory 40. The decoder 26 can be controlled and configured from either a program running on a Personal Computer 42 (hereinafter sometimes PC) or a web browser.

Frequency Shift Keying (hereinafter sometimes FSK), and the like, and tone decoding are achieved by a decoder 26, for example, an FSK decoder handling 520.83 Hz baud rate, a 2083.3 Hz mark frequency, a 1562.5 space frequency, 7-bit ASCII with a null eighth bit (no start/stop bits), a sixteen byte preamble (ABₕₑₓ) preceding each header for synchronization, an attention tone detector, a National Weather Service 1050 Hz tone detector, and real-time decoding of all input ports 30.

Processing and storage parameters include volatile memory 44 available for run-time program and audio storage, non-volatile memory 40 for firmware, configuration and log storage. Firmware upgrades can be flash programmed, and the decoder 26 configured, both via the Ethernet port 32. The decoder 26 includes a real-time clock 46 with battery 48 backup. The 10/100 BaseT Ethernet port 32 is provided with an RJ-45 connector 50.

Radio receivers 52 include selectable band (AM, FM or NOAA) frequencies and 50Ω F-type connectors 54 for antenna inputs. External inputs 56 include a 600Ω balanced mono input and modular screw terminal connectors 58. Audio recording is available from audio inputs with a minimum of two minutes storage per input port 30.

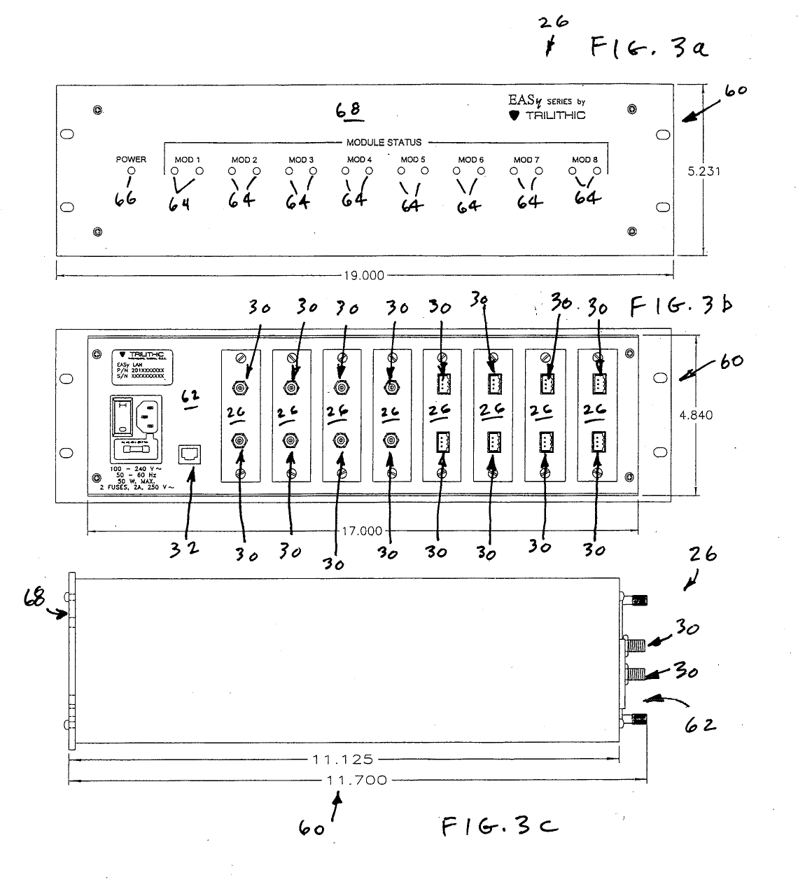

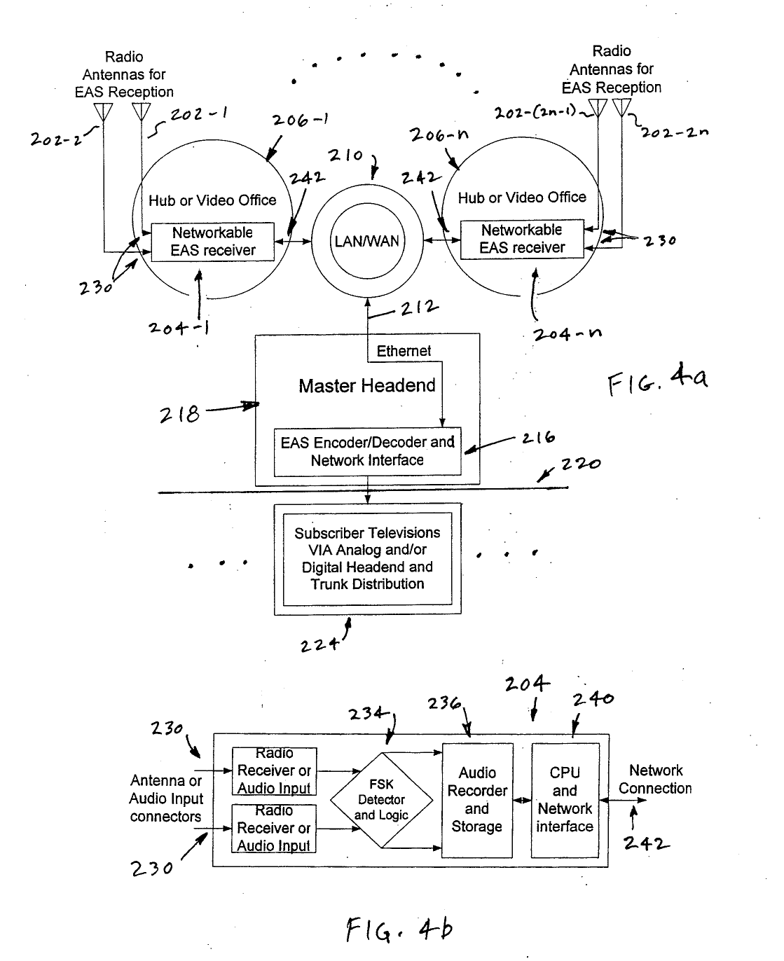

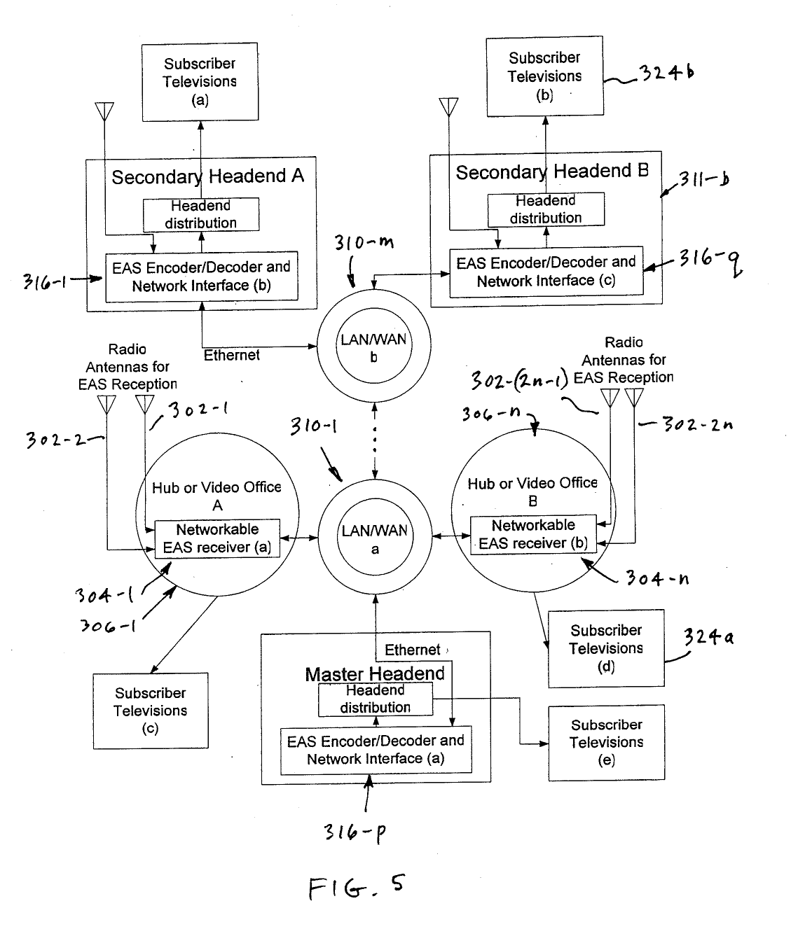

Mechanically, the decoders 26 can be made as stand-alone units, or can be rack-mountable including, for example, a card cage chassis 60 adapted for receiving sixteen monitoring ports 30, (an) internal AC power supply(ies), connectors 50, 54, 58 accessible from the back 62 of the chassis 60, and status and power indicators 64, 66, respectively, readable from the front 68 of the chassis 60. This rack-mountable configuration is illustrated in FIGS. 3a-c.

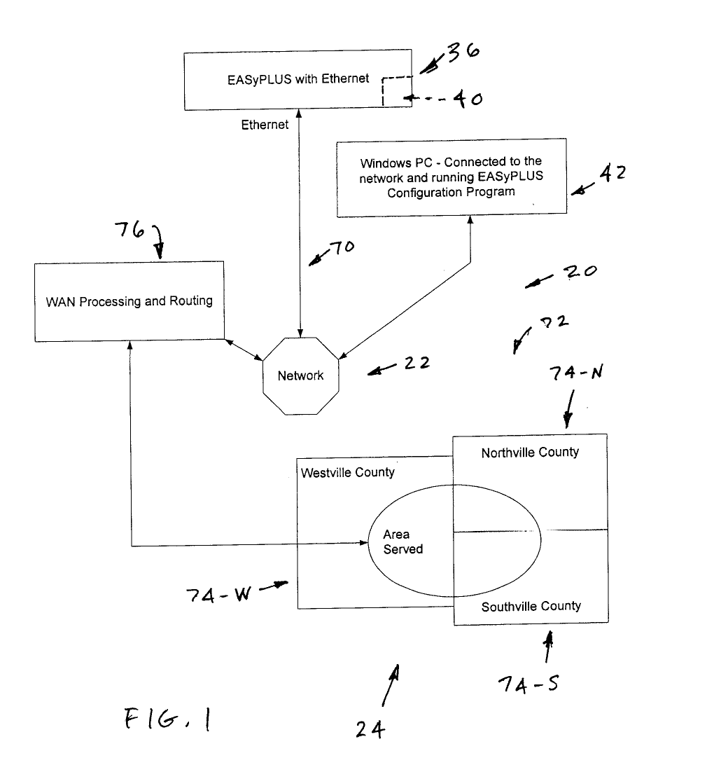

Referring now to FIG. 1, a typical system incorporating the present invention includes an encoder 36, such as an EASyPLUS™ networked encoder with NIC board coupled to the cable system 20. An area 72 served by the cable system 20 resides in at least parts of three adjacent counties 74-N, 74-S and 74-W. Signals are processed and routed by processing and routing equipment 76 in the system 20 from multiplexers serving counties 74-N, 74-S and 74-W to network 20. EAS messages received by decoders 26 in any of 74-N, 74-S and 74-W are thus processed by processing and routing equipment 76 for transport via network 20 to encoder 36. Necessary communication to the service area based upon the received EAS signals is then provided via connection to network 20, and via equipment 76 to terminal apparatus, for example, television receivers, of subscribers who are to receive the EAS signals.

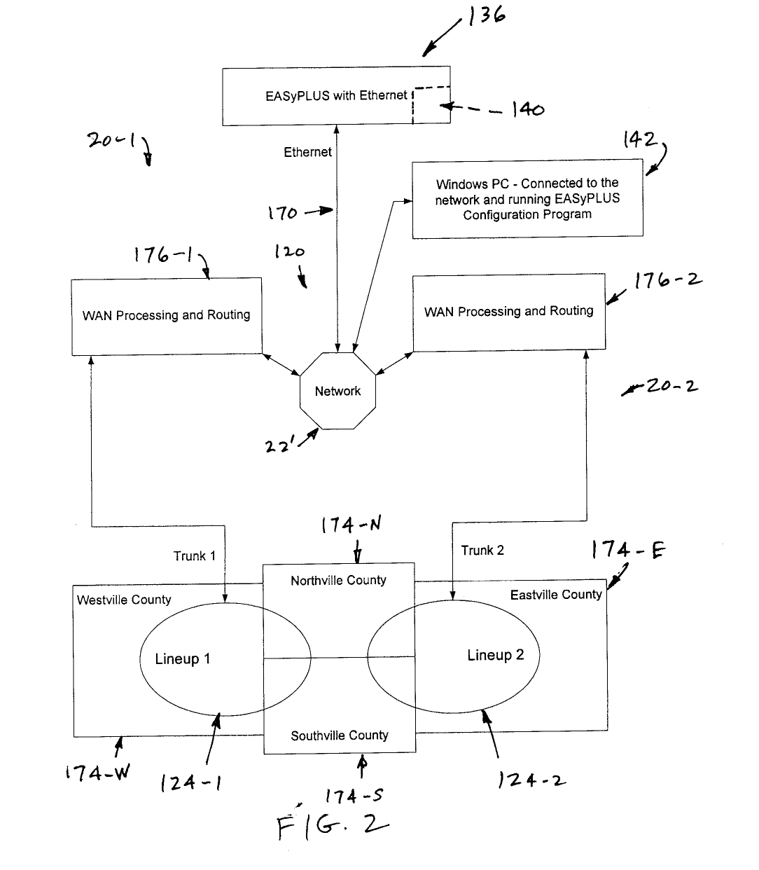

Referring now to FIG. 2, another typical system incorporating the present invention is presented. This system is a two-trunk system in which two separate trunks 20-1 and 20-2, which might be two previously independent or otherwise unconnected cable systems and may include spaced geographical areas 124-1, 124-2, are served from a common headend 22′. The system illustrated in FIG. 2 includes an encoder 136, again, such as an EASyPLUS™ networked encoder with NIC board coupled to the cable systems 120. Illustratively, the encoder 136 is coupled to the PC 142 via RS-232 ports on both. Illustratively, the PC 142 is coupled to the cable system 120 via an Ethernet connection 170 including Ethernet ports on both. An area 124-1 served by trunk 20-1 of cable system 120 resides in at least parts of three adjacent counties 174-N, 174-S and 174-W. An area 124-2 served by trunk 20-2 of cable system 120 resides in at least parts of three adjacent counties 174-N, 174-S and 174-E.

With respect to trunk 20-1, signals are processed and routed by processing and routing equipment 176-1 in trunk 20-1 from multiplexers serving counties 174-N, 174-S and 174-W to network 120. EAS messages received by decoders 26 associated with trunk 20-1 are thus processed by processing and routing equipment 176-1 for transport via network 120 to encoder 136. With respect to trunk 20-2, signals are processed and routed by processing and routing equipment 176-2 in trunk 20-2 from multiplexers serving counties 174-N, 174-S and 174-E to network 120. EAS messages received by decoders 26 in any of 174-N, 174-S and 174-E are thus processed by processing and routing equipment 176-2 for transport via network 120 to encoder 136. Necessary communication to the trunk 20-1 service area and/or the trunk 20-2 service area based upon the received EAS signals is then provided via connection to network 120, and via equipment 176-1 and/or 176-2 to terminal apparatus, for example, television receivers, of subscribers who are to receive the EAS signals.

The illustrated systems collect emergency alert information, bring it to a common point, decode the information, and distribute it to the appropriate address(es) on the network to which data can be addressed, received, assembled and displayed or played back. A cable system is an example of a type of network in which the illustrated systems may function. IPTV is another, as are other systems in which playback devices are addresses on the network to which data can be addressed, received, assembled and displayed or played back. The illustrated systems embody the collection of EAS data over non-EAS networks to (a) central location(s), the collection of EAS data from disparate sources to (a) central location(s), the use of a single EAS decoder to interface with multiple EAS encoders via a non-EAS network, the use of multiple EAS decoders to interface with a single EAS encoder via a non-EAS network, the use of EAS encoders, EAS decoders and EAS encoder/decoders across a point-to-point or point-to-multipoint network, whereby any of the EAS encoders or EAS encoder/decoders can access any of the EAS decoders or EAS encoder/decoders, or any of the EAS decoders or EAS encoder/decoders can access any of the EAS encoders or EAS encoder/decoders for data pertinent to their geographic area(s) of responsibility.

The systems can provide data without the data first having been requested. The systems can provide streaming audio and/or video, for example. The systems include networkable EAS receivers, devices containing one or more audio inputs and one or more radio receivers which are used to monitor the EAS network outlined in 47 C. F. R., Part 11. The devices are capable of decoding EAS FSK for logging, quality assurance and enforcement purposes. The device is capable of understanding and filtering received FSK, and may be used as a component of an EAS decoder. The device is capable of transporting its audio inputs across a digital network. The device is capable of storing audio to avoid EAS messages being discarded at the EAS encoder/decoder due to “bottlenecking.” The device is capable of storing information about the incoming audio, including EAS FSK information. The device is capable of communicating audio, configuration, and other data over a digital medium such as Ethernet. The device contains a processor that can be programmed to combine intelligently all of its other capabilities. The device comprises an EAS radio receiver and/or audio input device which exists on a network geographically independent of the EAS encoder/decoder. The device is capable of remote storage of EAS audio (including the voice portion of an EAS message) to be held until a certified encoder/decoder can retrieve the audio for retransmission. The device can be used as a component part of an FCC certified EAS encoder/decoder. This component part can be physically separated on the network from remaining components of the certified EAS encoder/decoder. The device need not be used with an EAS encoder. Rather, it can be used to log EAS transmissions, and/or for quality assurance and/or dissemination verification purposes. The device can be used to provide an independent archive of EAS messages sent over a given radio/audio channel. The device may be used to decentralize EAS receivers in systems which are inherently centralized, and which may cover geographic areas wider than commercial radio broadcasts are able to be received. The device may be used to enable EAS encoder/decoders located at or beyond the “fringe area” of EAS local programming radio stations to receive messages from those stations. The device may be used to provide EAS inputs to more than one EAS encoder/decoder, as opposed to one radio receiver/audio input for each EAS encoder/decoder. The device may be used to provide non-EAS emergency devices or networks with EAS information, such as, for example, providing cell phone services with EAS alerts via Common Alerting Protocol or other EAS or non-EAS protocol. The device may be used to provide an economical EAS network to Internet interface.

Another typical system 200 is illustrated in FIG. 4a. Radio antennas 202-1, 2, . . . (2n-1), 2n (n an integer) for EAS reception are coupled to networkable EAS receivers 204-1, . . . 204-n at respective hubs or video offices 206-1, . . . 206-n. The networkable EAS receivers 204-1, . . . 204-n are coupled by any suitable means to the Local Area Network and/or Wide Area Network (hereinafter sometimes LAN/WAN) 210. The LAN/WAN 210 is coupled via Ethernet connection 212 to an EAS encoder/decoder and network interface 216, such as an EASyPLUS™ networked encoder with NIC board, in a master headend 218. The EAS encoder/decoder and network interface 216 is coupled via analog and/or digital headend and trunk distribution equipment 220 to subscriber televisions 224.

Referring to FIG. 4b, each networkable EAS receiver 204 includes antenna or audio input connectors 230 for coupling the radio antennas 202-1, 2, . . . (2n-1), 2n, respectively, for EAS reception to an FSK detector and logic 234. The output of the FSK detector and logic 234 is coupled to an audio recorder and storage 236. The output of audio recorder and storage 236 is coupled to a CPU and network interface 240. The output of CPU and network interface 240 is coupled via a network connection 242 to the LAN/WAN 210.

Another embodiment is illustrated in FIG. 5. Radio antennas 302-1, 2, . . . (2n-1), 2n are coupled to respective networkable EAS receivers 304-1, . . . 304-n at respective hubs or video offices 306-1, . . . 306-n. The signals received by such antennas 302 are decoded by the respective FSK detector and logic 234 (see FIG. 4b), recorded by the respective audio recorders and storage 236, and passed to the respective CPUs and network interfaces 240. The thus processed signals are then coupled via their respective network connections 242 to the LAN/WAN 310-1. Messages are transmitted via the LAN/WAN 310-1 and the interconnected LAN/WANs 310-2, . . . 310-m (m an integer) to all listening encoder/decoder/network interfaces 316-1, 316-2, . . . 316-q (q an integer) on the LAN/WANs 310-1, 310-2, . . . 310-m. An illustrative messaging sequence might proceed as follows. An EAS message is received (off air) from a radio station by networkable EAS receiver 304-n. The EAS message contains information pertinent to counties in the area of secondary headend 311-b and hub or video office 306-n. The networkable EAS receiver 304-n decodes the data portion of the message and recognizes that the message contains information pertinent to counties in its service area. Networkable EAS receiver 304-n stores the incoming alert audio. Networkable EAS receiver 304-n transmits via LAN/WANs 310-2, . . . 310-m a short message to all listening encoder/decoder/network interfaces A short alert message is then transmitted via the LAN/WAN 310-1 and the interconnected LAN/WANs 310-2, . . . 310-m (m an integer) to all listening encoder/decoder/network interfaces 316-1, 316-2, . . . 316-q. The short alert message alerts all listening encoder/decoder/network interfaces 316-1, 316-2, . . . 316-q on the LAN/WANs 310-1, 310-2, . . . 310-m that a new message is available for processing. EAS encoder/decoder/network interfaces 316-1, 316-2, . . . 316-q receive the short alert message and ask via the LAN/WANs 310-1, 310-2, . . . 310-m for the data portion of the new message. EAS encoder/decoder/network interface 316-p which handles the channels for hub or video office 306-n, requests and receives the entire EAS message and audio from networkable EAS receiver 304-n and distributes the message to subscriber televisions 324-a. EAS encoder/decoder/network interface 316-1 recognizes that the message is not pertinent to its region, and disregards the message. EAS encoder/decoder/network interface 316-q requests and receives the entire EAS message and audio from networkable EAS receiver 304-n and distributes the message to subscriber televisions 324-b.

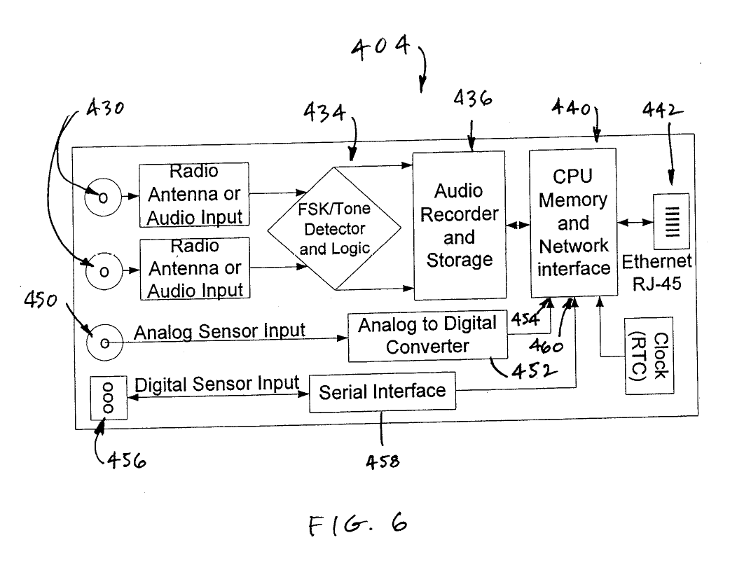

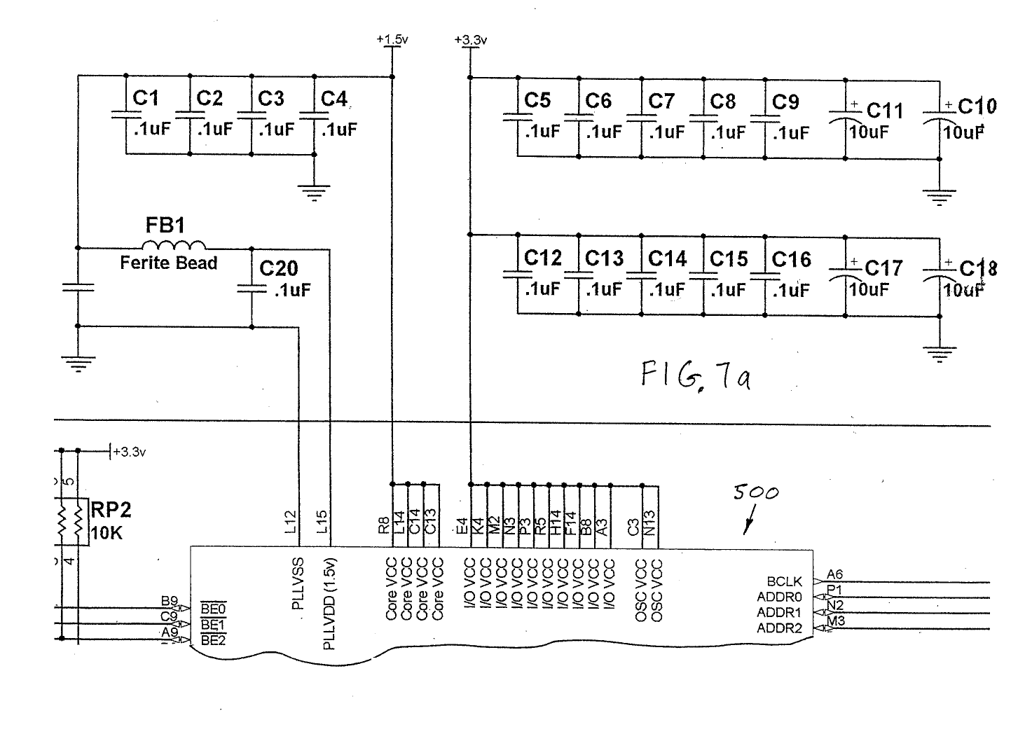

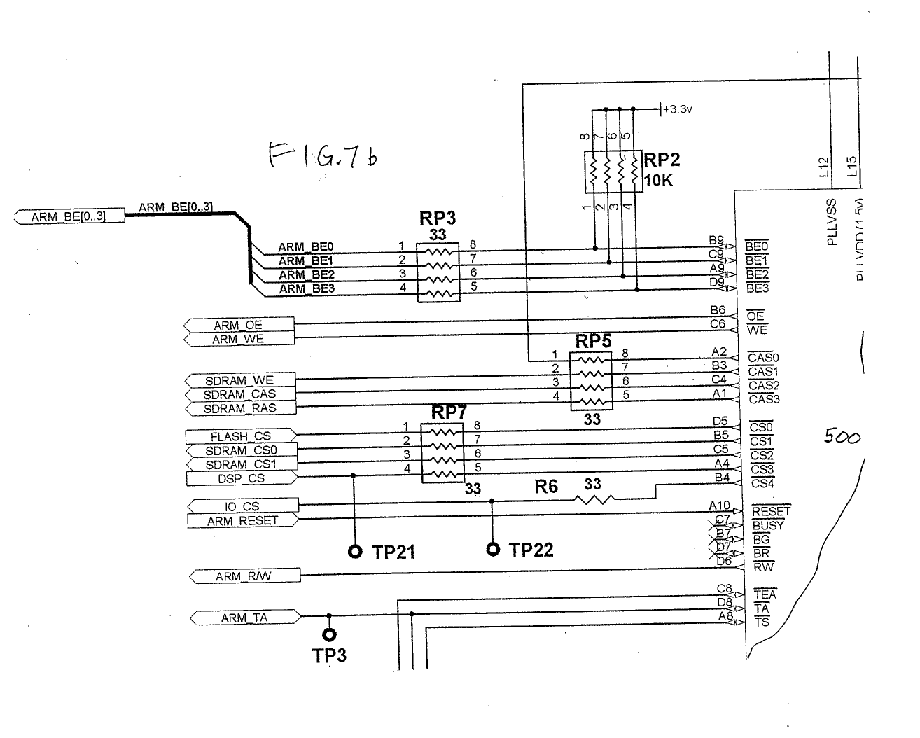

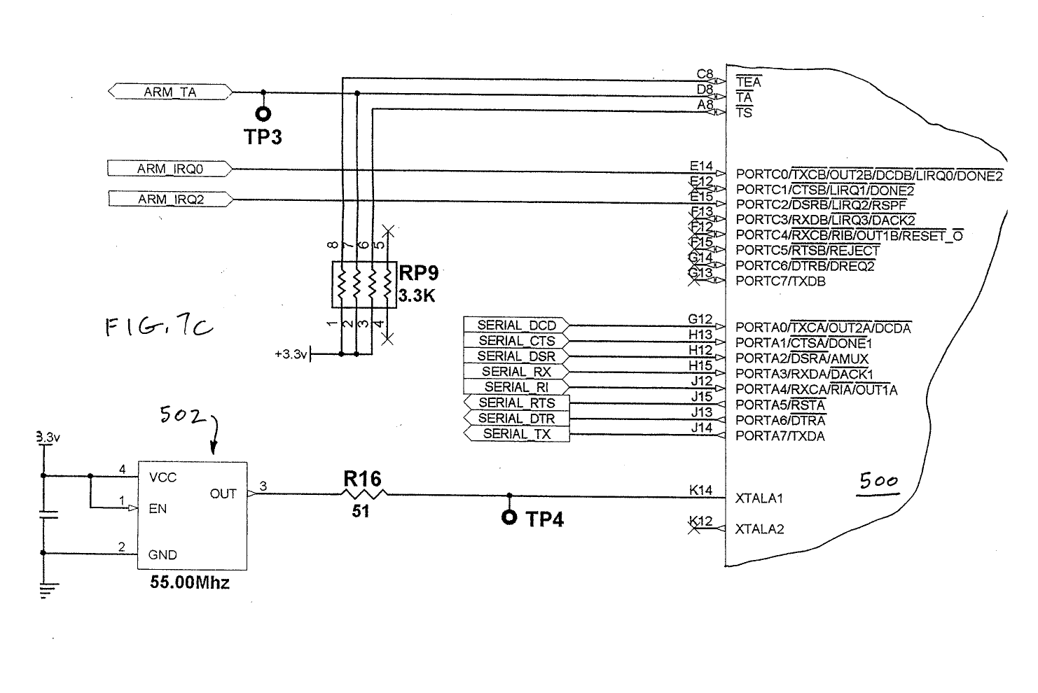

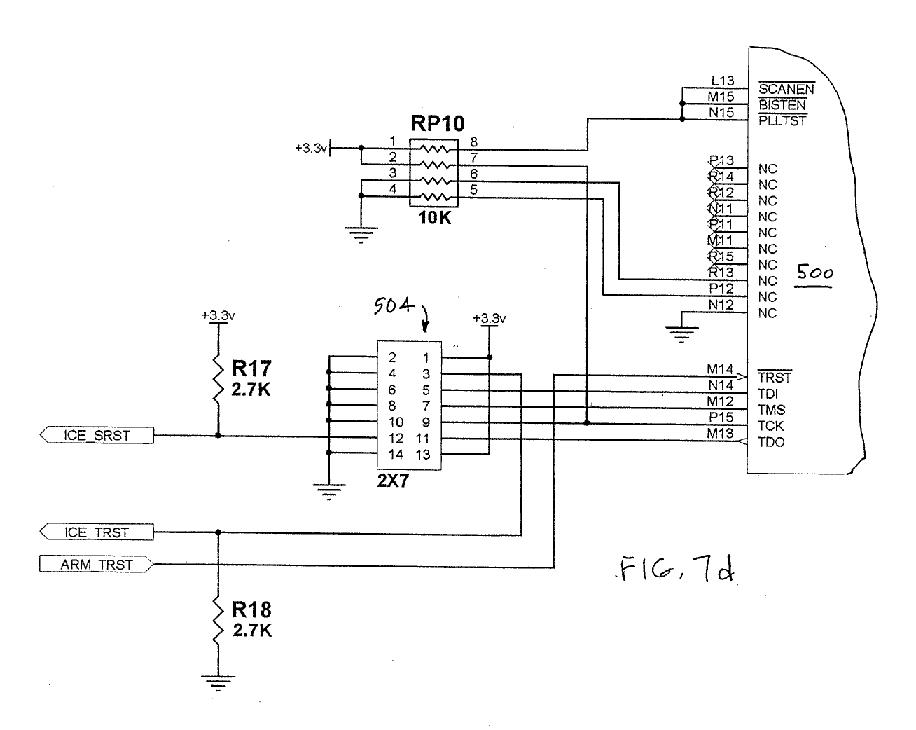

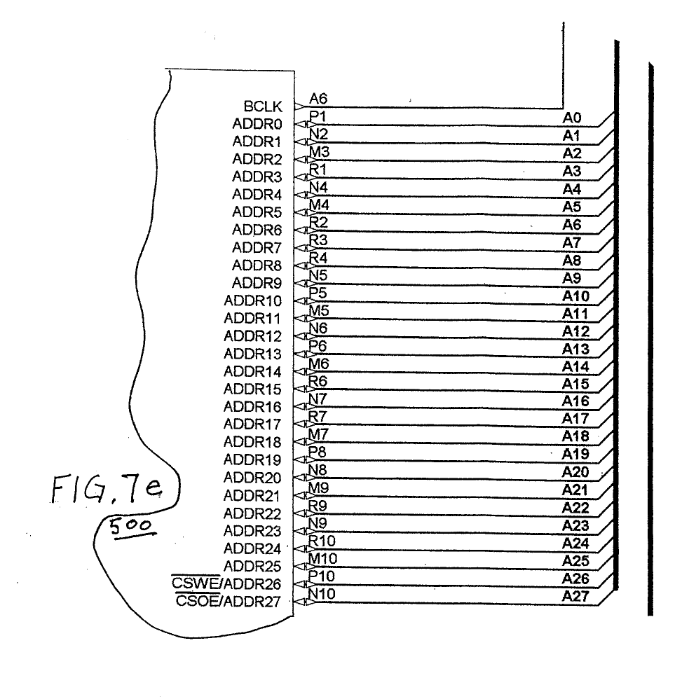

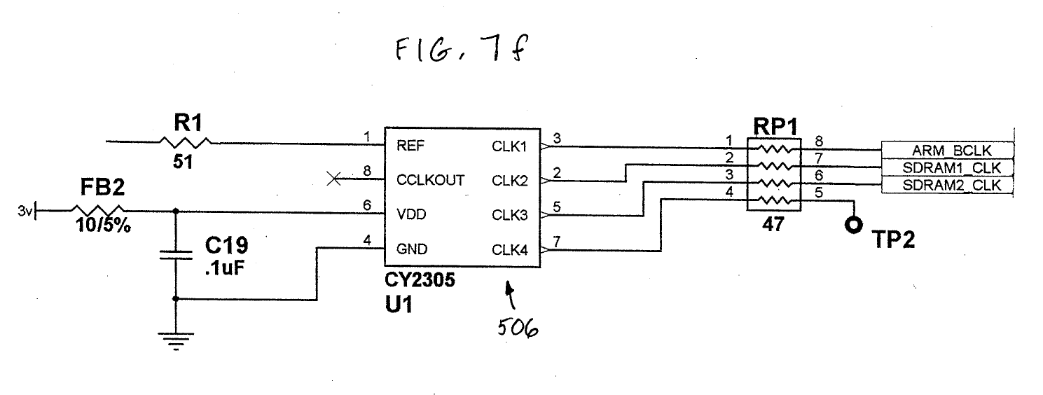

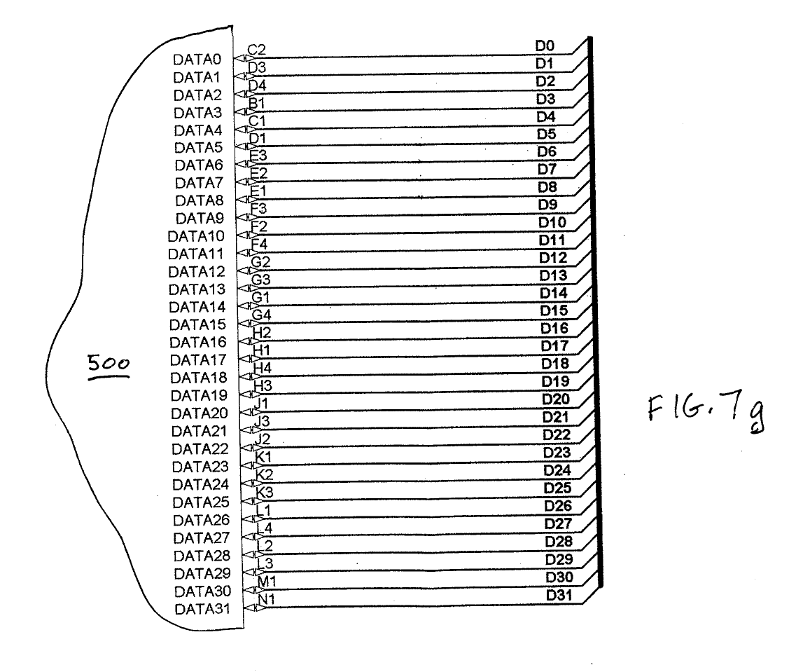

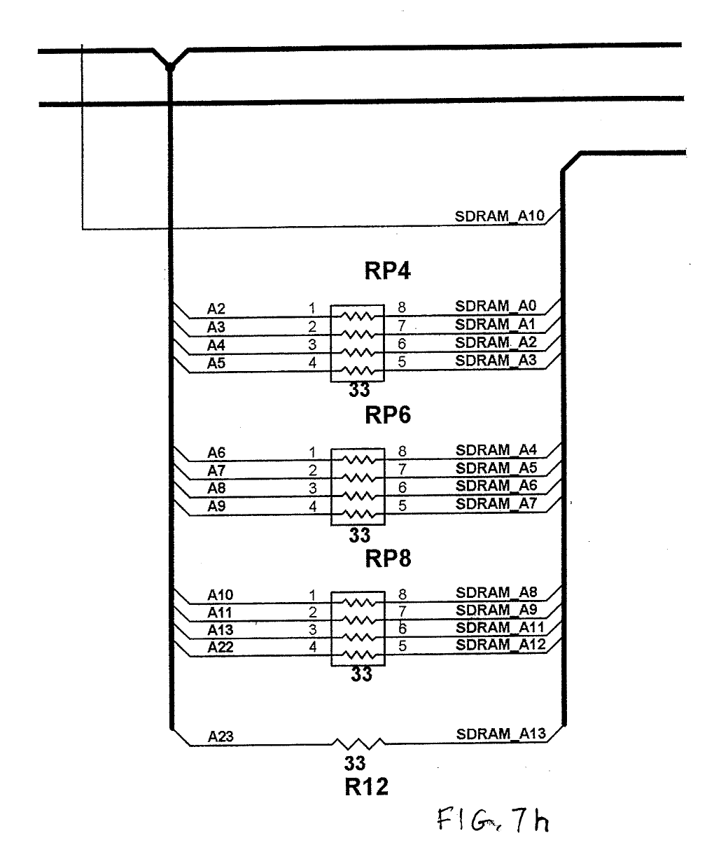

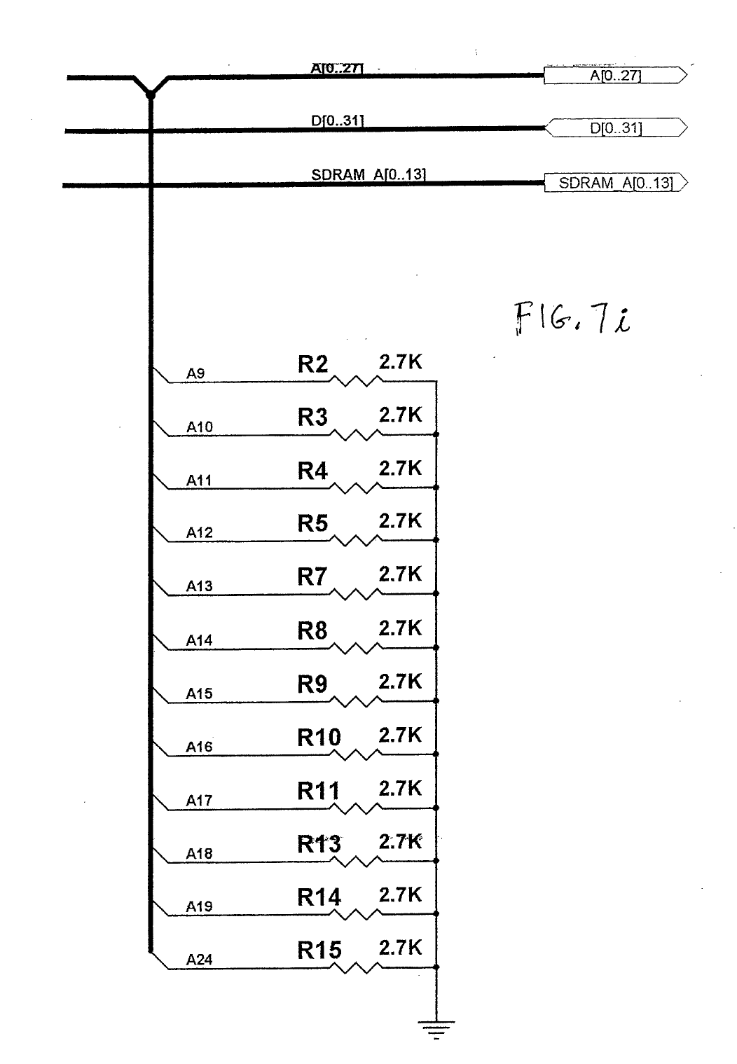

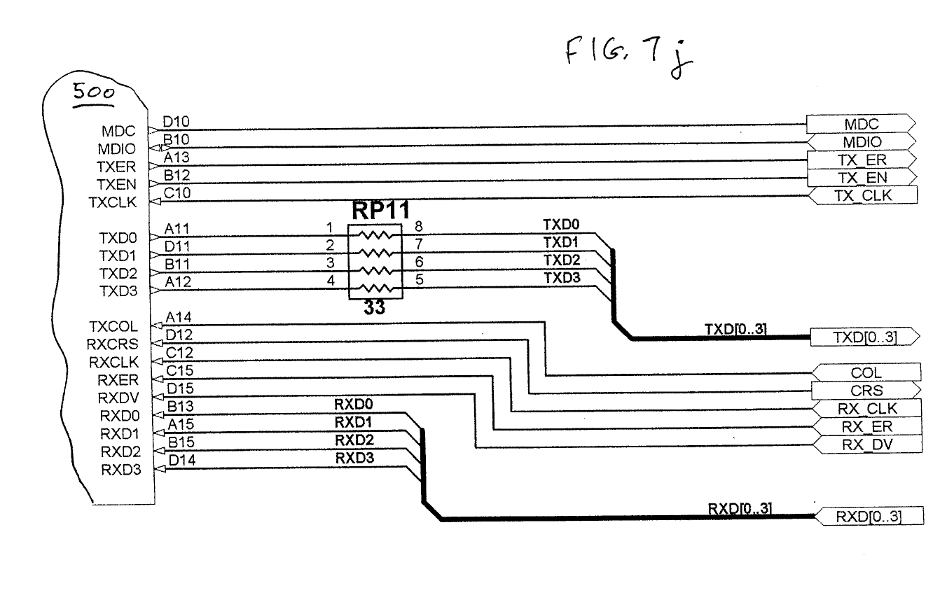

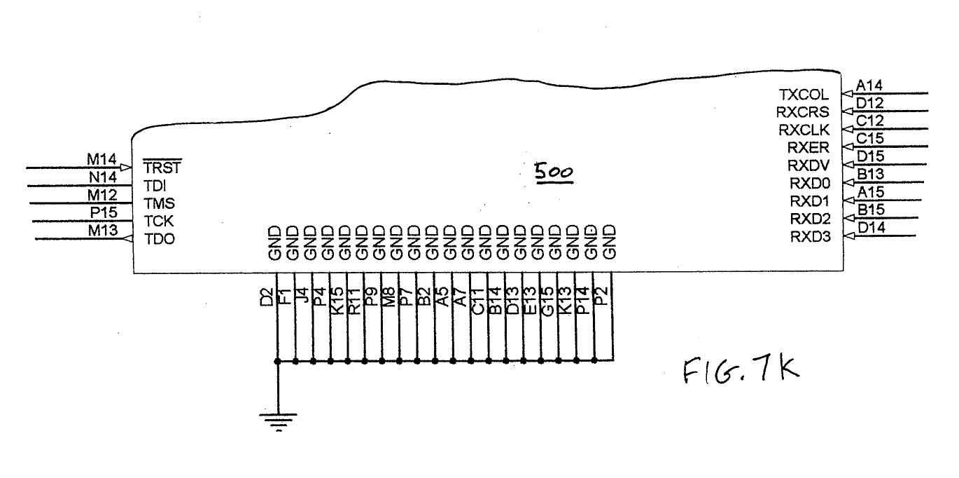

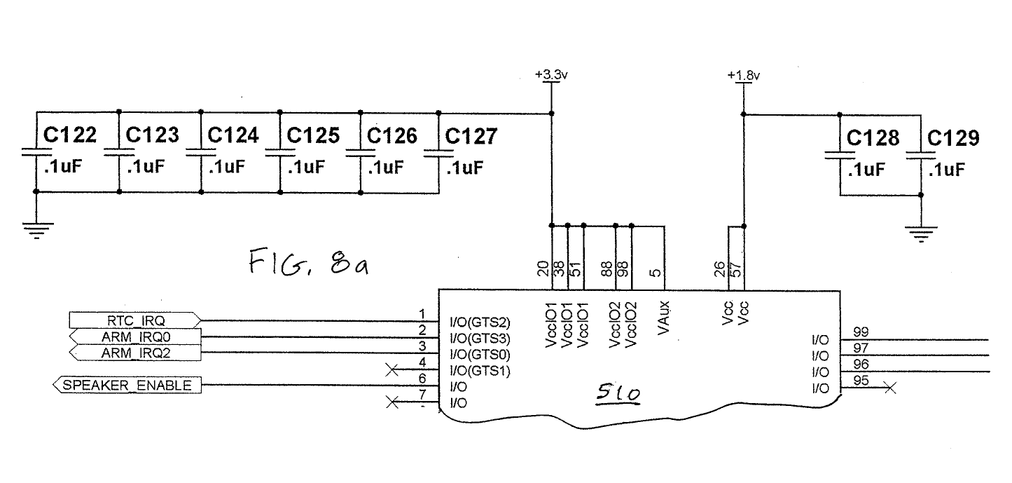

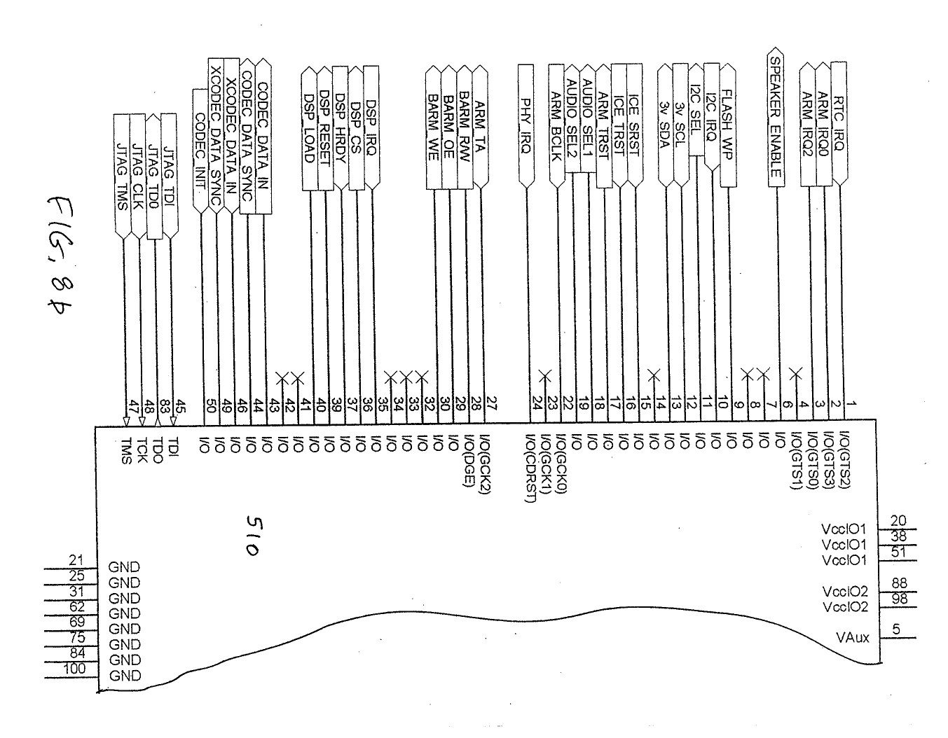

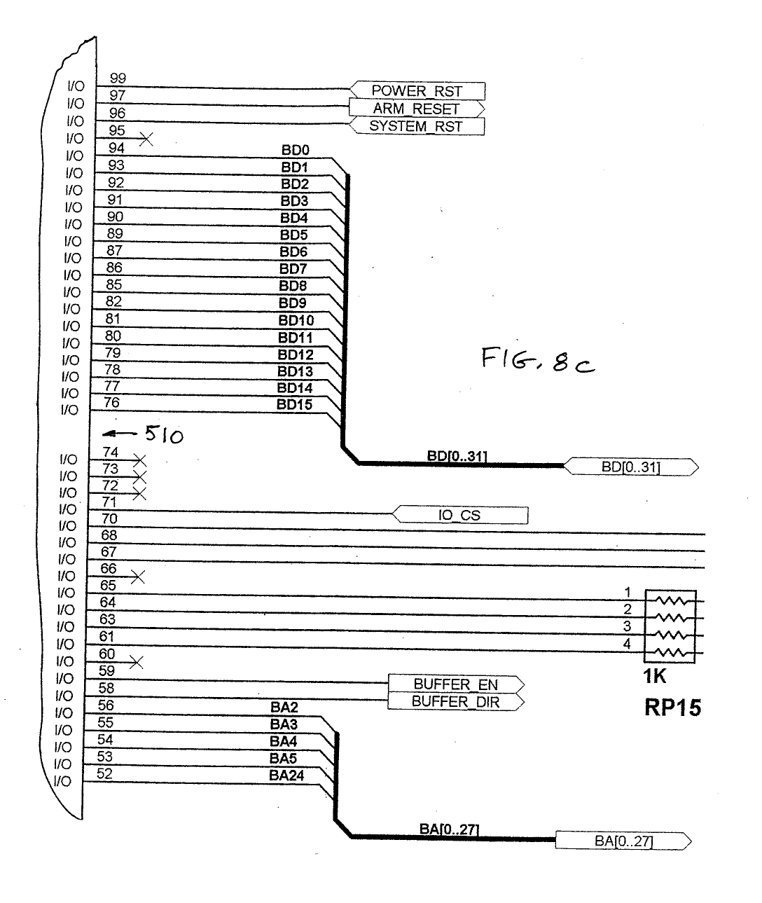

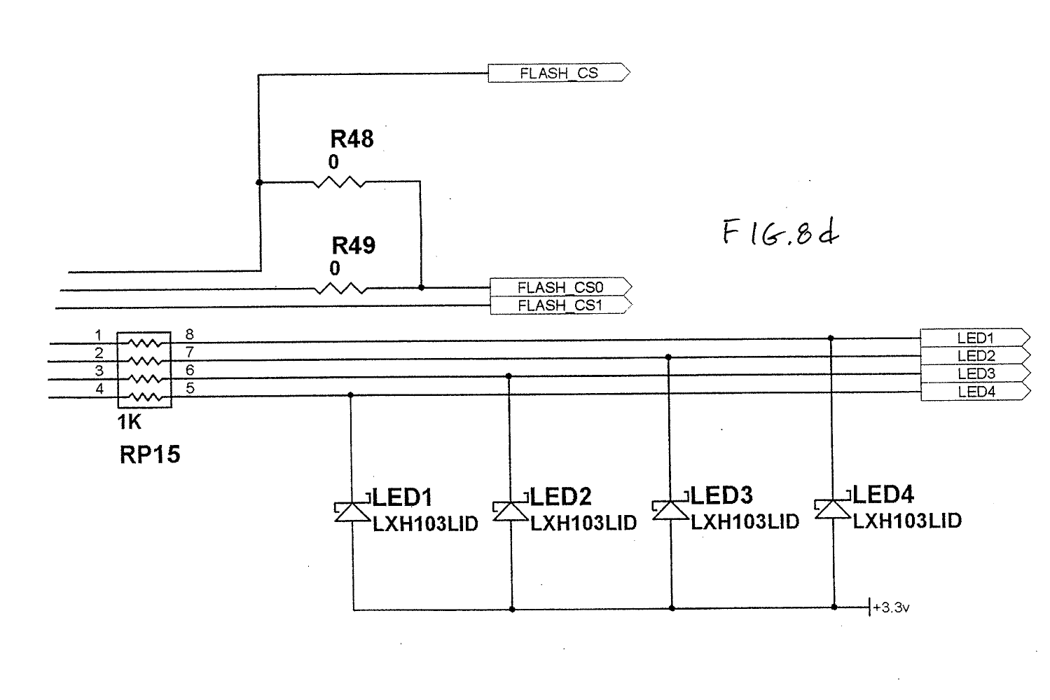

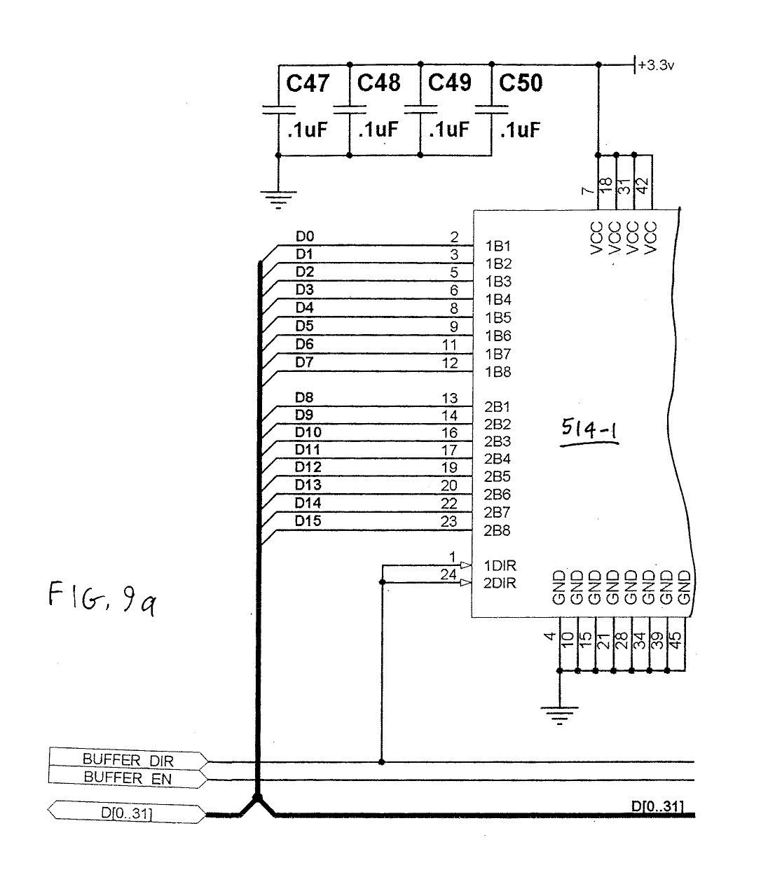

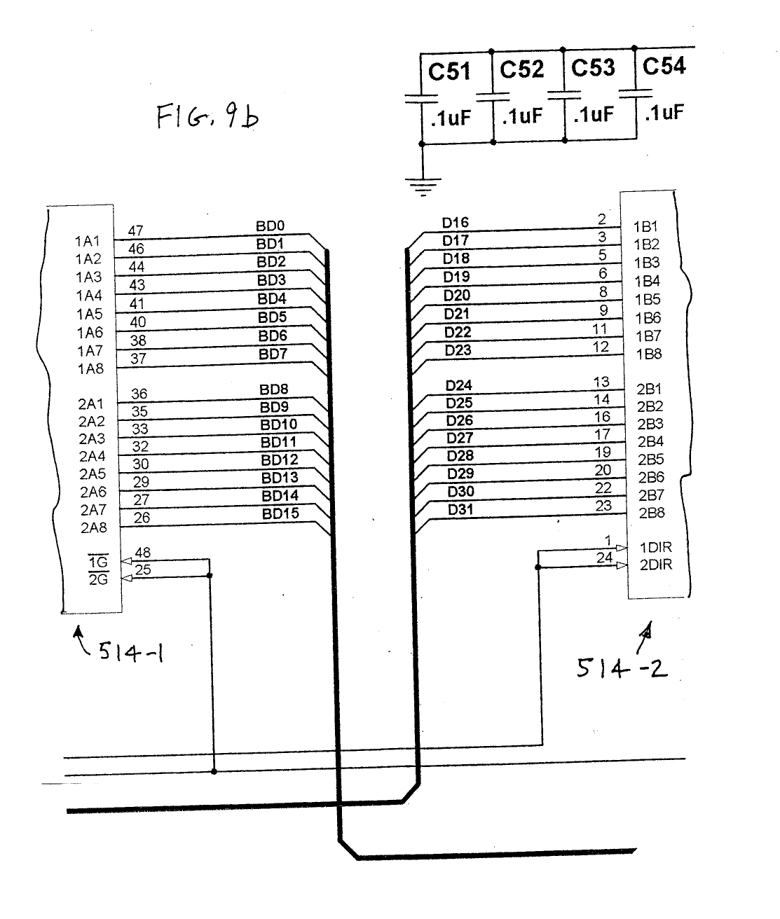

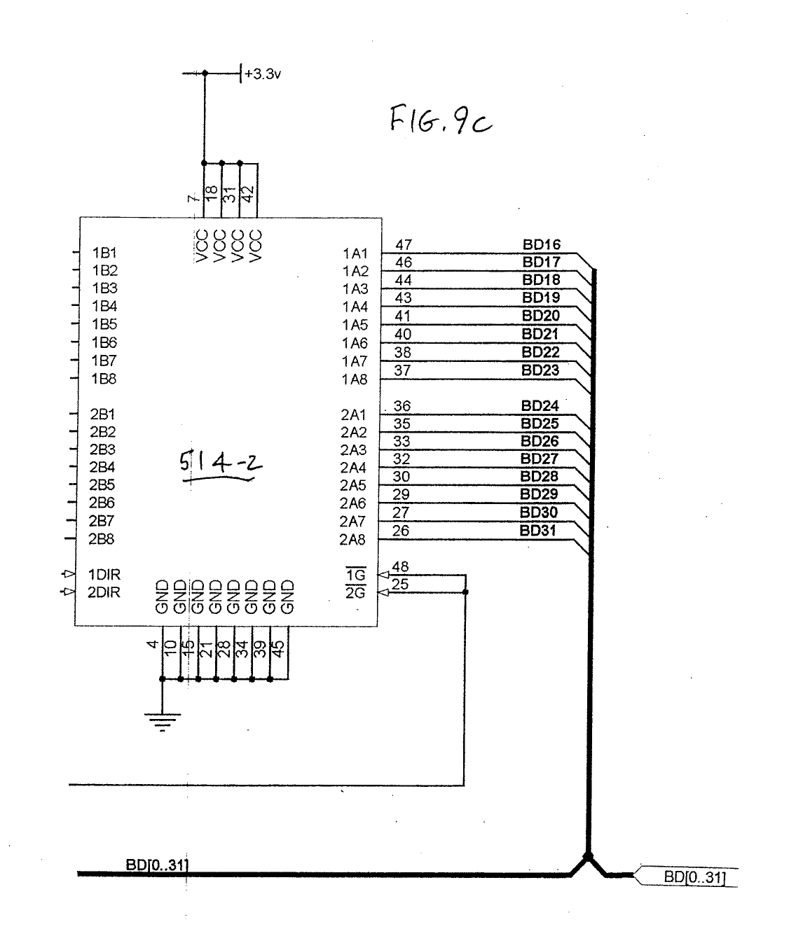

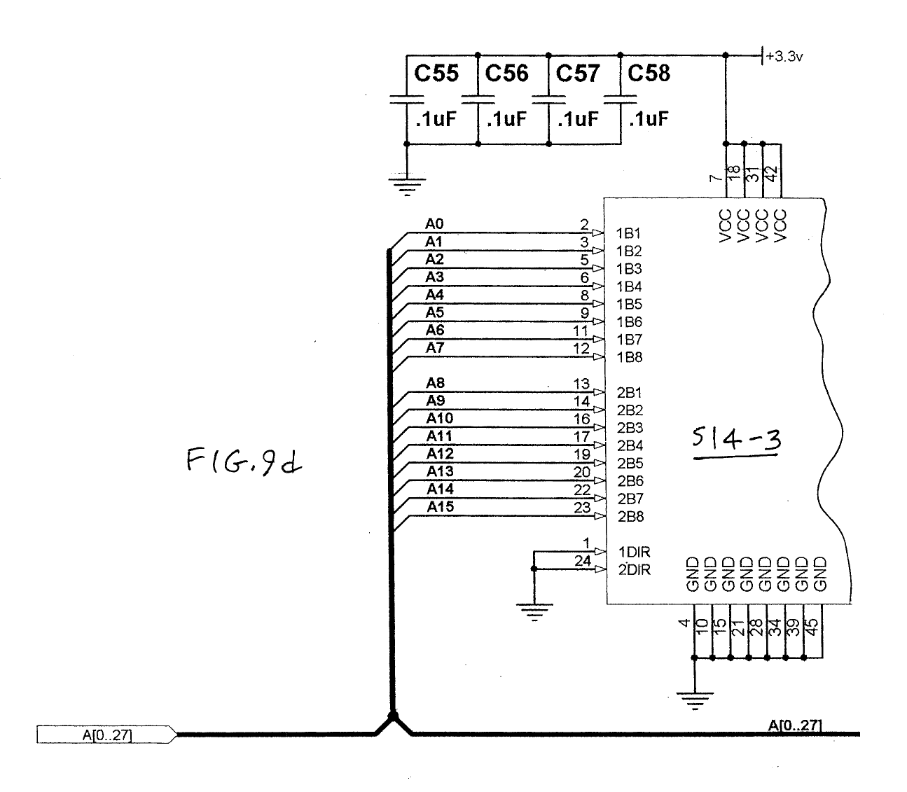

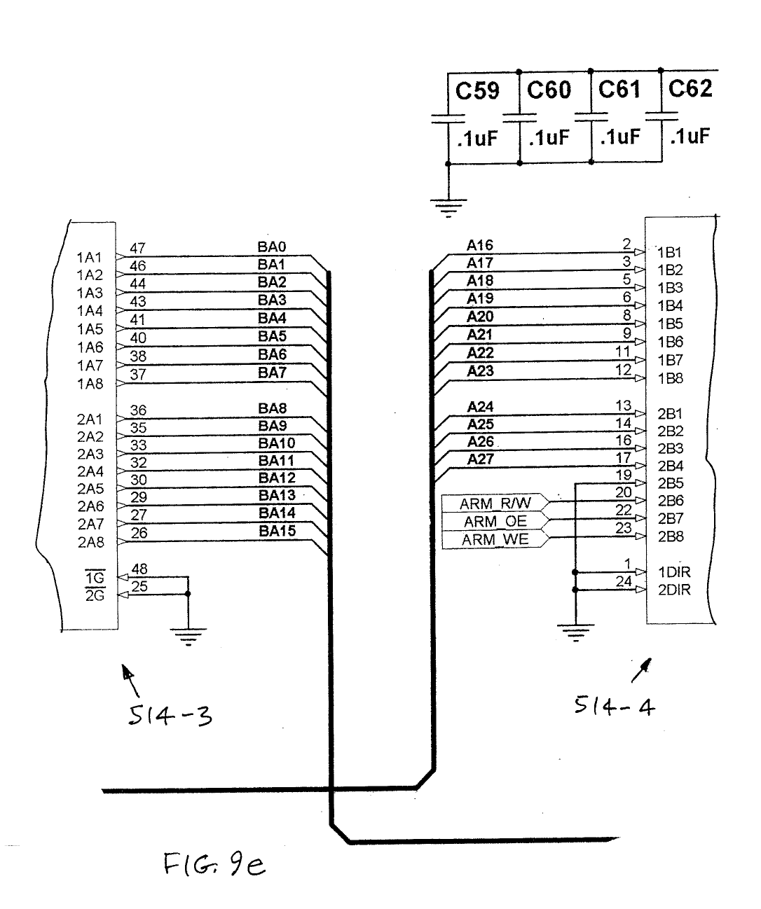

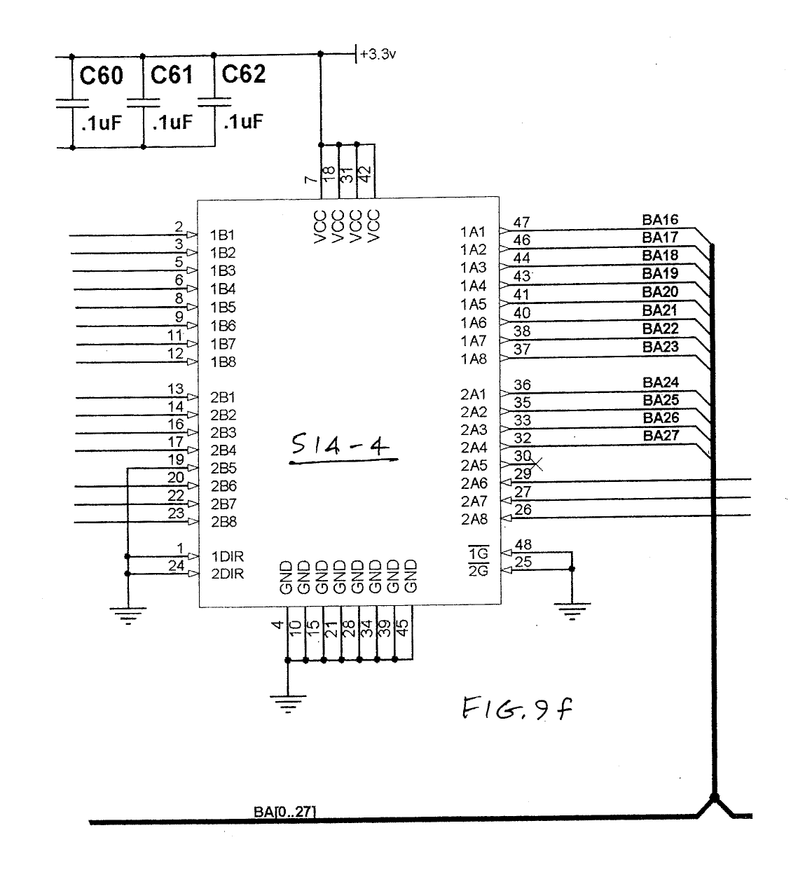

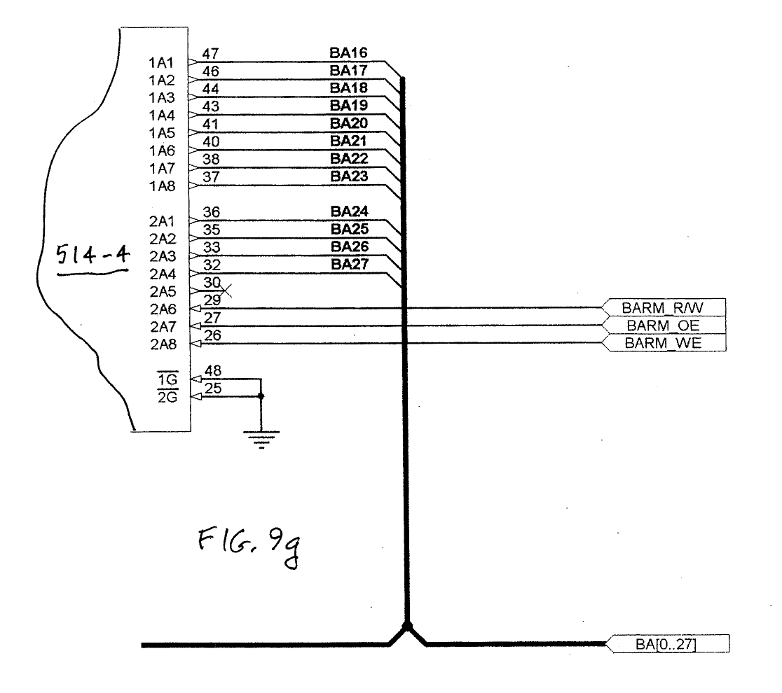

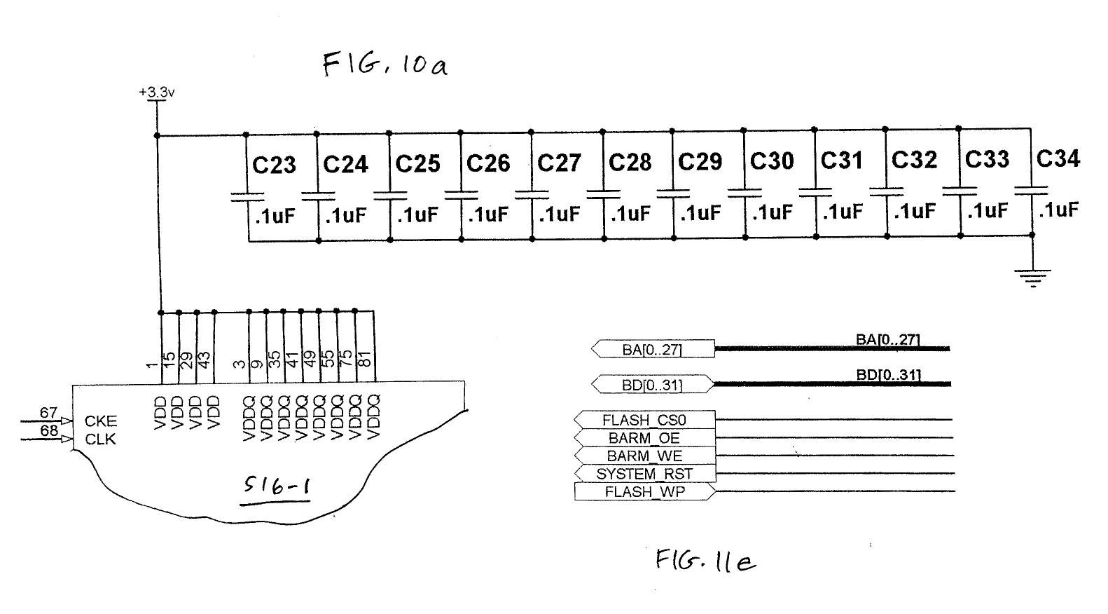

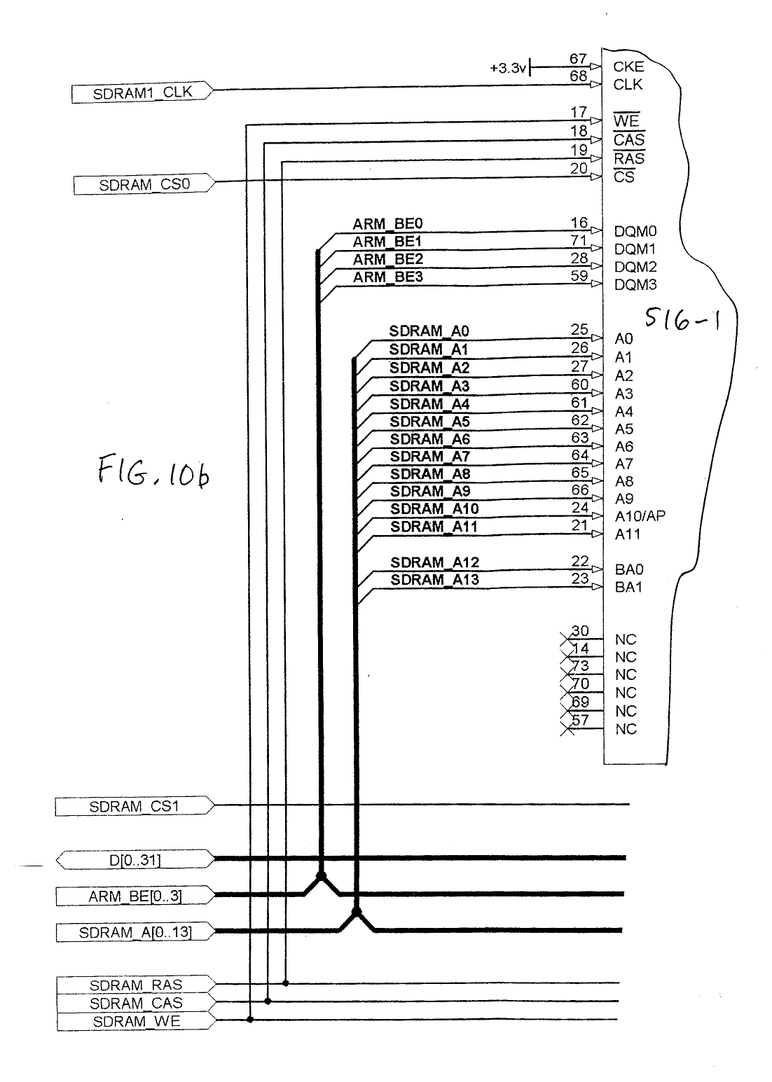

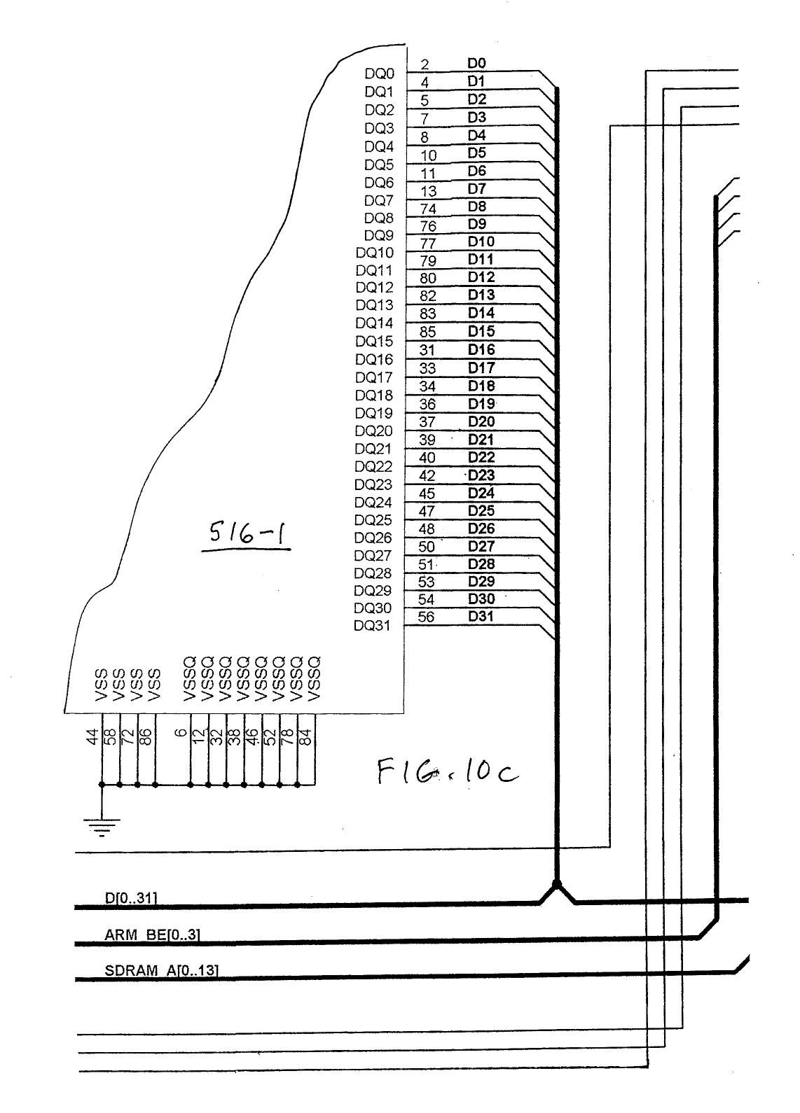

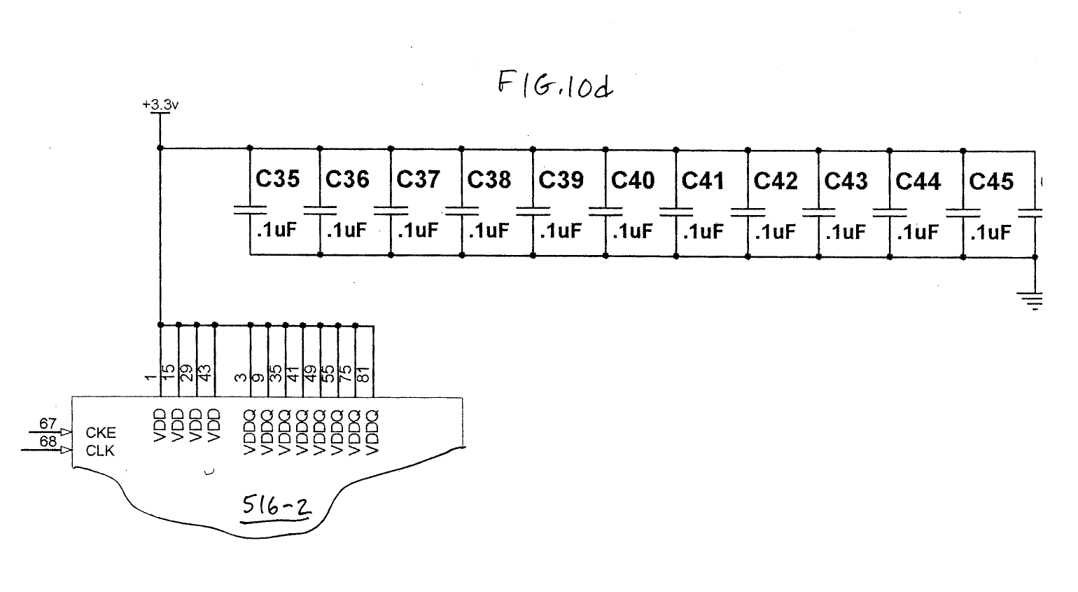

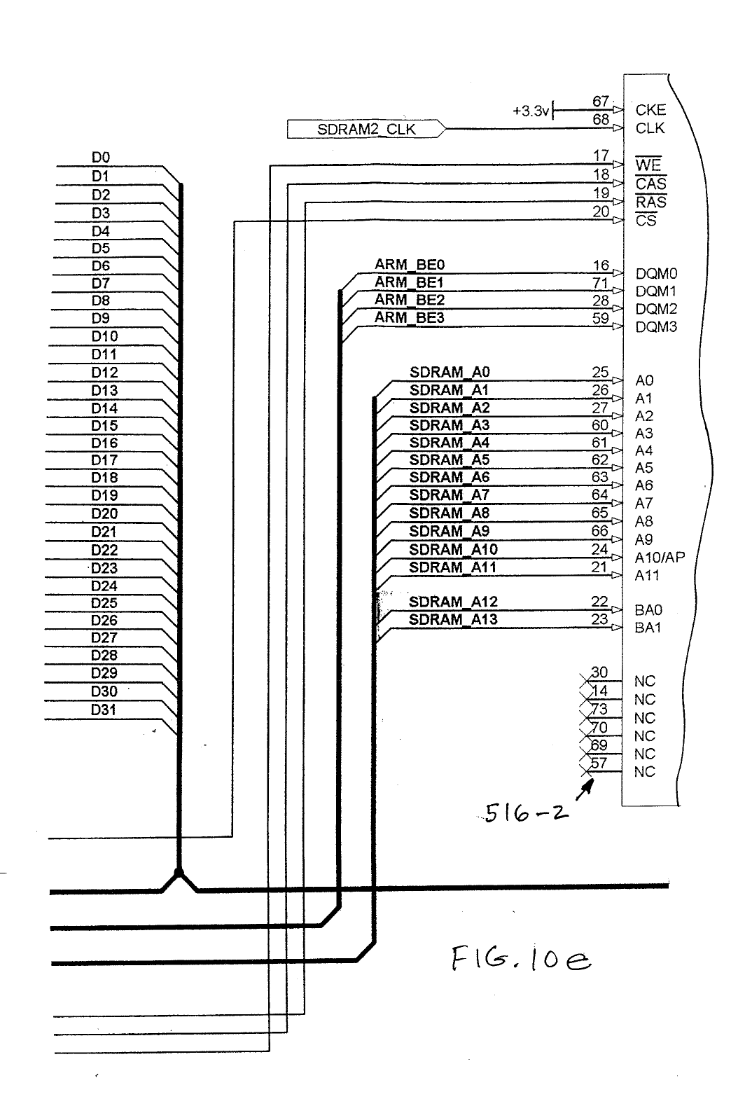

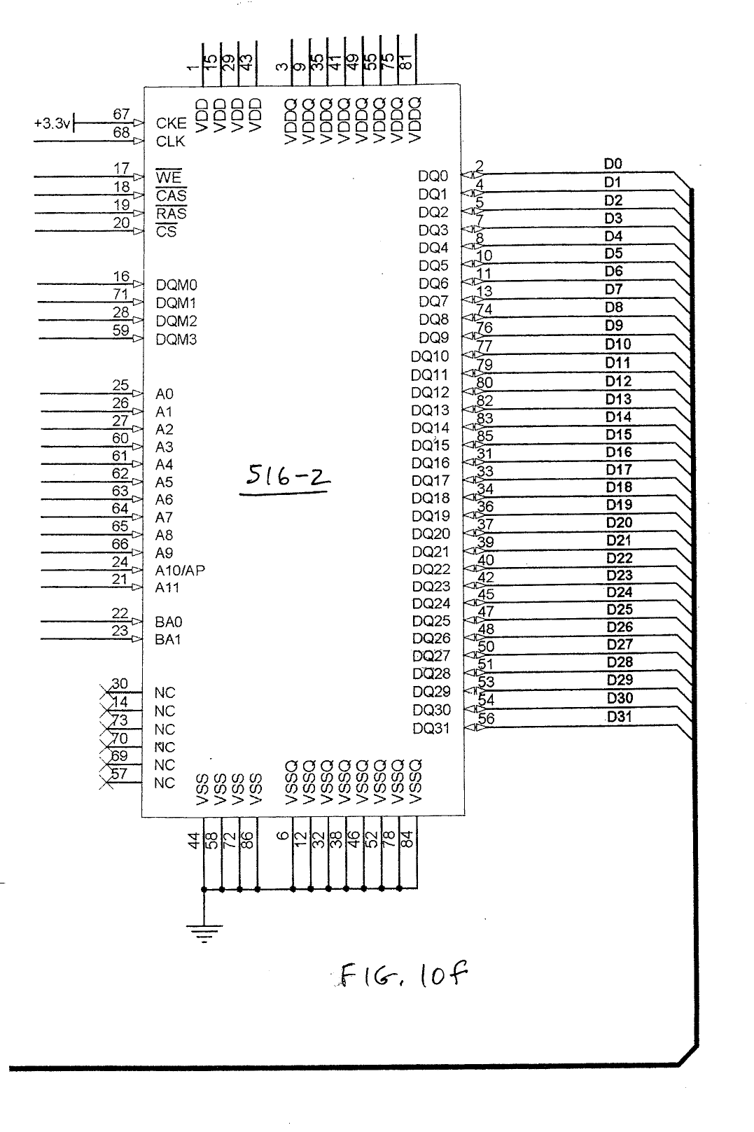

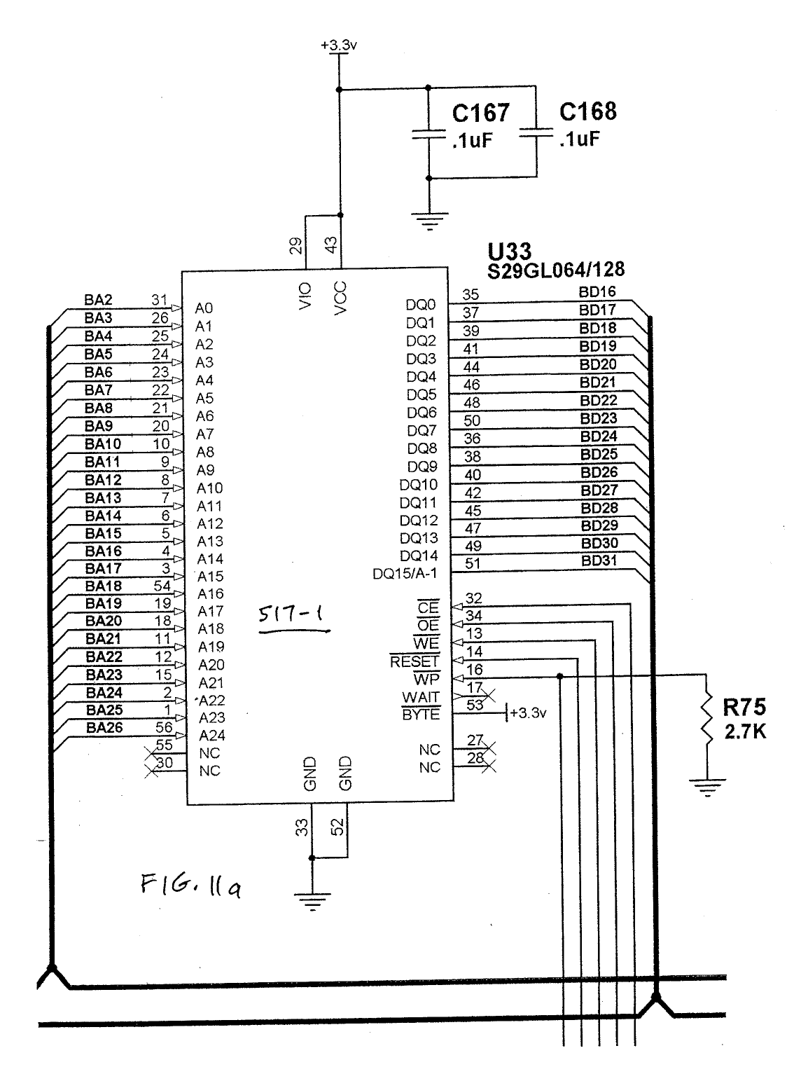

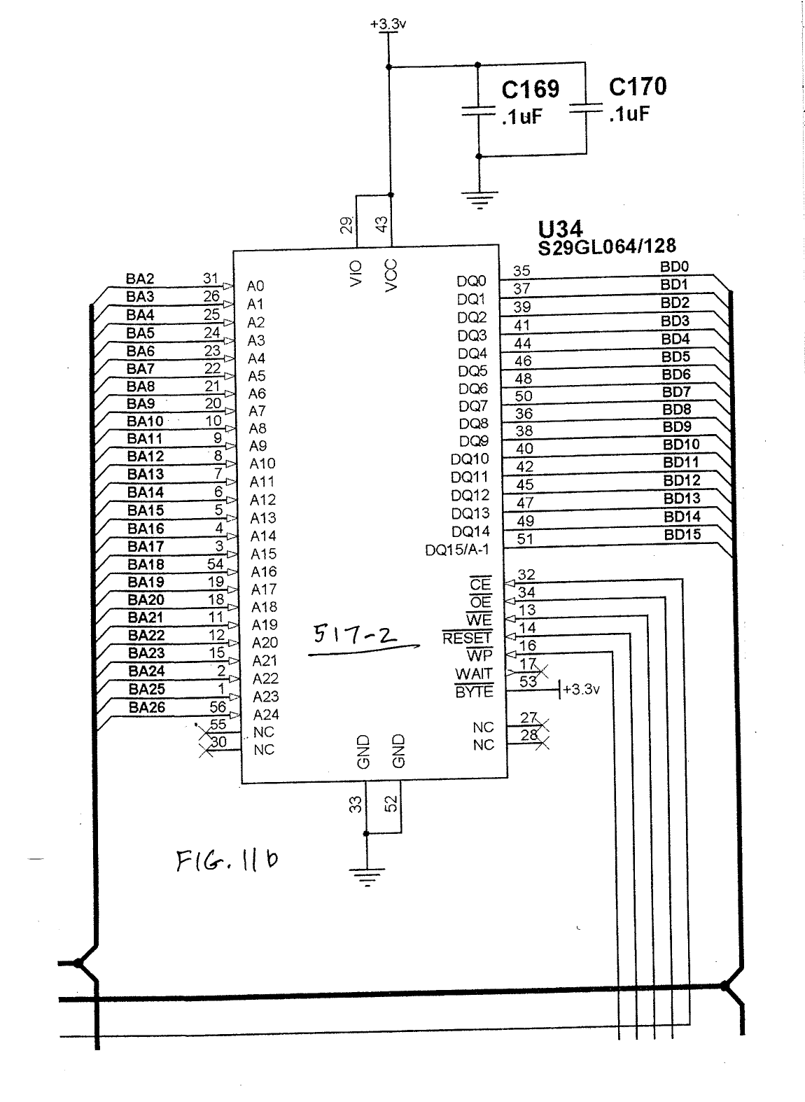

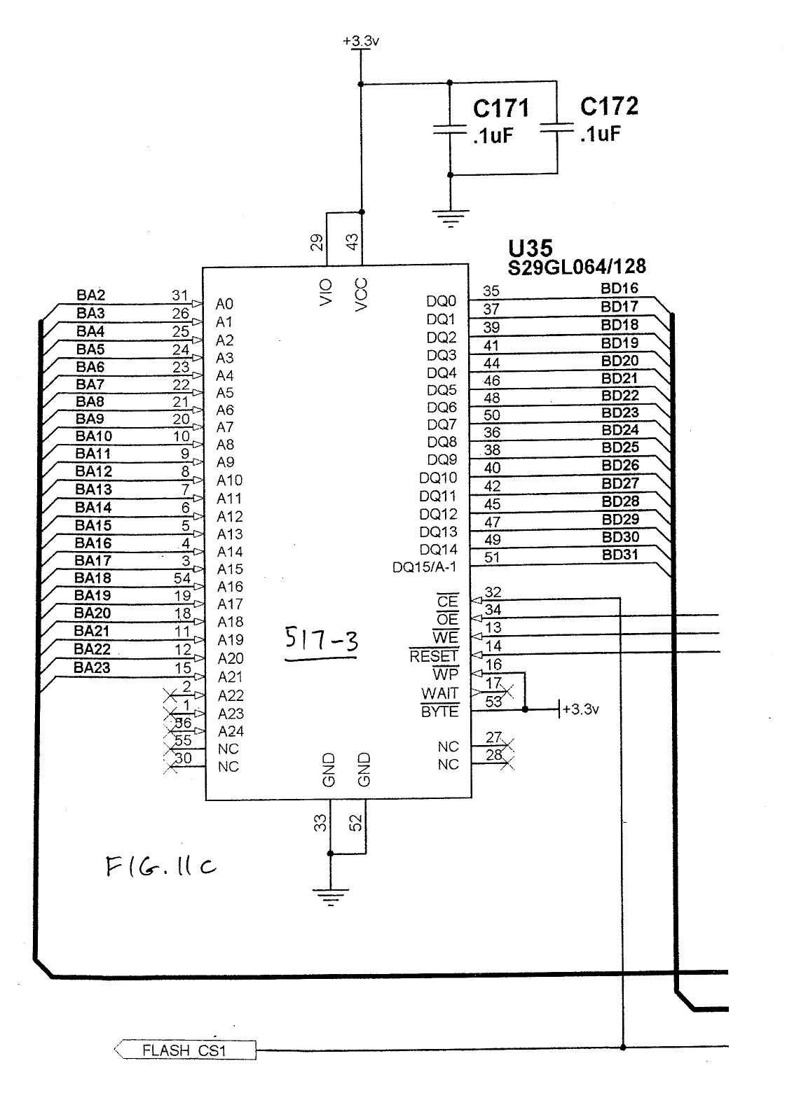

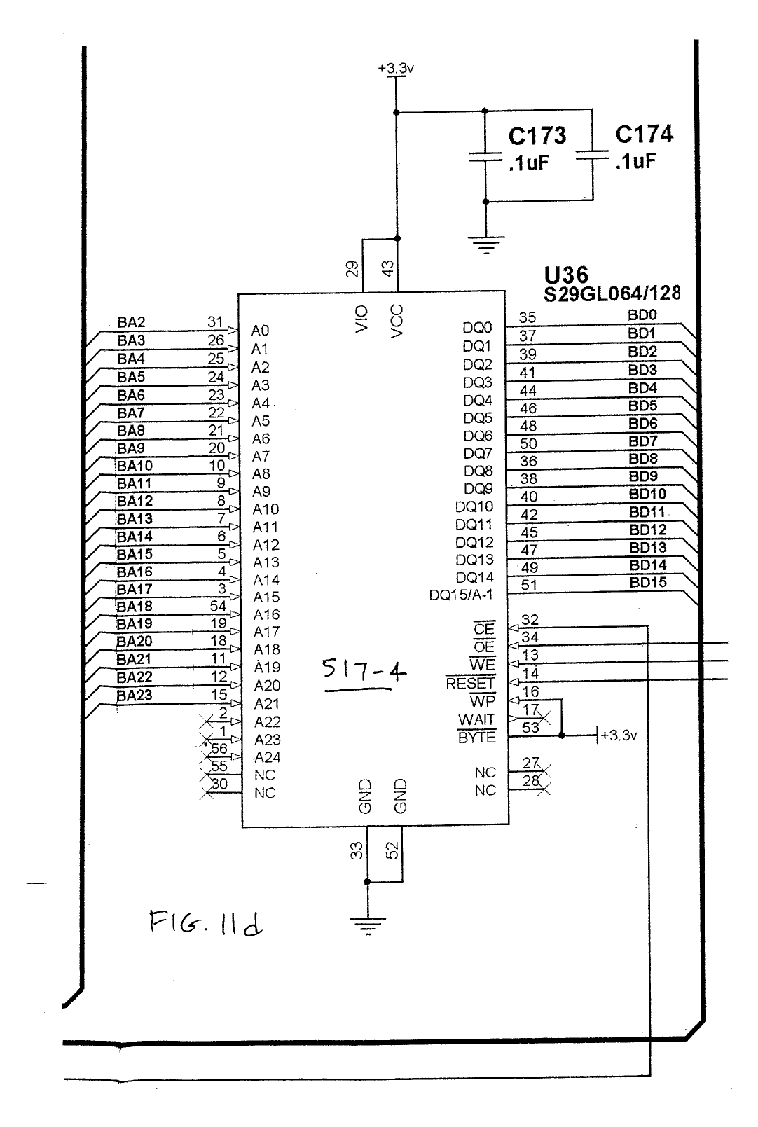

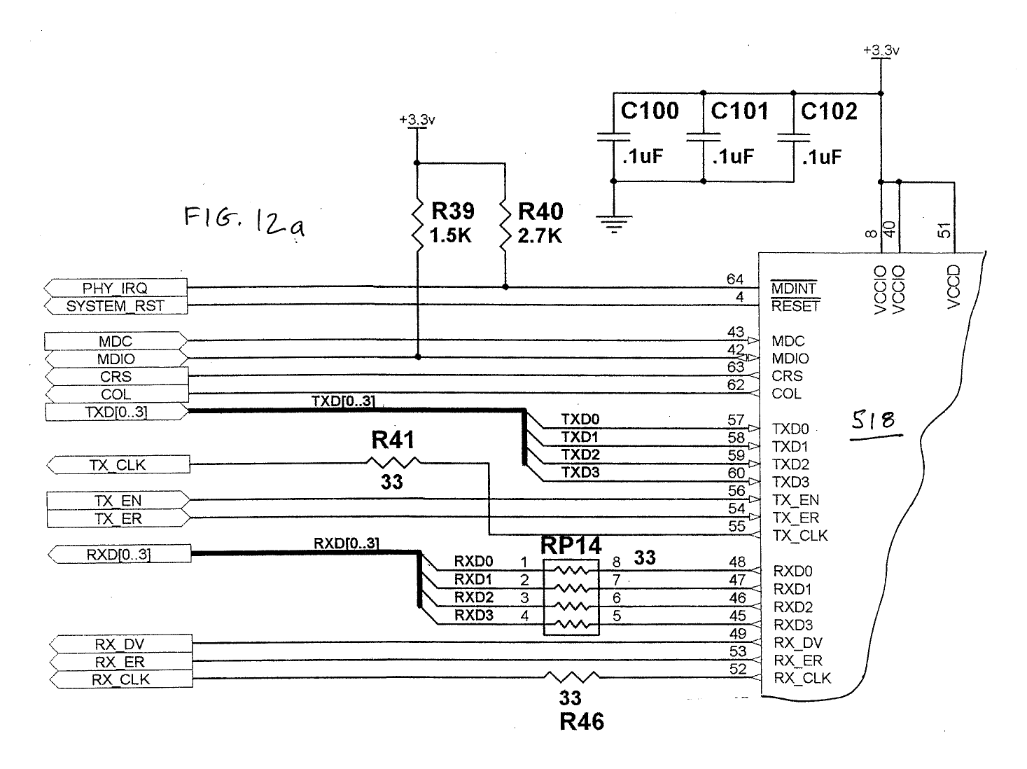

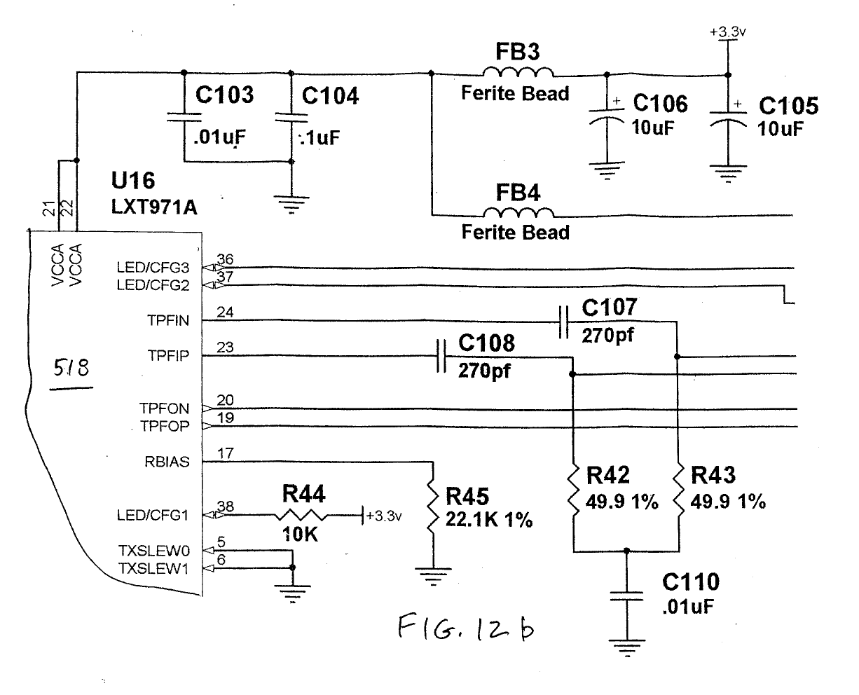

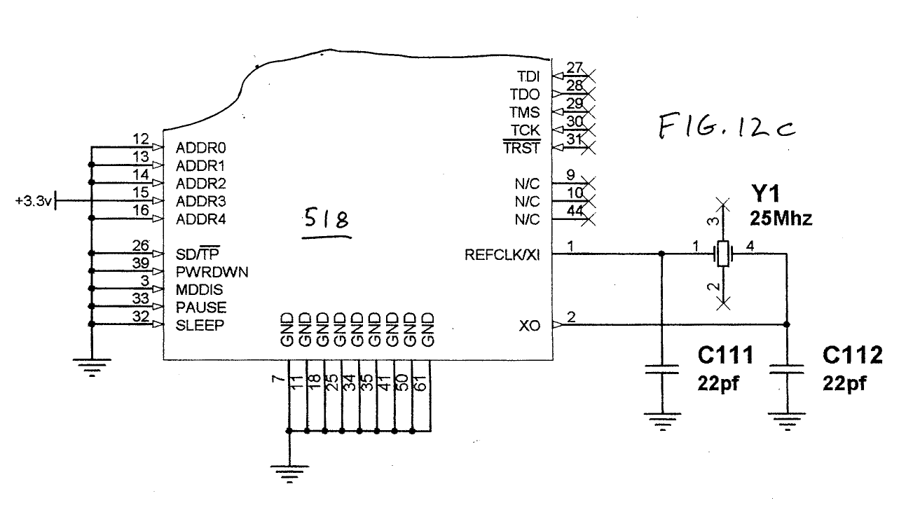

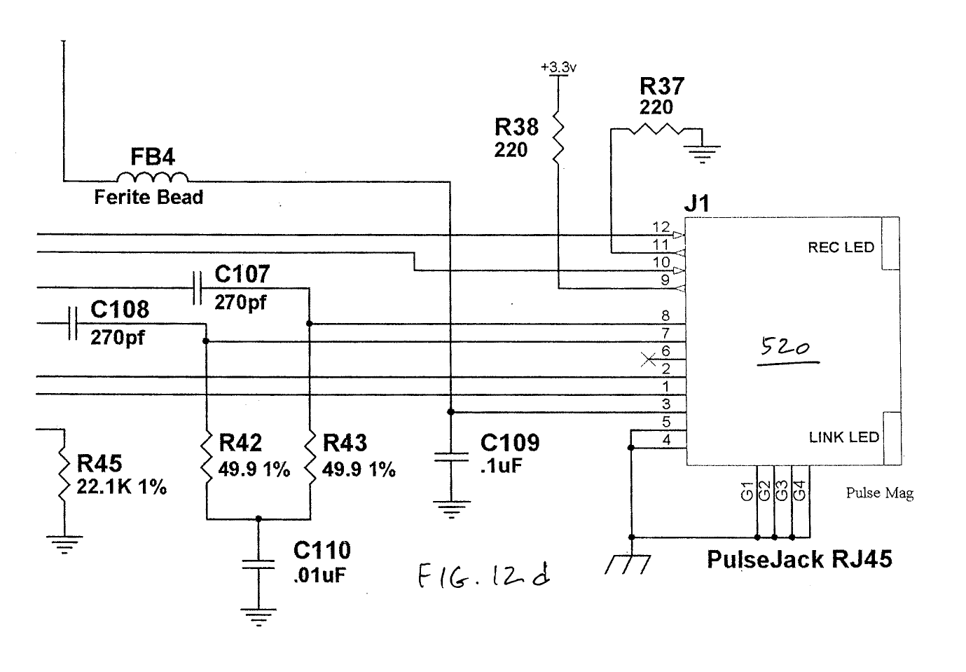

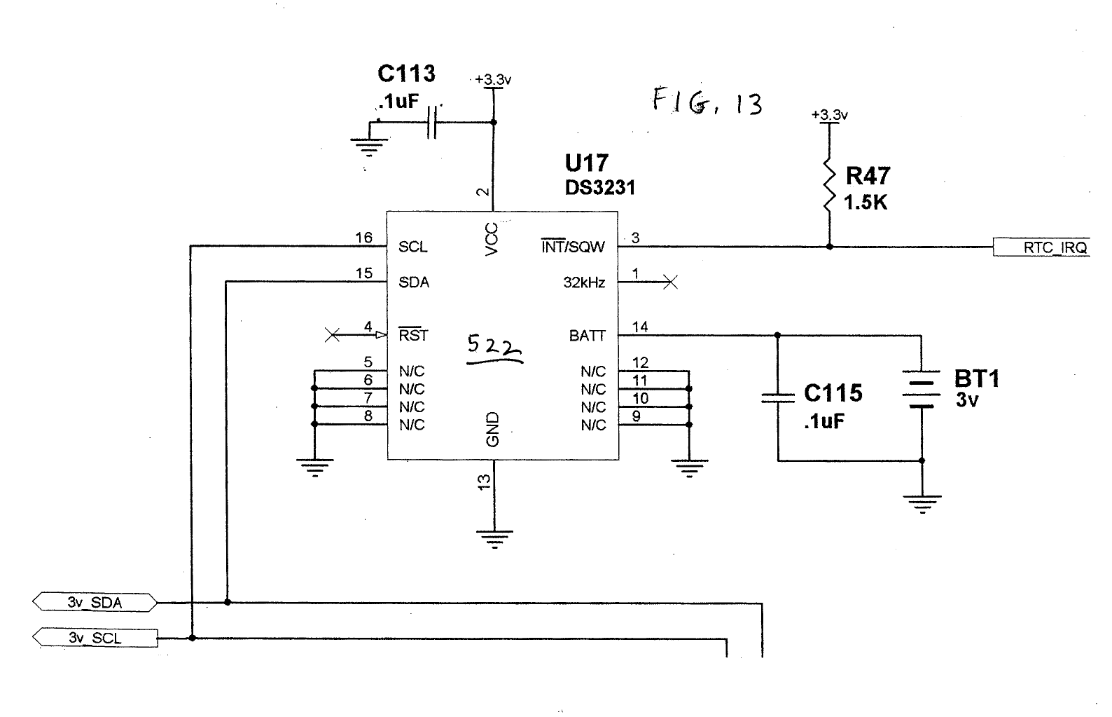

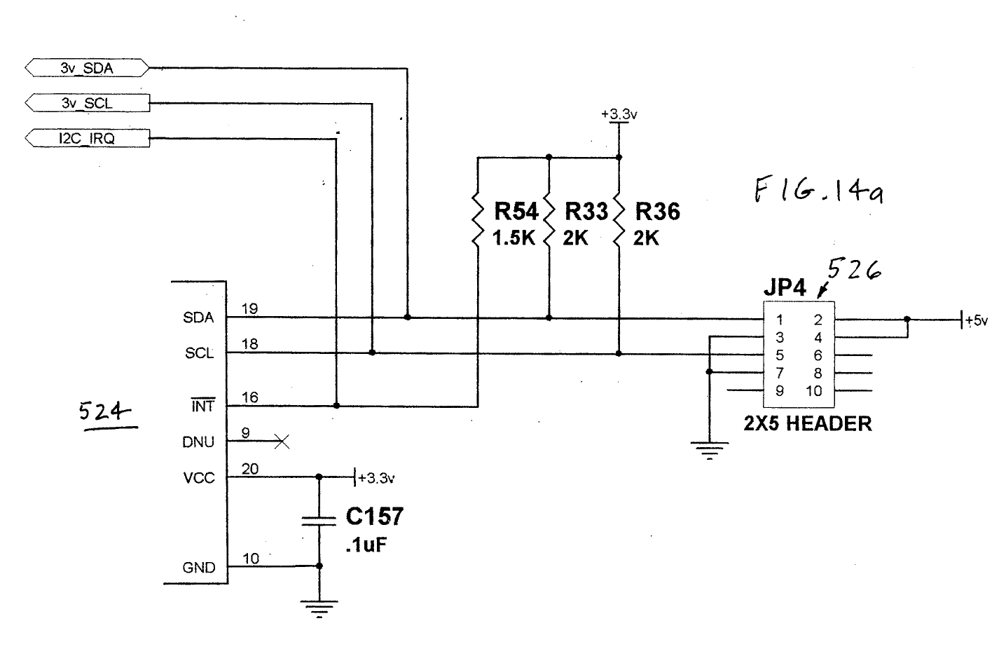

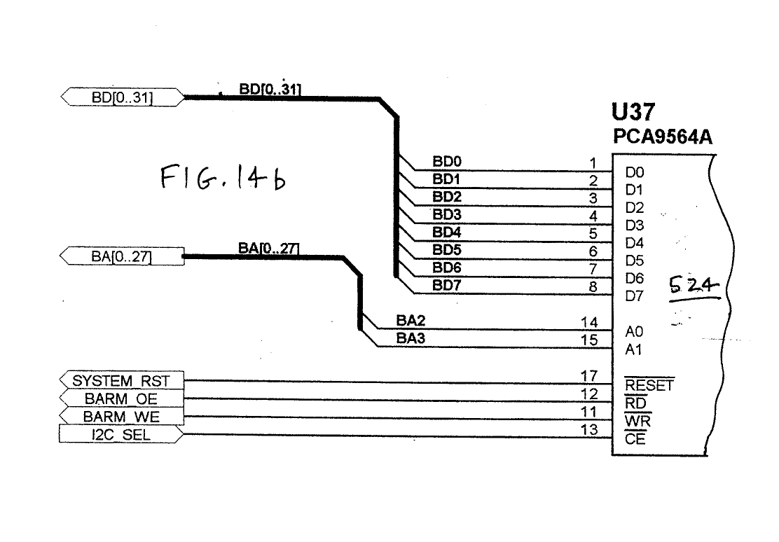

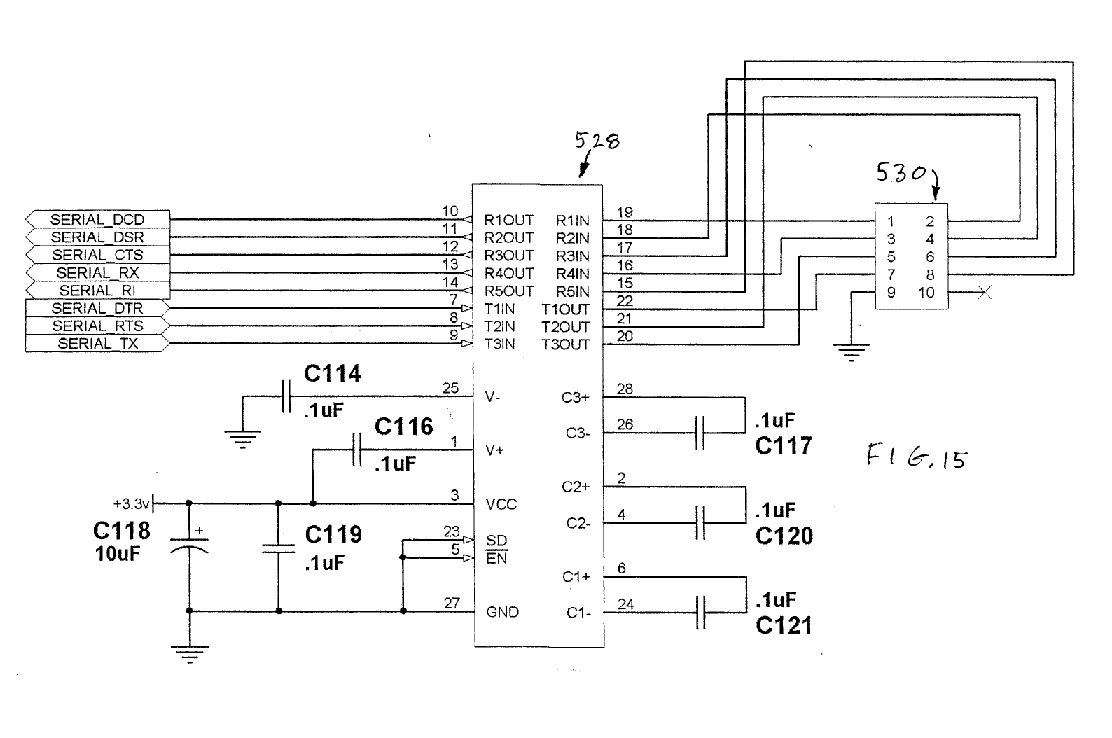

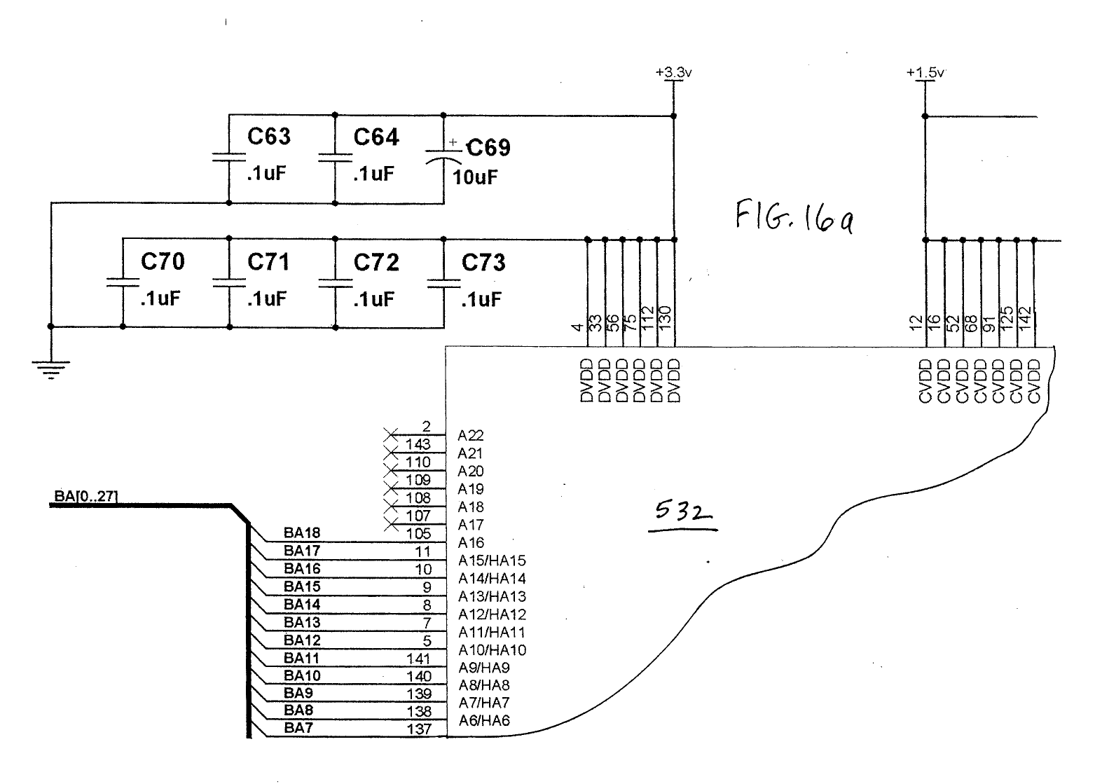

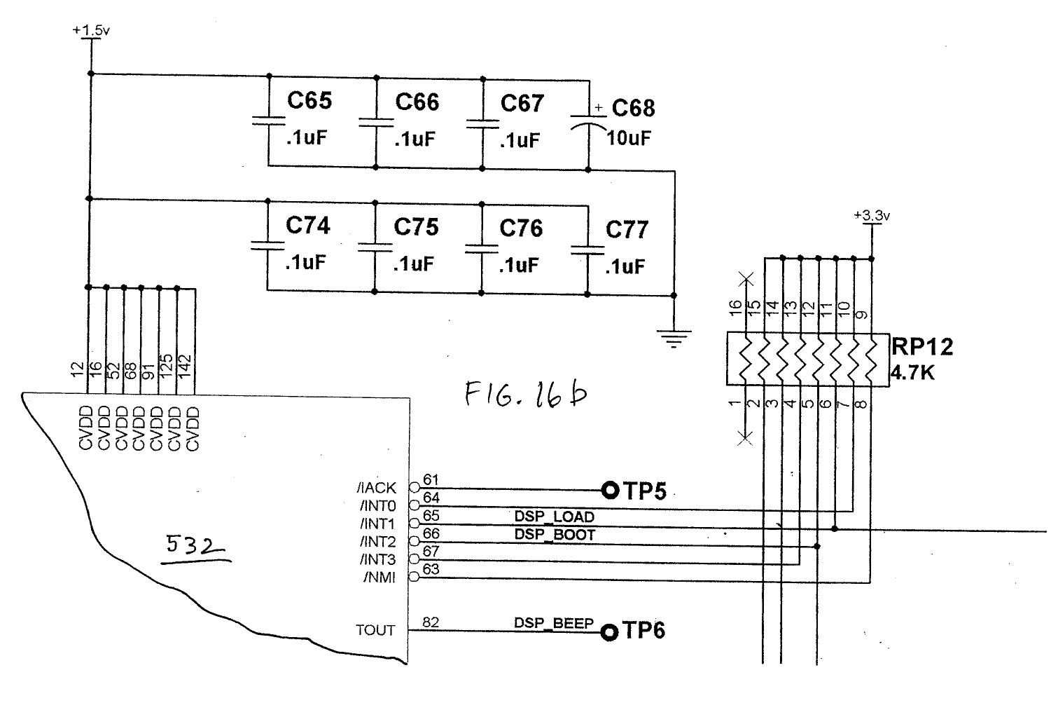

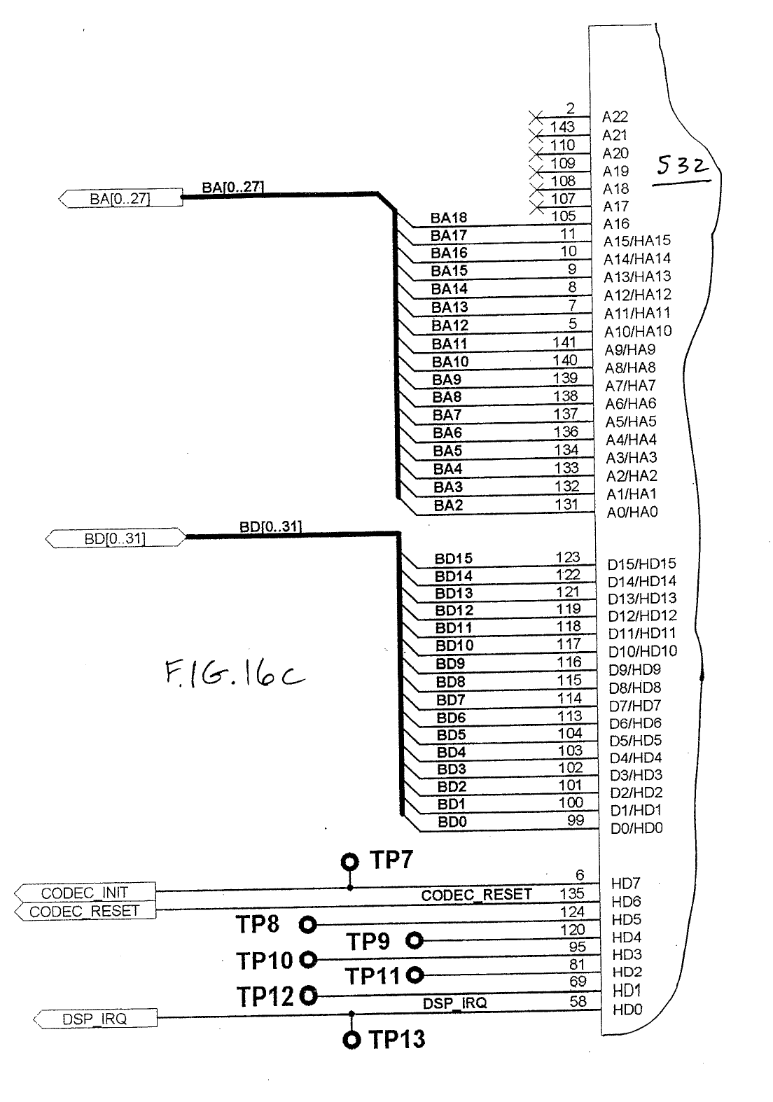

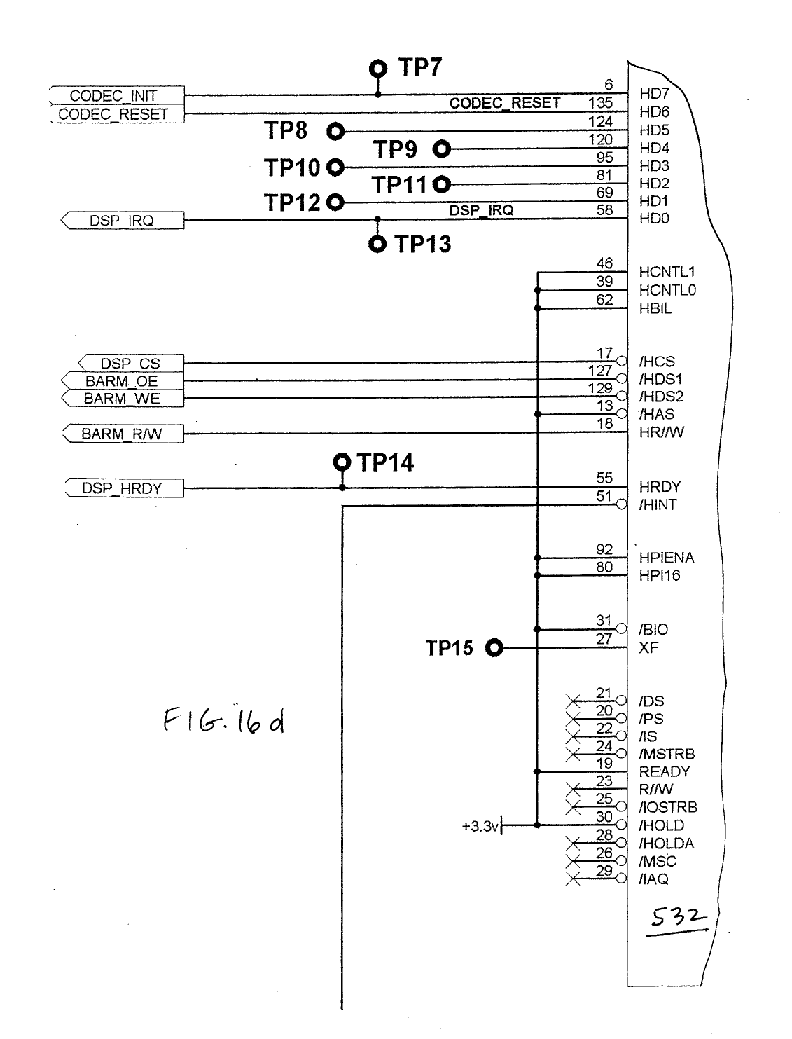

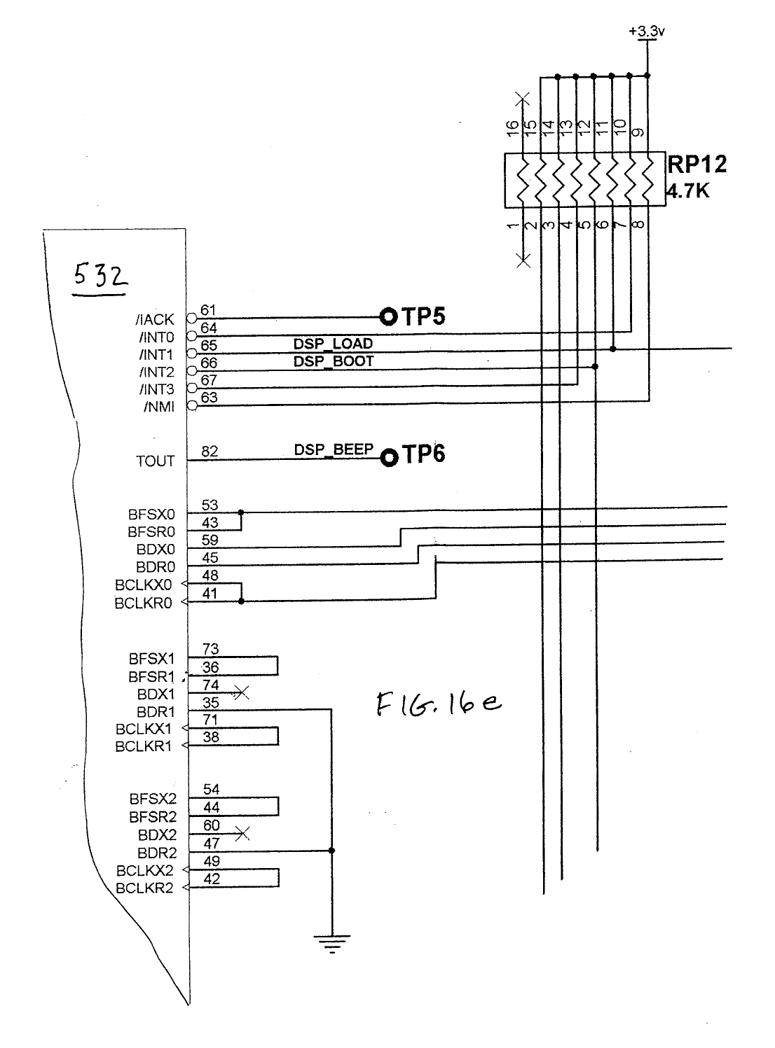

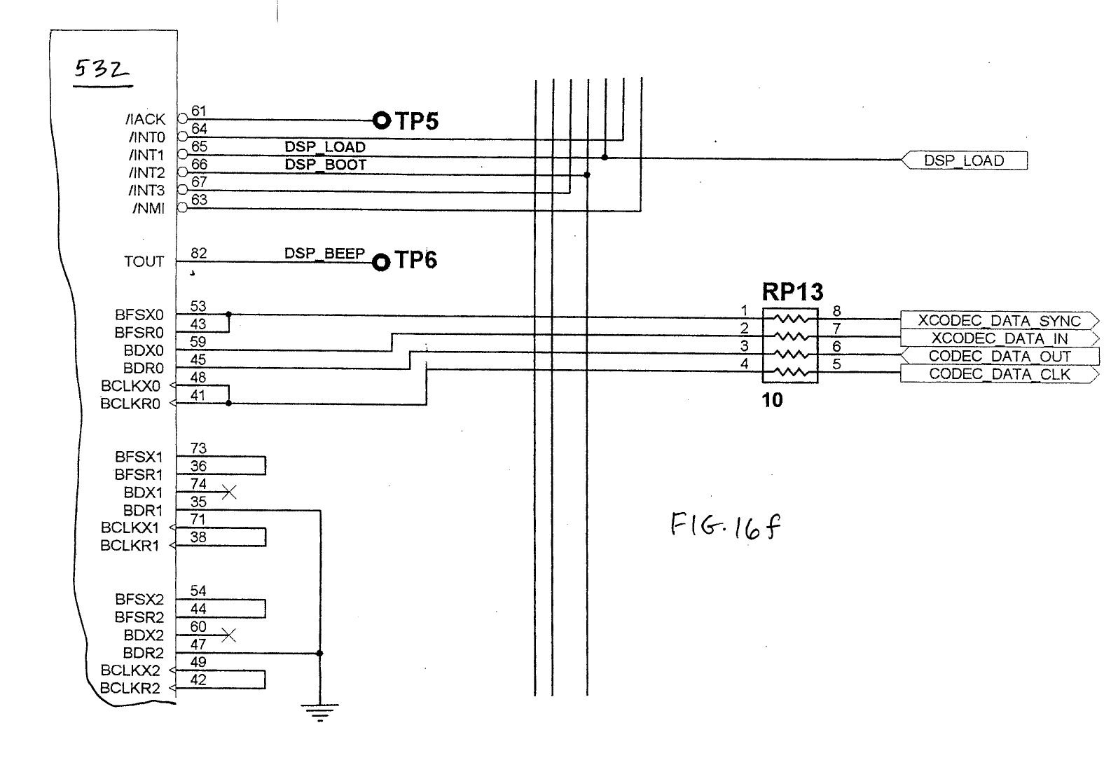

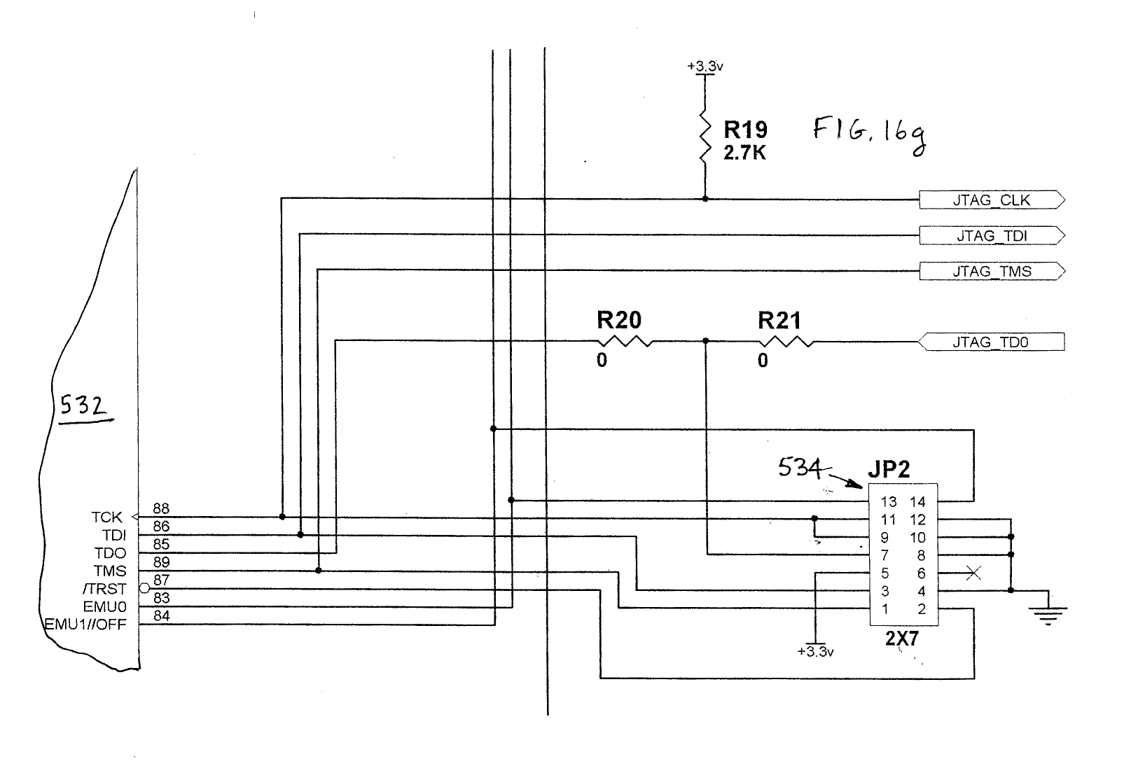

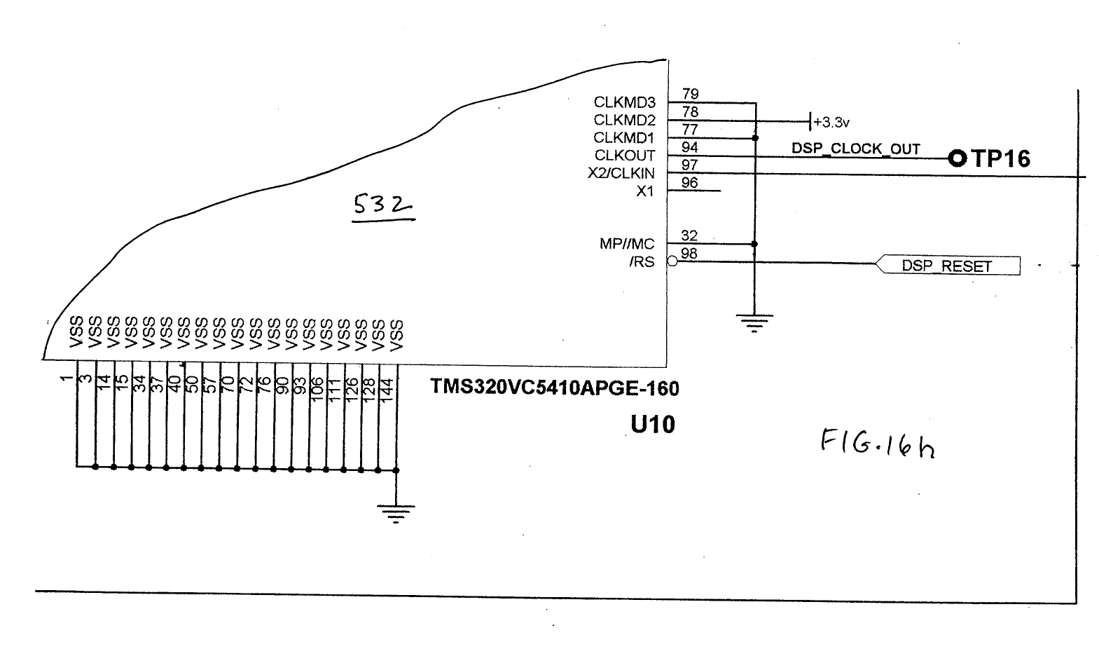

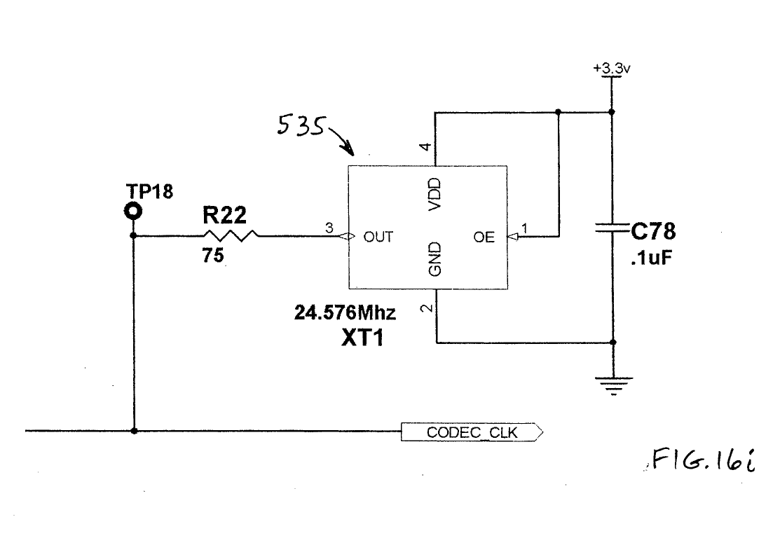

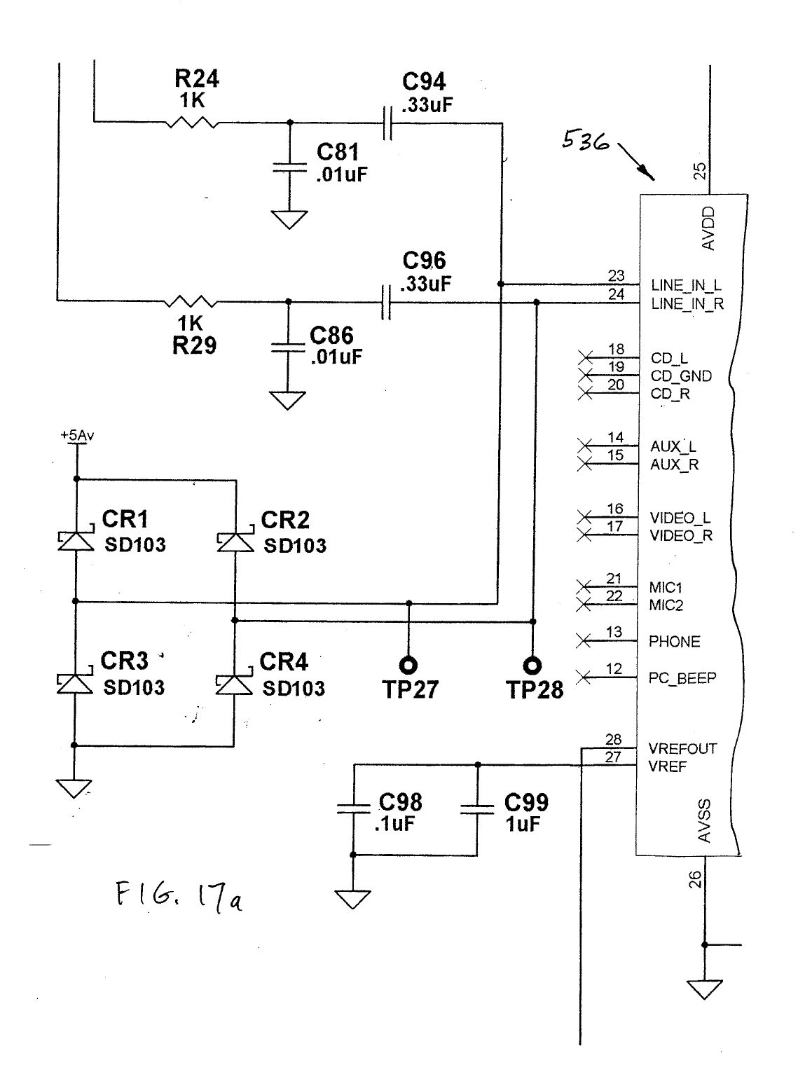

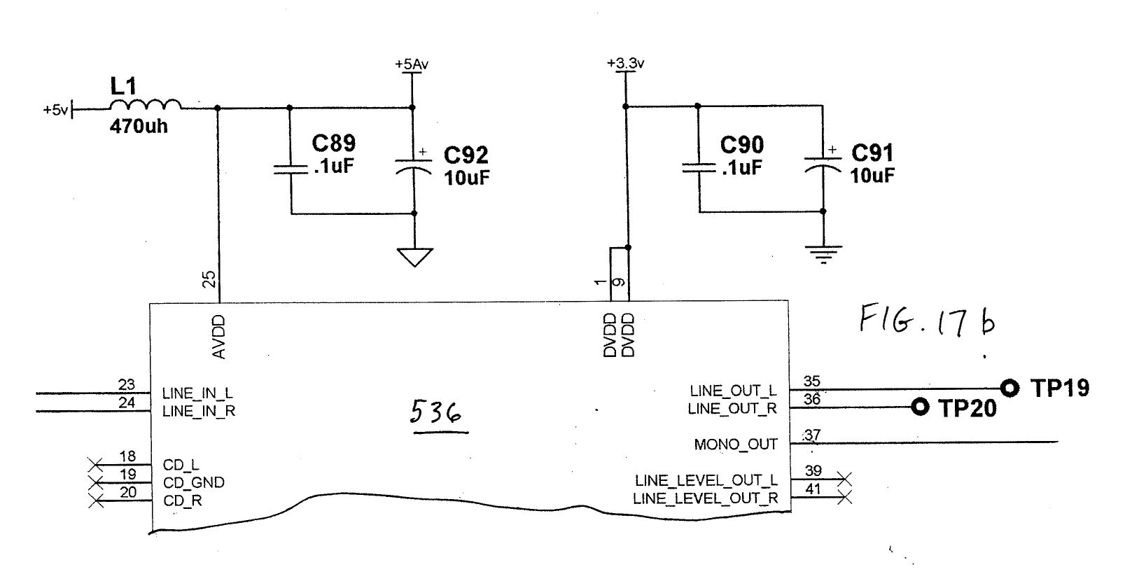

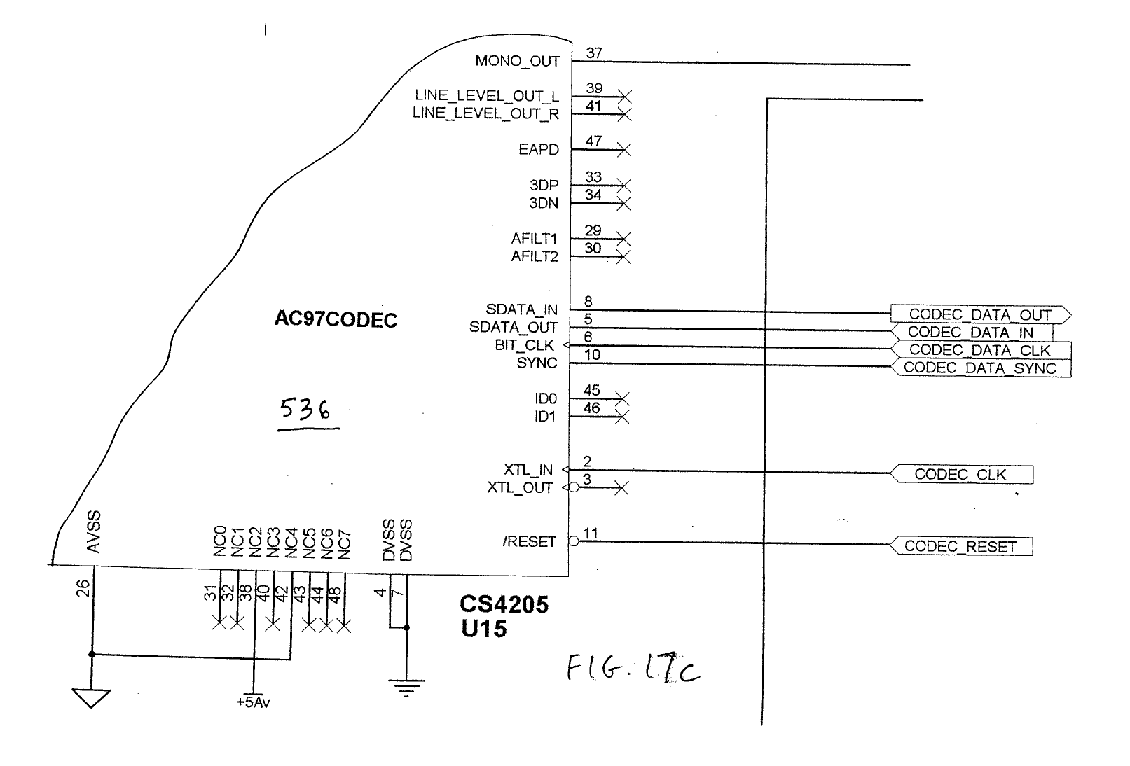

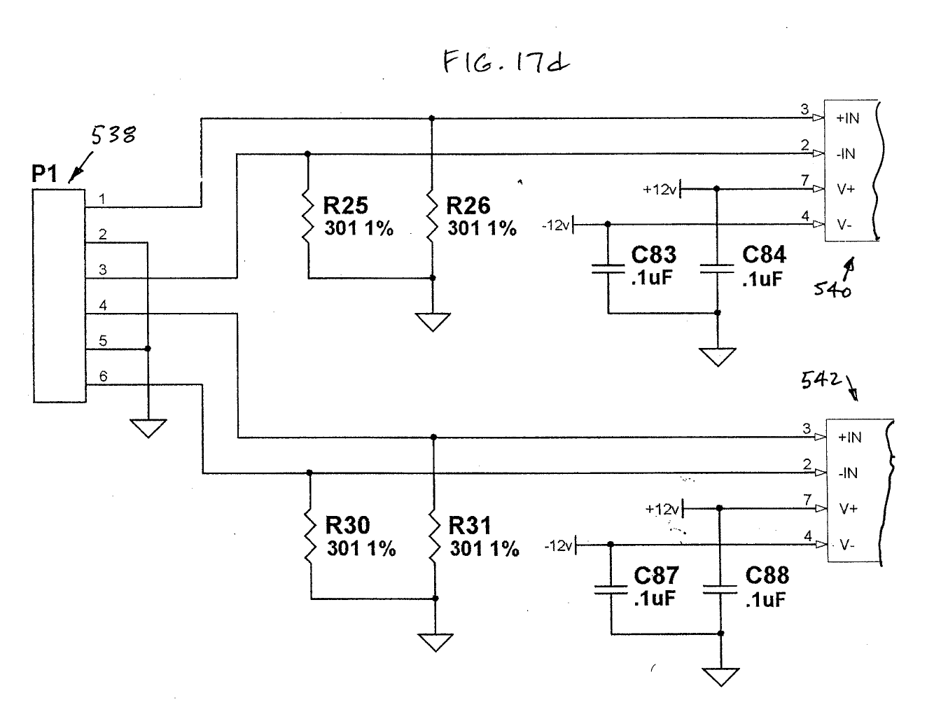

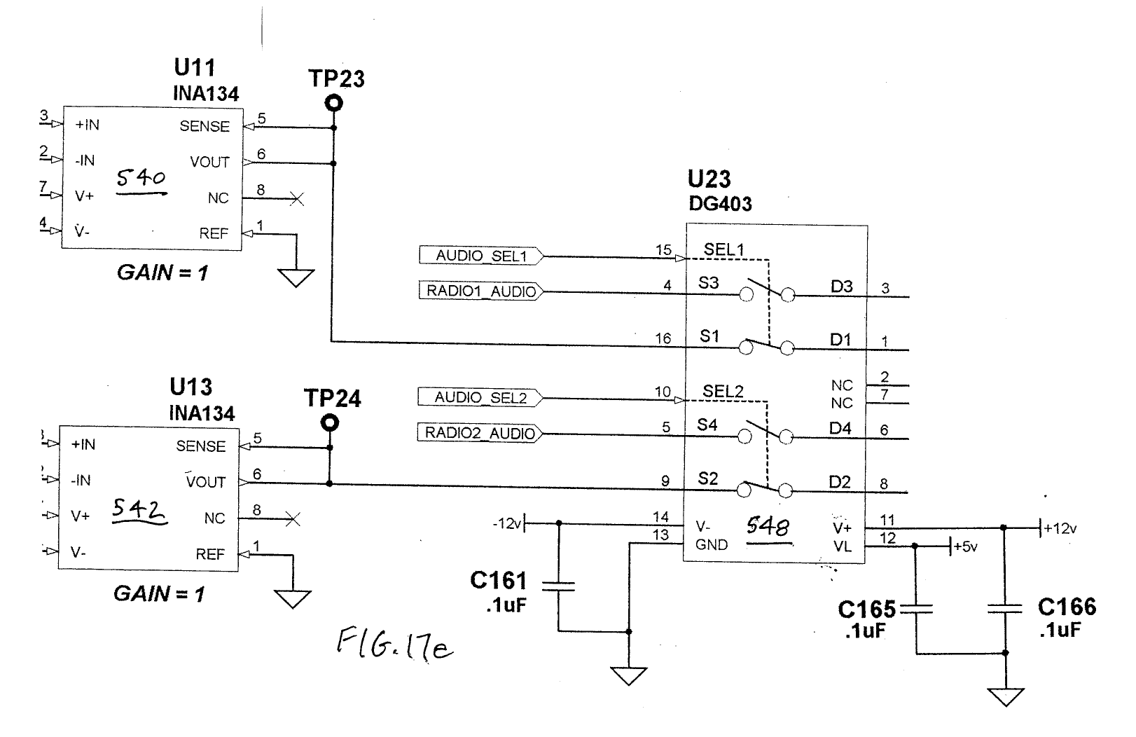

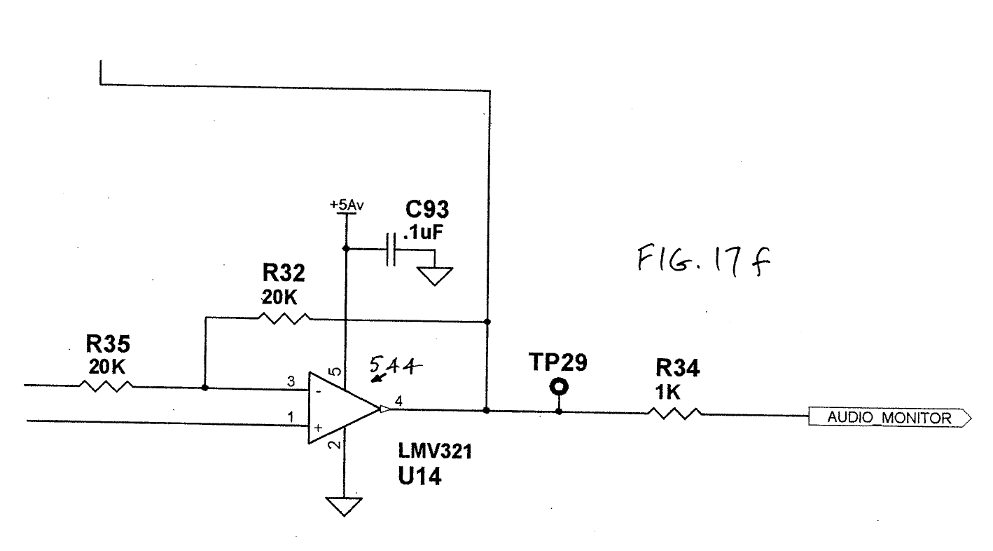

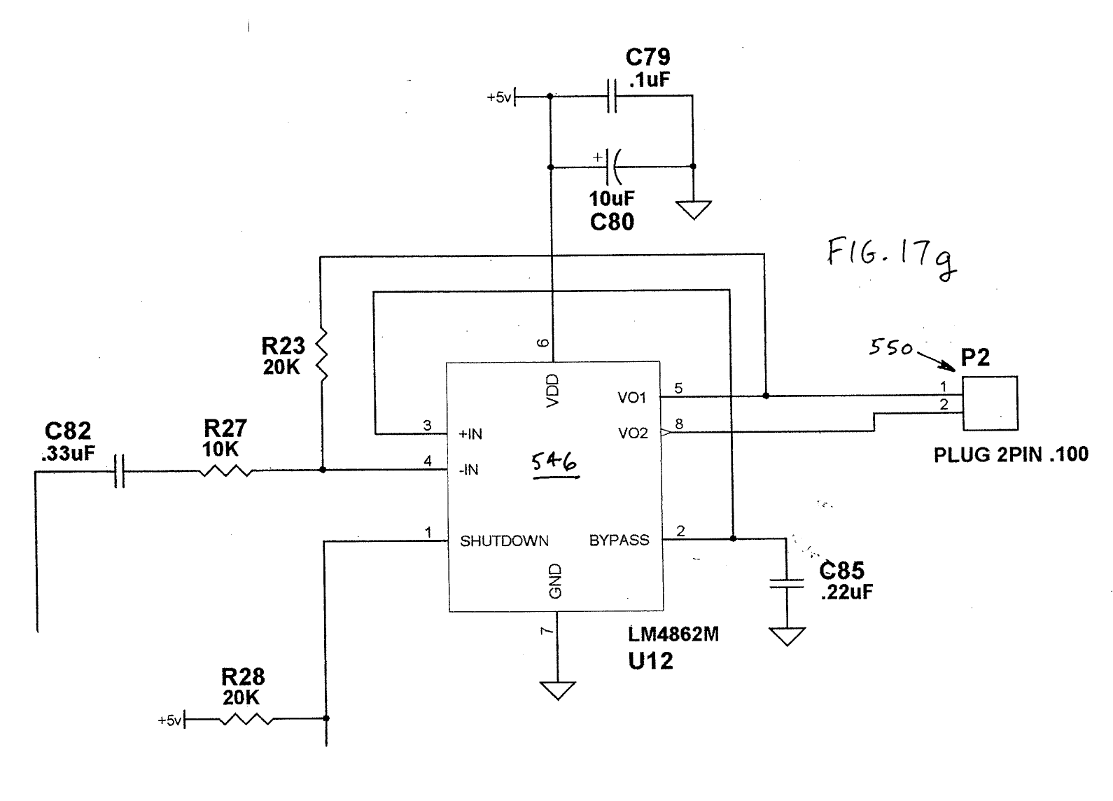

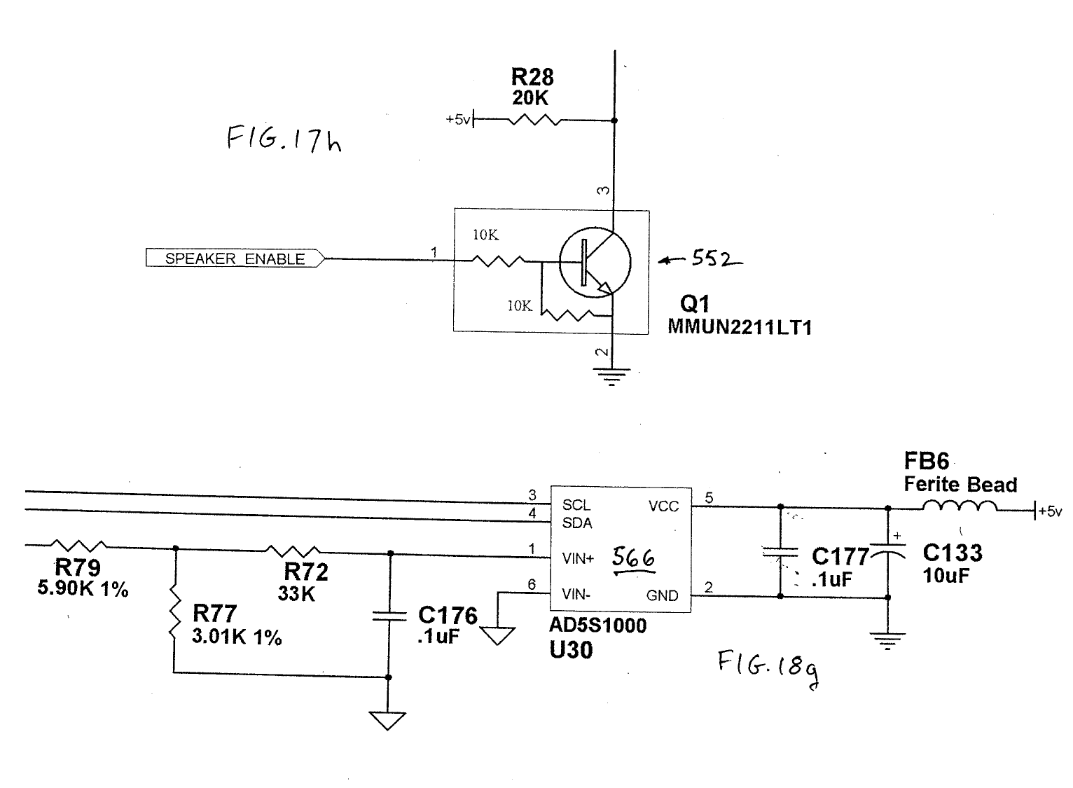

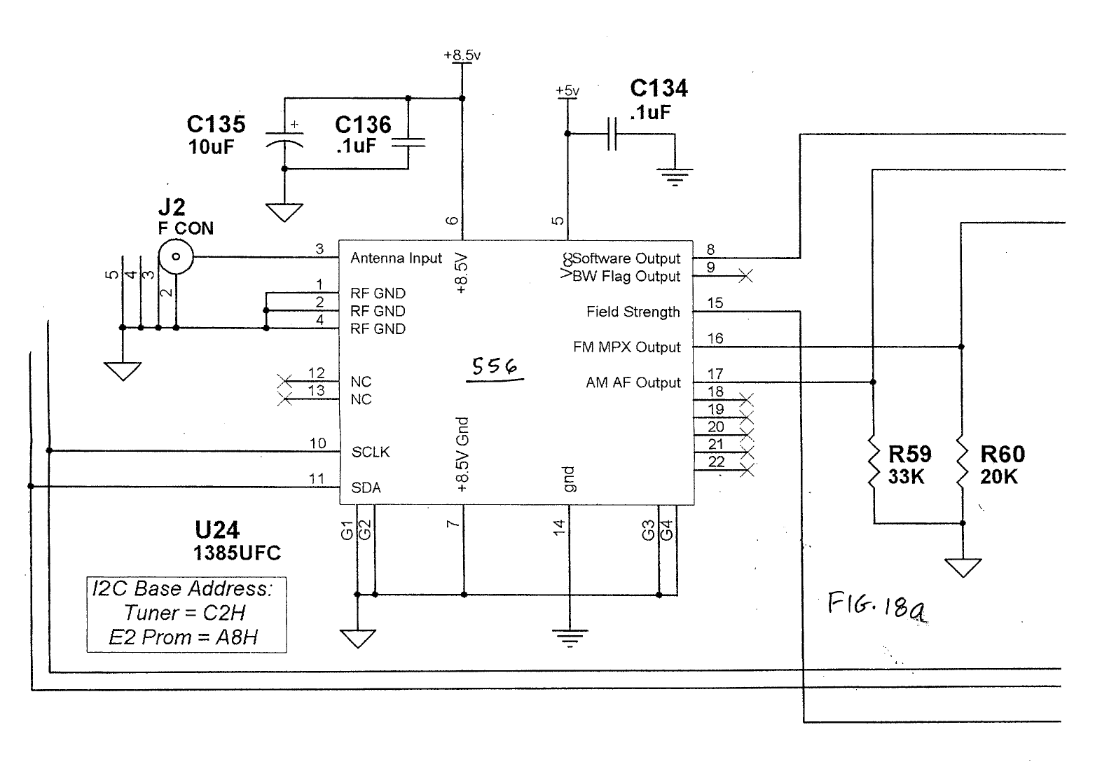

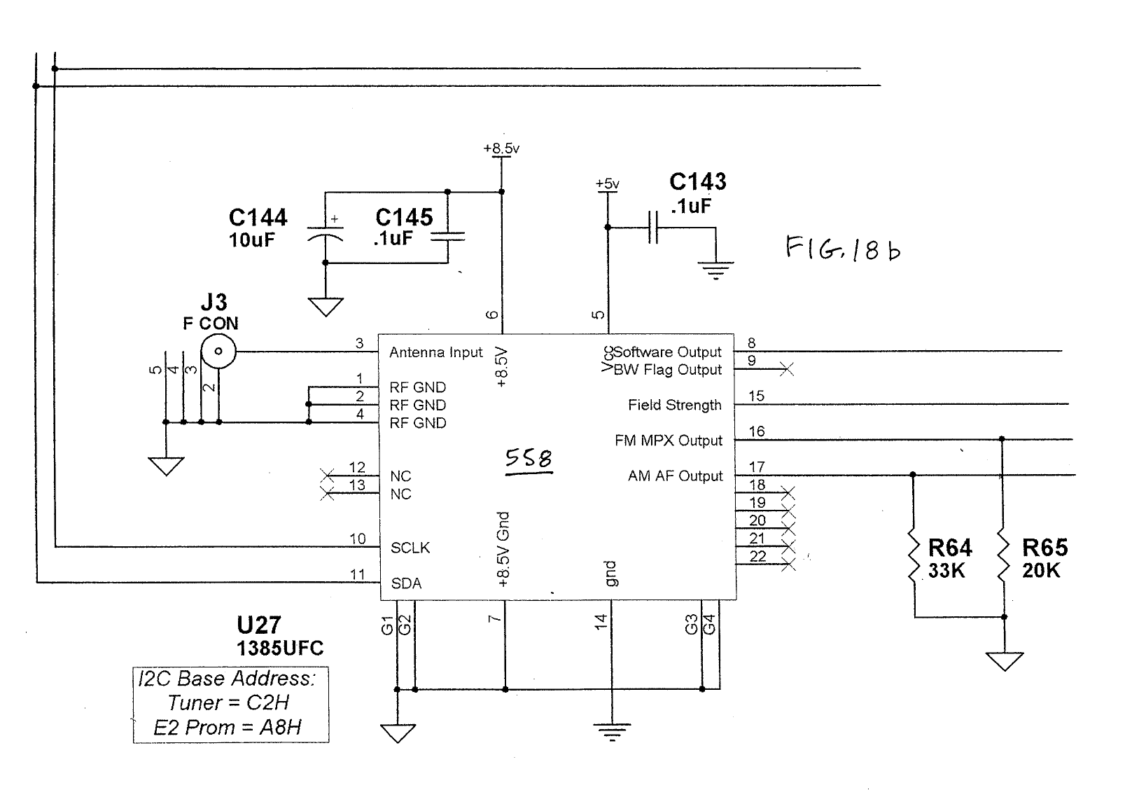

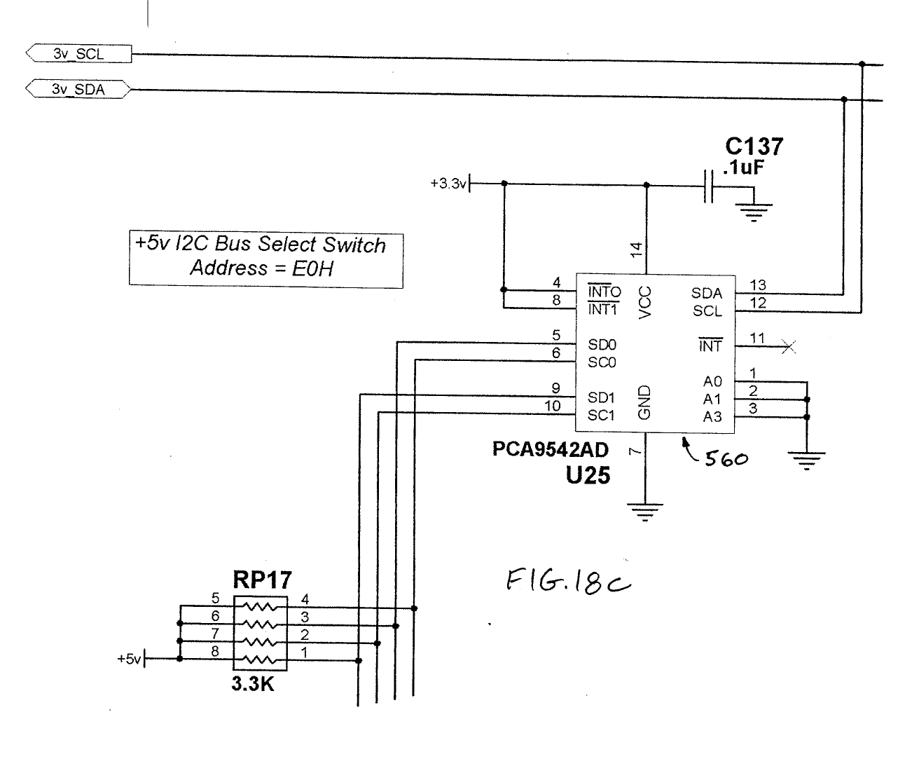

Referring to FIG. 6, a networkable EAS receiver 404 includes antenna or audio input connectors 430 for coupling radio antennas such as antennas 202, 302 for EAS reception to an FSK/tone detector and logic 434. The output of the FSK/tone detector and logic 434 is coupled to an audio recorder and storage 436. The output of audio recorder and storage 436 is coupled to a CPU, memory and network interface 440. The output of CPU, memory and network interface 440 is coupled via an Ethernet port 442, such as an RJ-45 connector, to a LAN/WAN such as LAN/WANs 210, 310. In the networkable EAS receiver 404, additional digital capability is implemented from an analog sensor input port 450 through an Analog-to-Digital (hereinafter sometimes A/D) converter 452 to an input port 454 of CPU, memory and network interface 440. A digital sensor input port 456 is coupled to an input port of a serial interface 458. An output port of serial interface 458 is coupled to an input port 460 of CPU, memory and network interface 440. A real time clock 462 is coupled to a clock port 464 of CPU, memory and network interface 440. Networkable EAS receiver 404 is thus capable of receiving, processing and distributing both analog or digital inputs.

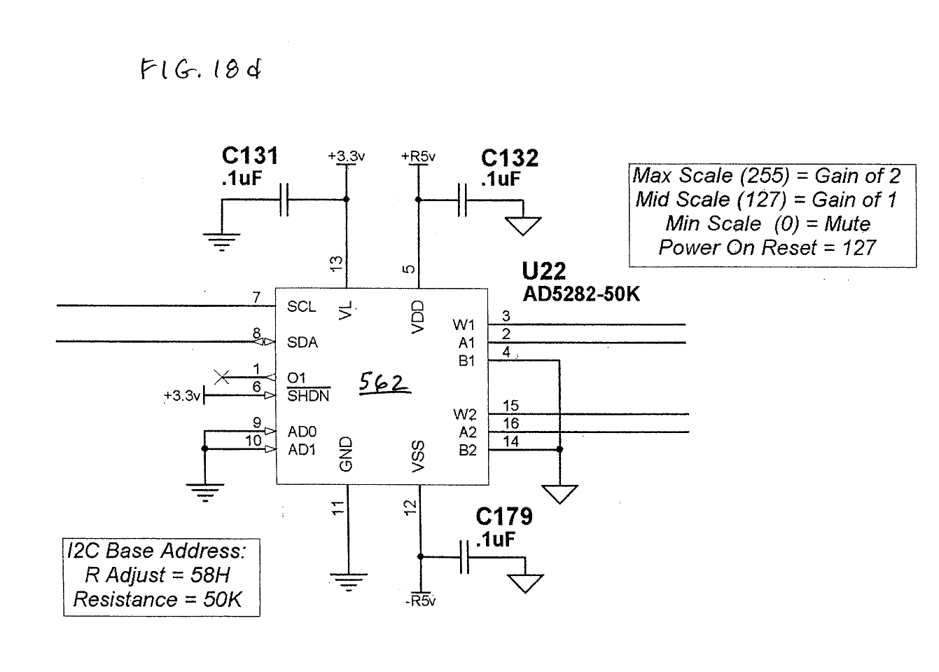

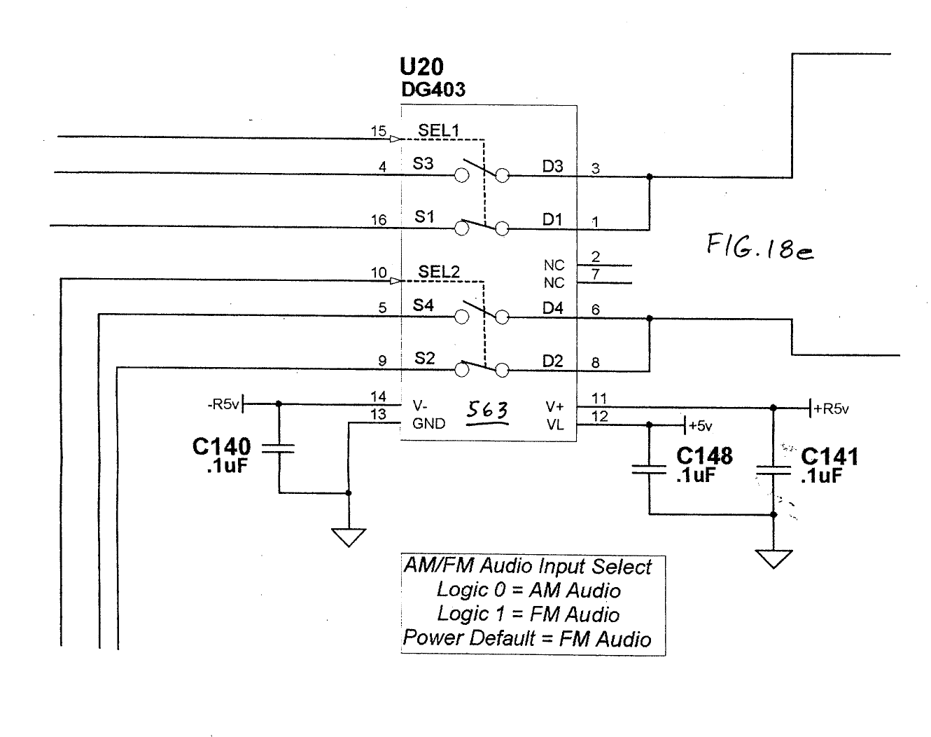

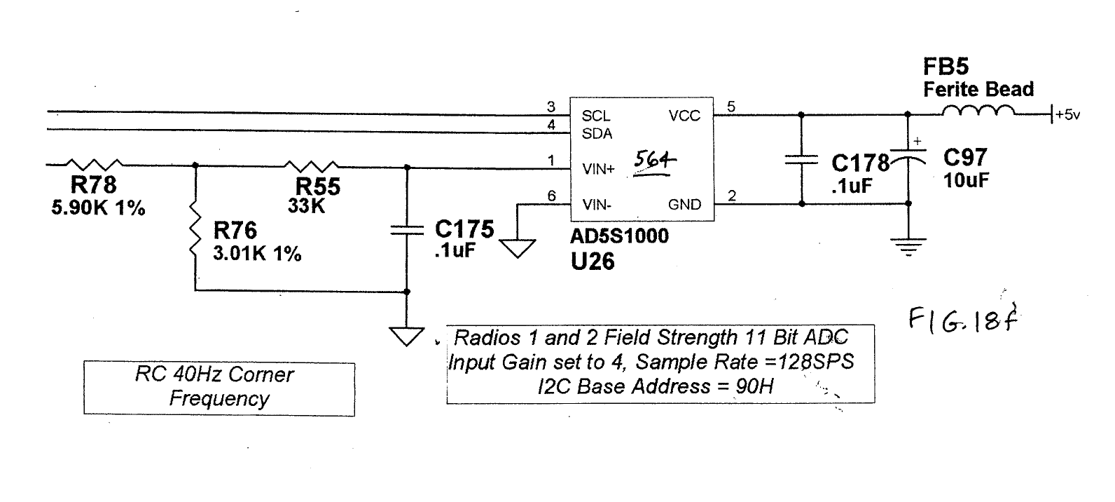

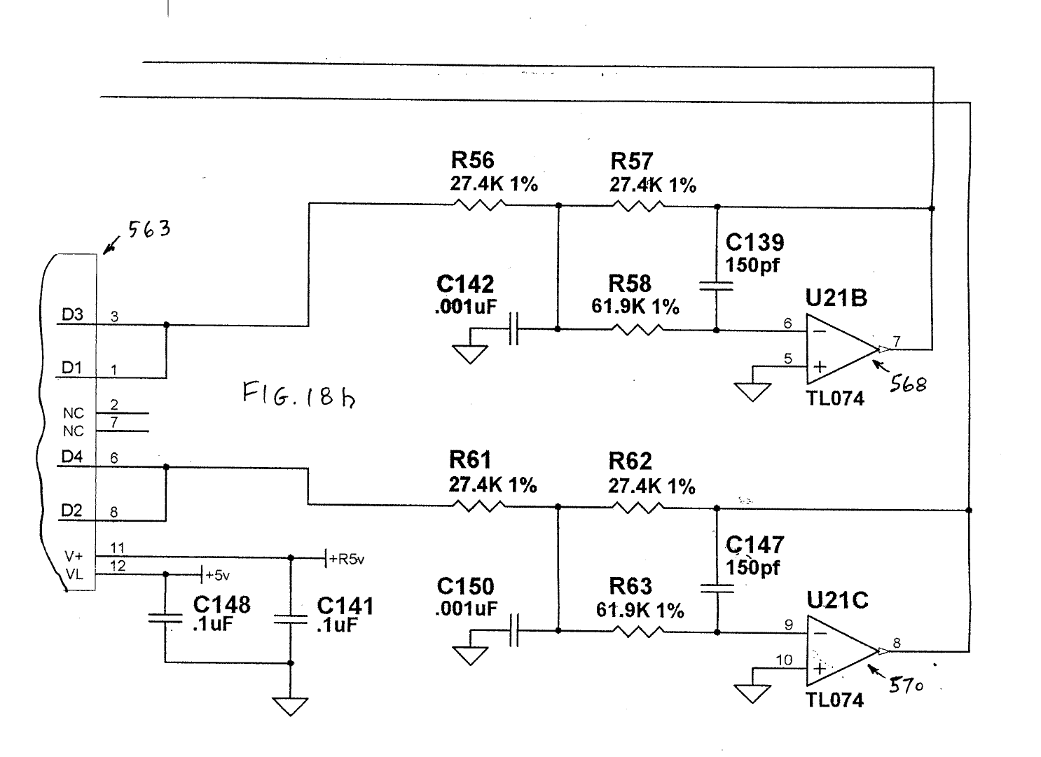

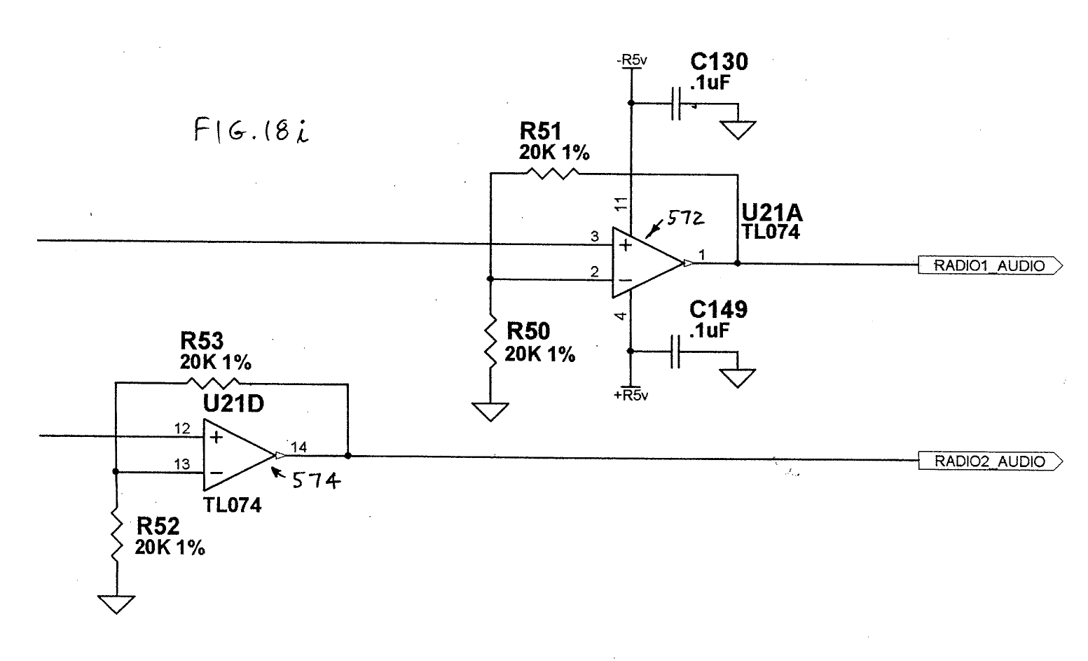

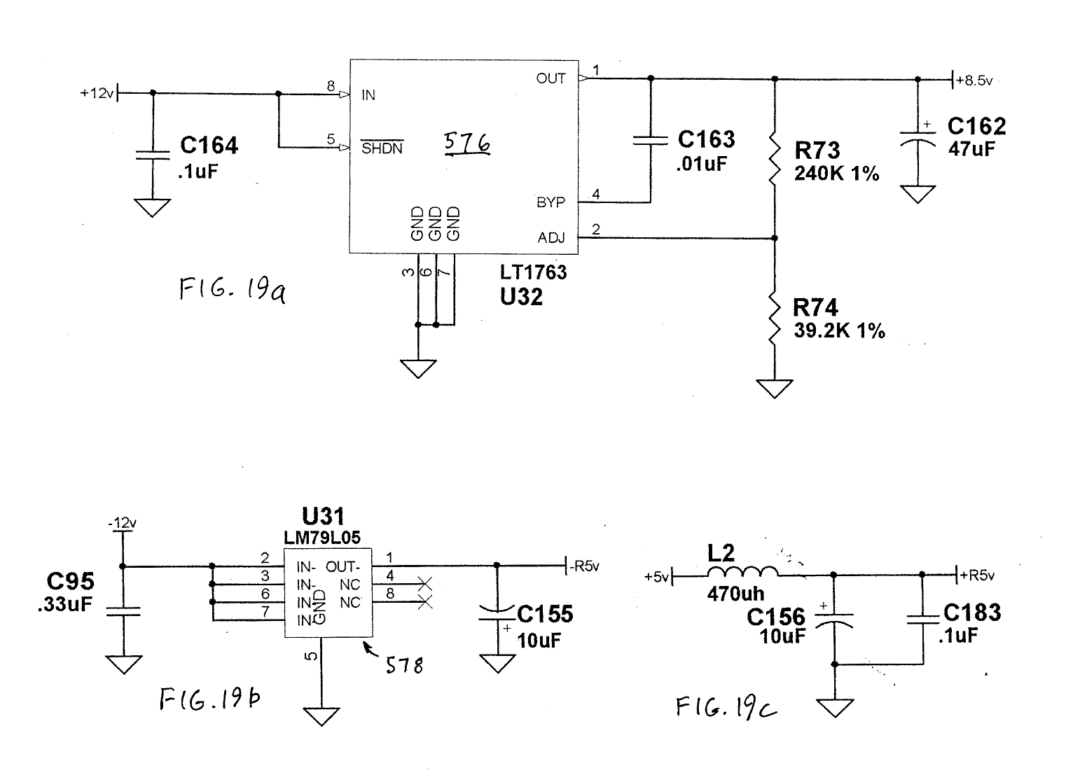

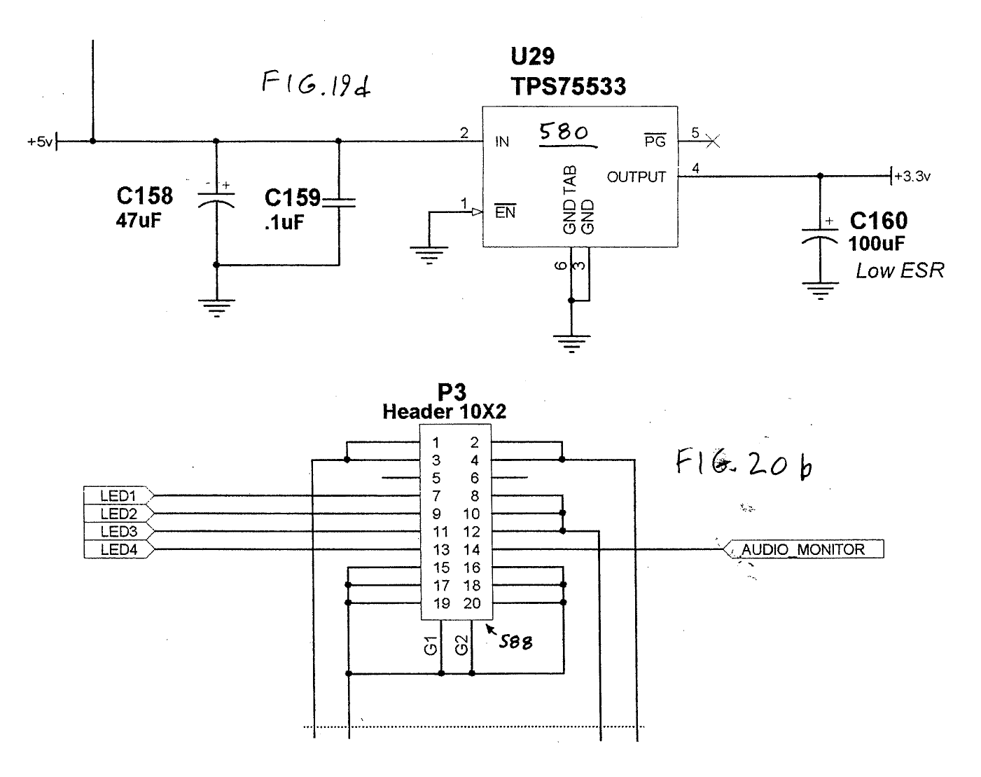

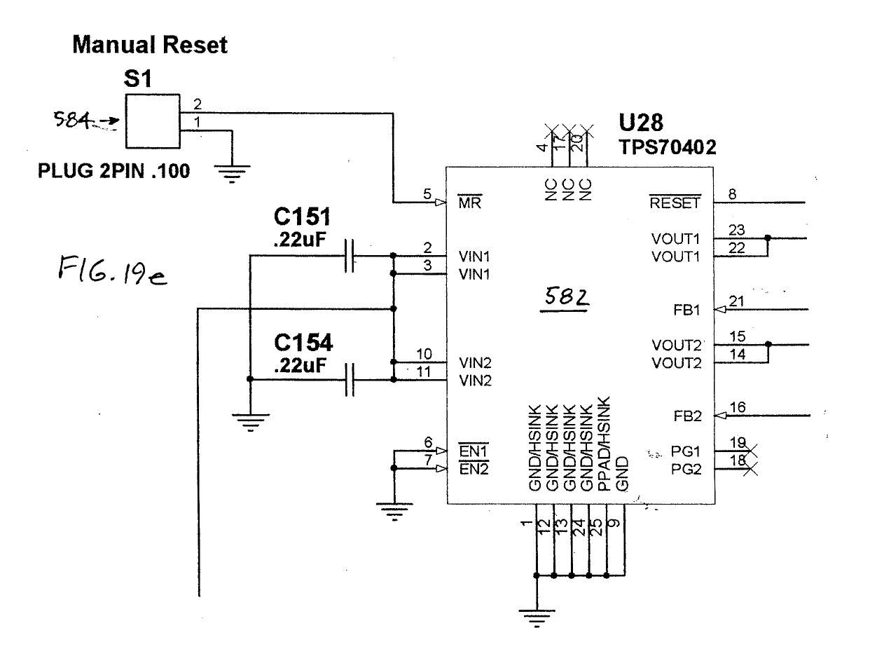

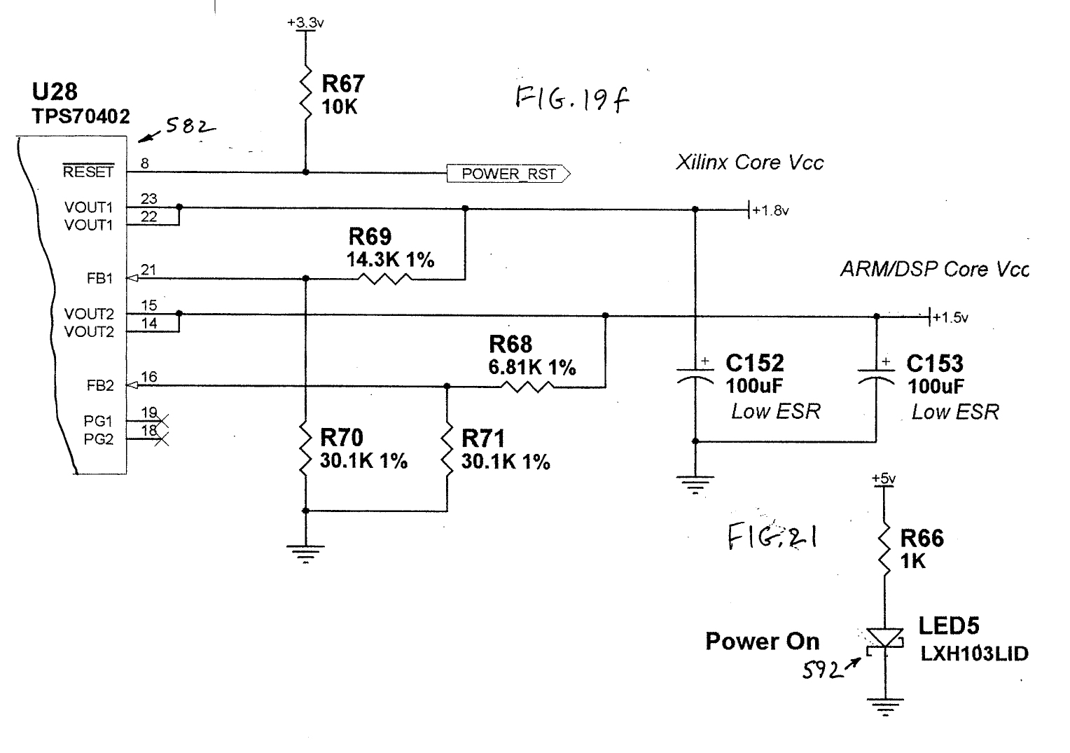

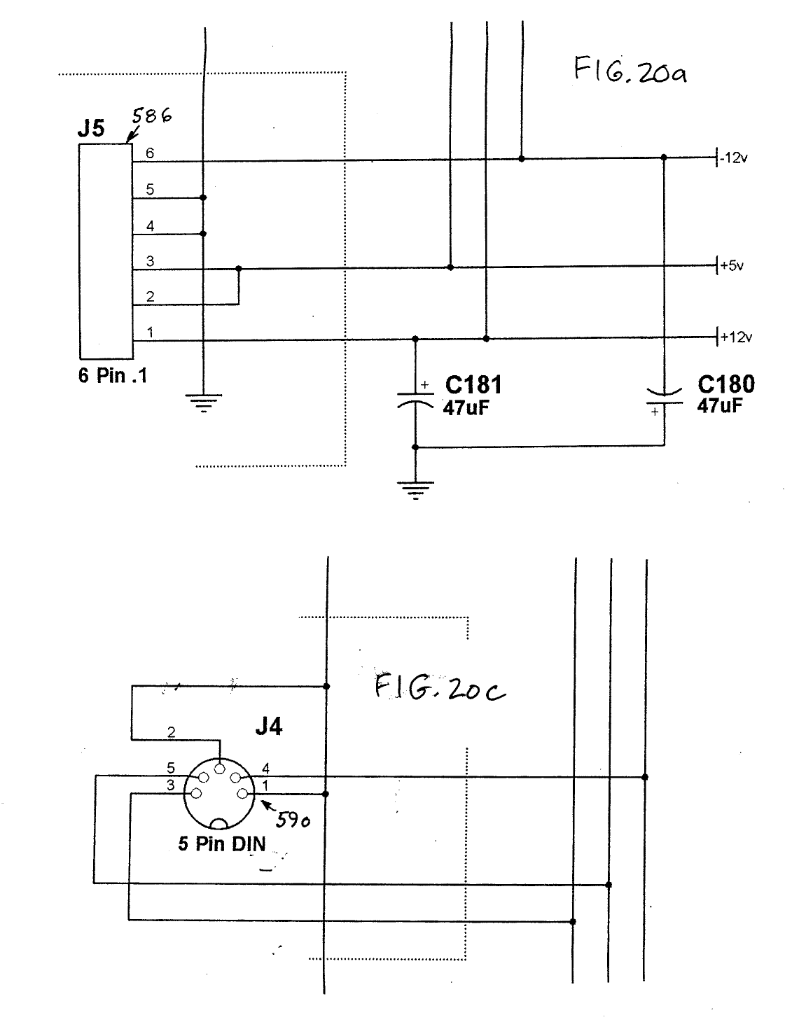

FIGS. 7a-k through 16a-f illustrate block and schematic circuit diagrams of an embodiment of a networkable decoder. In the description that follows, circuit component values, specific discrete and integrated circuit components, and in many instances, specific sources of these components, will be identified. The circuits will be described with reference to those specifically identified components, sometimes referring to terminals by terminal names and numbers and/or pin numbers. This should not be interpreted to mean that these are the only component values or components available from the identified sources or any sources which will perform the necessary functions in the circuits. Indeed, typically there will be a number of suitable discrete and integrated circuit components available from the identified sources and other sources which will perform the necessary functions. Some of such substitute components will use the same terminal/pin identifiers as those noted in this description. Others, however, will use different designations.

Referring first to FIGS. 7a-k, a processor (hereinafter sometimes μP) 500 illustratively is a NetSilicon NS7520 32-bit Acorn (or Advanced) RISC (Reduced Instruction Set Computer) machine (or ARM). The PLLVSS, PLLVDD(1.5 v) and Core VCC terminals, pins L12, L15, R8, L14, C14 and C13, of μP 500 are coupled to +1.5 V supply. The I/O VCC and OSCVCC terminals, pins E4, K4, M2, N3, P3, R5, H14, F14, B8, A3, C3 and N13, of μP 500 are coupled to +3.3 V supply. Referring to FIG. 7b, the notBE0-notBE3 terminals, pins B9, C9, A9 and D9, respectively, are coupled through respective 10 Kohm pull-up resistors to +3.3V supply, and through respective 33 ohm resistors to the system ARM_BE0-ARM_BE3 lines, respectively. Terminals notOE and notWE, pins B6 and C6, respectively, form the system ARM_OE and ARM_WE lines, respectively. Terminals notCAS0, not CAS1, notCAS2, notCAS3, notCS0, notCS1, notCS2, notCS3 and notCS4 are coupled through respective 33 ohm resistors to the system SDRAM_A10, SDRAM_WE, SDRAM_CAS, SDRAM_RAS, FLASH_CS, SDRAM_CS0, SDRAM_CS1, DSP_CS and IO_CS lines, respectively. Terminals notRESET and notRW are coupled to the system ARM_RESET and ARM_R/W lines, respectively.

Referring to FIG. 7c, terminals notTEA, notTA and notTS are coupled through respective 3.3 Kohm resistors to +3.3V. Terminal notTEA is coupled to the system ARM_TA line. Terminals PORTC0/notTXCB/notOUT2B.notDCDB/notLIRQ0/notDONE2 and PORTC2/notDSRB/notLIRQ2/notRSPF of μP 500 are coupled to the system ARM_IRQ0 and ARM_IRQ2 lines, respectively. Terminals PORTA0/notTXCA/notOUT2A/notDCDA, PORTA1/notCTSA/notDONE1, PORTA2/notDSRA/AMUX, PORTA3/RXDA/notDACK1, PORTA4/RXCA/notRIA/notOUT1A, PORTA5/notRSTA, PORTA6/notDTRA and PORTA7/TXDA are coupled to the system SERIAL_DCD, SERIAL_CTS, SERIAL_DSR, SERIAL_RX, SERIAL_RI, SERIAL_RTS, SERIAL_DTR and SERIAL_TX lines, respectively. A 55 MHz clock 502, such as an Epson type SG-710ECK55.000MB0 IC is coupled through a 51 ohm resistor to terminal XTALA1 of μP 500.

Referring to FIG. 7d, terminals notSCANEN, notBISTEN and notPLLTST are coupled through a common 10 Kohm resistor to +3.3V. Pins R13 and P12 are coupled through respective 10 Kohm resistors to ground. Pin N12 is coupled to ground. Terminal notTRST is coupled to the system ARM_TRST line. Terminals TDI, TMS, TCK and TDO are coupled to pins 5, 7, 9 and 11, respectively, of a 2×7 pin ARM JTAG connector 504. Pins 1 and 13 of connector 504 are coupled to +3.3V. Pins 2, 4, 6, 8, 10 and 14 of connector 504 are coupled to ground. Pin 3 of connector 504 is coupled to the system ICE_TRST line, and is coupled through a 2.7 Kohm pull-down resistor to ground. Pin 12 of connector 504 is coupled to the system ICE_SRST line, and through a 2.7 Kohm pull-up resistor to +3.3V.

Referring to FIGS. 7e-f, terminal BCLK of μP 500 is coupled through a 51 ohm resistor to a REF terminal of a buffer IC 506, such as a Cyprus Semiconductor type CY2305 buffer. The VDD and GND terminals of IC 506 are coupled to +3.3V and ground, respectively. The CLK1, CLK2 and CLK3 terminals of IC 506 are coupled through respective 47 ohm resistors to the system ARM_BCLK, SDRAM1_CLK and SDRAM2_CLK lines, respectively. μP 500 terminals ADDR0-ADDR27 are coupled to the system A0-A27 lines, respectively. Referring to FIG. 7g, terminals DATA0-DATA31 are coupled to the system D0-D31 lines, respectively. Referring to FIG. 7h, the system A2-A11, A13, A22 and A23 lines are coupled through respective 33 ohm resistors to the system SDRAM_A0-SDRAM_A9 and SDRAM_A11-SDRAM_A13 lines, respectively. Referring to FIG. 7i, the system A9-A19 and A-24 lines are coupled through respective 2.7 Kohm ARM programming resistors to ground.

Referring to FIG. 7j, μP 500 terminals MDC, MDIO, TXER, TXEN and TXCLK are coupled to the system MDC, MDIO, TX_ER, TX_EN and TX_CLK lines, respectively. Terminals TXD0-TXD3 are coupled through respective 33 ohm resistors to the system TXD0-TXD3 lines, respectively. Terminals TXCOL, RXCRS, RXCLK, RXER and RXDV are coupled to the system COL, CRS, RX_CLK, RX_ER and RX_DV lines, respectively. Terminals RXD0-RXD3 are coupled to the system RXD0-RXD3 lines, respectively. Referring to FIG. 7k, pins D2, F1, J4, K15, R11, P9, M8, P7, B2, A5, A7, C11, B14, D13, E13, G15, K13, P14 and P2 of μP 500 are coupled to ground.

Referring now to FIGS. 8a-d, a programmable logic device IC 510, such as a Xylinx type XC2C128 CPLD IC has its VccIO1, VccIO02 and VAux terminals coupled to +3.3V and its Vcc terminals coupled to +1.8V. Referring to FIG. 8b, the I/O(GTS2), I/O(GTS3) and I/O(GTS0) terminals of IC 510 are coupled to the system RTC_IRQ, ARM_IRQ0 and ARM_IRQ2 lines, respectively. I/O pins 6, 9, 10, 11, 12, 13, 15, 16, 17, 18 and 19 are coupled to the system SPEAKER_ENABLE, FLASH_WP, I2C_IRQ, I2C_SEL, 3v_SCL, 3v_SDA, ICE_SRST, ICE_TRST, ARM_TRST, AUDIO_SEL1 and AUDIO_SEL2 lines, respectively. Terminals I/O(GCK0), I/O(CDRST), I/O(GCK2) and I/O(DGE) of IC 510 are coupled to the system ARM_BCLK, PHY_IRQ, ARM_TA and BARM_R/W lines, respectively. I/O pins 29, 30, 35, 36, 37, 39, 40, 43, 44, 46, 49 and 50 of IC 510 are coupled to the system BARM_OE, BARM_WE, DSP_IRQ, DSP_CS, DSP_HRDY, DSP_RESET, DSP_LOAD, CODEC_DATA_IN, CODEC_DATA_SYNC, XCODEC_DATA_IN, XCODEC_DATA_SYNC and CODEC_INIT lines, respectively. The TDI, TDO, TCK and TMS terminals of IC 510 are coupled to the system JTAG_TDI, JTAG_TDO, JTAG_CLK and JTAG_TMS lines, respectively. The GND terminals, pins 21, 25, 31, 62, 69, 75, 84 and 100, of IC 510 are coupled to ground.

Referring now to FIGS. 8c-d, pins 99, 97 and 96 of IC 510 are coupled to the system POWER_RST, ARM_RESET and SYSTEM_RST lines, respectively. Pins 94-89, 87-85 and 82-76 of IC 510 are coupled to the system BD0-BD15 lines, respectively. Pins 71, 70, 68 and 67 are coupled to the system IO_CS, FLASH_CS, FLASH_CS0 and FLASH_CS1 lines, respectively. Pins 65, 64, 63 and 61 of IC 510 are coupled through respective 1 Kohm resistors to the system LED1-LED4 lines, respectively. The system LED1-LED4 lines are also coupled to the cathodes of respective LEDs, the anodes of which are coupled to +3.3V. These diodes illustratively are type LXH103LID diodes. Pins 59, 58 and 56-52 are coupled to the system BUFFER_EN, BUFFEER_DIR, BA2-BA5 and BA24 lines, respectively.

Referring now to FIGS. 9a-g, the bus buffers for the system include four bus transceiver ICs 514-1-514-4, which illustratively are Philips Semiconductor 74LVC16245A 16-bit bus transceiver ICs. The VCC terminals of all four ICs 514-1-514-4 are coupled to +3.3V (FIGS. 9a-f). The GND terminals of all four are coupled to ground (FIGS. 9a, c, d, f). The 1B1-1B8 and 2B1-2B8 terminals of IC 514-1 are coupled to the system D0-D15 lines, respectively (FIG. 9a). The 1B1-1B8 and 2B1-2B8 terminals of IC 514-2 are coupled to the system D16-D31 lines, respectively (FIG. 9b). 1A1-1A8 and 2A1-2A8 terminals of IC 514-1 are coupled to the system BD0-BD15 lines, respectively (FIG. 9b). 1A1-1A8 and 2A1-2A8 terminals of IC 514-2 are coupled to the system BD16-BD31 lines, respectively (FIG. 9c). The system BUFFER_DIR line is coupled to the 1DIR and 2DIR terminals of each of ICs 514-1 and 514-2 (FIGS. 9a-b). The system BUFFER_EN line is coupled to the not1G and not2G terminals of each of ICs 514-1 and 514-2 (FIGS. 9a-c). The system A0-A15 lines are coupled to terminals 1B1-1B8 and 2B1-2B8 lines, respectively, of IC 514-3 (FIG. 9d). The system A16-A27 lines are coupled to terminals 1B1-1B8 and 2B1-2B4, respectively, of IC 514-4 (FIG. 9e). Terminals 1A1-1A8 and 2A1-2A8 of IC 514-3 are coupled to the system BA0-BA15, lines, respectively (FIG. 9e). Terminals 1A1-1A8 and 2A1-2A4 of IC 514-4 are coupled to the system BA16-BA27 lines, respectively (FIG. 9f). The 1DIR, 2DIR, not1G and not2G terminals of both of ICs 514-3 and 514-4 are coupled to ground (FIGS. 9e-f). Terminal 2B5 of IC 514-4 is coupled to ground (FIG. 9e). Terminals 2B6-2B8 of IC 514-4 are coupled to the system ARM_R/W, ARM_OE and ARM_WE lines, respectively. Terminals 2A6-2A8 of IC 514-4 are coupled to the system BARM_R/W, BARM_OE and BARM_WE lines, respectively (FIGS. 9f-g).

Referring now to FIGS. 10a-f, the system random access memory illustratively includes two SDRAM ICs 516-1, 516-2 which illustratively are Micron type MT48LC4M32B2TG-6128 Mb×32 SDRAM ICs. The VDD and VDDQ terminals of ICs 516-1, 516-2 are coupled to +3.3V (FIGS. 10a, d). The VSS and VSSQ terminals of ICs 516-1, 516-2 are coupled to ground (FIGS. 10c, f). The CKE, notWE, notCAS and notRAS terminals of both of ICs 516-1, 516-2 are coupled to +3.3V, the system SDRAM_WE line, the system SDRAM_CAS line and the system SDRAM_RAS line, respectively (FIGS. 10b, c, e and f). The notCS terminal of IC 516-1 is coupled to the system SDRAM_CS0 line FIG. 10b). The notCS terminal of IC 516-2 is coupled to the system SDRAM_CS1 line (FIGS. 10b, c, e and f). The CLK terminal of IC 516-1 is coupled to the system SDRAM1_CLK line (FIG. 10b). The CLK terminal of IC 516-2 is coupled to the system SDRAM2_CLK line (FIG. 10e). The system ARM_BE0-ARM_BE3 lines are coupled to the DQM0-DQM3 lines of both of ICs 516-1, 516-2 (FIGS. 10b and e). The A0-A11, BA0 and BA1 terminals of both of ICs 516-1, 516-2 are coupled to the system SDRAM_A0-SDRAM_A13 lines, respectively (FIGS. 10b and e). The system D0-D31 lines are coupled to the DQ0-DQ31 terminals, respectively, of both of ICs 516-1, 516-2 (FIGS. 10b, c, e and f).

Referring now to FIGS. 11a-e, the system flash memory illustratively includes four flash memory ICs 517-1-517-4 (FIGS. 11a-d). ICs 517-1-517-4 may be, for example, Spansion type S29GL064/128 flash memory ICs. The system BA2-BA26 lines are coupled to the A0-A24 terminals, respectively, of each of ICs 517-1 and 517-2 (FIGS. 11a, b and e). The system BA2-BA23 lines are coupled to the A0-A21 terminals, respectively, of each of ICs 517-3 and 517-4 (FIGS. 11a-e). The system BD16-BD31 lines are coupled to the DQ0-DQ-15 terminals, respectively, of each of ICs 517-1 and 517-3 (FIGS. 11a, c and e). The system BD0-BD15 lines are coupled to the DQ0-DQ15 terminals, respectively, of each of ICs 517-2 and 517-4 (FIGS. 11a-e). The system FLASH_CS0 line is coupled to the notCE terminals of ICs 517-1, 517-2 (Figs. a, b and e). The system FLASH_CS1 line is coupled to the notCE terminals of ICs 517-3, 517-4 (FIGS. 11c-d). The system BARM_OE line is coupled to the notOE terminals of all of ICs 517-1-517-4 (FIGS. 11a-e). The system BARM_WE line is coupled to the notWE terminals of all of ICs 517-1-517-4. The SYSTEM_RST line is coupled to the notRESET terminals of all of ICs 517-1-517-4. The system FLASH_WP line is coupled to the notWP terminals of ICs 517-1 and 517-2, and to ground through a 2.7 Kohm resistor. The notWP terminals of ICs 517-3 and 517-4 are coupled to +3.3V. The notBYTE, VIO and VCC terminals of all of ICs 517-1-517-4 are coupled to +3.3V. The GND terminals of all of ICs 517-1-517-4 are coupled to ground.

Referring now to FIGS. 12a-d, the system's Ethernet transceiver 518 illustratively includes an Intel type LXT971A fast Ethernet transceiver IC. IC 518's VCCIO and VCCD terminals are coupled to +3.3V. Its VCCA terminals are coupled through a Murata BLM21PG221SN1 ferrite bead to +3.3V (FIG. 12b). Referring back to FIG. 12a, the notMDINT, notRESET, MDC, MDIO, CRS and COL terminals of IC 518 are coupled to the system PHY_IRQ, SYSTEM_RST, MDC, MDIO, CRS and COL lines, respectively. The system TXD0-TXD3 lines are coupled to the TXD0-TXD3 terminals, respectively, of IC 518. The system TX_EN and TX_ER lines are coupled to the TX_EN and TX_ER terminals, respectively, of IC 518. The system TX_CLK line is coupled through a 33 ohm resistor to the TX_CLK terminal of IC 518. The system RXD0-RXD3 lines are coupled through respective 33 ohm resistors to the RXD0-RXD3 terminals of IC 518. The system RX_DV and RX_ER lines are coupled to the RX_DV and RX_ER terminals, respectively, of IC 518. The system RX_CLK line is coupled through a 33 ohm resistor to the RX_CLK terminal of IC 518. Referring now to FIG. 12C, the address of the physical layer interface IC 518 is established by the connections of terminals ADDR0-ADDR4. In the illustrated example, terminals ADDR0-ADDR2 and ADDR4 are coupled to ground and ADDR3 is coupled to +3.3V, making the address 08 hexadecimal. Terminals SD/notTP, PWRDWN, MDDIS, PAUSE and SLEEP are coupled to ground.

Referring now to FIGS. 12b and d, terminals LED/CFG3 and LED/CFG2 are coupled to pins 12 and 10, respectively, of an RJ45 connector 520, which illustratively is a PulseJack RJ45 connector. Pin 11 of connector 520 is coupled through a 220 ohm resistor to ground. Pin 9 of connector 520 is coupled through a 220 ohm resistor to +3.3V. Terminals TPFIN and TPFIP of IC 518 are coupled through respective 270 pF capacitors to pins 8 and 7, respectively, of connector 520. Terminals TPFON and TPFOP of IC 518 are coupled to pins 2 and 1, respectively, of connector 520. Terminal RBIAS of IC 518 is coupled through a 22.1 Kohm resistor to ground. Terminal LED/CFG1 of IC 518 is coupled through a 10 Kohm resistor to +3.3V. Terminals TXSLEW0 and TXSLEW1 of IC 518 are coupled to ground. Referring back to FIG. 12c, a 25 MHz crystal oscillator is coupled across terminals REFCLK/XI and XO of IC 518. Pin 3 of connector 520 is coupled to ground through a 0.1 μF capacitor and to the VCCA terminals of IC 518 through a Murata BLM21PG221SN1 ferrite bead (FIGS. 12b and d). The VCCA terminals are also coupled to ground through the parallel combination of a 0.01 μF capacitor and a 0.1 μF capacitor. Pins 7 and 8 of connector 520 are coupled through respective 49.9 ohm resistors to a common point which is coupled through a 0.01 μF capacitor to ground. The GND terminals, pins 7, 11, 18, 25, 34, 35, 41, 50 and 61, of connector 520 are coupled to ground (FIG. 12c).

Referring now to FIG. 13, the system's real time clock comprises a real time clock IC 522, such as a Dallas Semiconductor type DS3231 real time clock IC. Referring to FIGS. 14a-b, the system's I2C interface comprises an I2C interface IC 524, such as a Philips Electronics type PCA9564A I2C controller IC. The SDA and SCL terminals of each of real time clock IC 522 and I2C interface IC 524 are coupled to the system 3v_SDA and 3v_SCL lines, respectively. The VCC terminals of both are coupled to +3.3V (FIGS. 13 and 14a). The GND terminals of both are coupled to ground. The BATT terminal of real time clock IC 522 is coupled to the anode of a 3V backup battery, and to one terminal of a 0.1 μF capacitor. The cathode of the 3V backup battery and the other terminal of the 0.1 μF capacitor are coupled to ground. The notINT/SQW terminal of IC 522 is coupled to the system RTC_IRQ line, and through a 1.5 Kohm pull-up resistor to +3.3V. Pins 5-12 of IC 522 are coupled to ground.

Referring to FIG. 14b, the D0-D7 terminals of IC 524 are coupled to the system BD0-BD7 lines, respectively. The A0 and A1 terminals of IC 524 are coupled to the system BA2 and BA3 lines, respectively. The notRESET, notRD, notWR and notCE terminals of IC 524 are coupled to the system SYSTEM_RESET, BARM_OE, BARM_WE and I2C_SEL lines, respectively. The notINT, SCL and SDA terminals of IC 524 are coupled, respectively, through a 1.5 Kohm pull-up resistor, a 2 Kohm pull-up resistor and a 2Kohm pull-up resistor to +3.3V. The notINT terminal is also coupled to the system I2C_IRQ line. An I2C expansion bus includes a 2×5 pin connector 526 having pins 2 and 4 coupled to +5V, pins 3 and 7 coupled to ground, and pins 1 and 5 coupled to the system 3v_SDA and 3v_SCL lines, respectively.

Referring now to FIG. 15, the system RS232 interface includes an RS232 serial port driver-receiver IC 528, such as an Analog Devices type ADM3311E RS232 serial port driver-receiver IC. The system SERIAL_DCD, SERIAL_DSR, SERIAL_CTS, SERIAL_RX, SERIAL_RI, SERIAL_DTR, SERIAL_RTS and SERIAL_TX lines are coupled to the R1OUT, R2OUT, R3OUT, R4OUT, R5OUT, T1IN, T2IN and T3IN terminals, respectively, of IC 528. The R1IN, R2IN, R3IN, R4IN, R5IN, T1OUT, T2OUT and T3OUT terminals of IC 528 are coupled to pins 1, 2, 6, 3, 8, 7, 4 and 5, respectively, of a 2×5 pin RS232 connector 530. Terminals V−, V+, VCC, SD, notEN and GND of IC 528 are coupled through a 0.1 μF capacitor to ground, through a 0.1 μF capacitor to +3.3V, to +3.3V, to ground, to ground and to ground, respectively. Terminals C1+ and C1− are coupled through a 0.1 μF capacitor; terminals C2+ and C2− are coupled through a 0.1 μF capacitor; and, terminals C3+ and C3− are coupled through a 0.1 μF capacitor.

Referring now to FIGS. 16a-i, the system includes a digital signal processor comprising a DSP IC 532, such as a Texas Instruments TMS320VC5410APGE-160 DSP. The DVDD terminals of IC 532 are coupled to +3.3V. Referring to FIG. 16b, the CVDD terminals of IC 532 are coupled to +1.5V. Referring to FIG. 16c, the A16-A0 terminals of IC 532 are coupled to the system BA18-BA2 lines, respectively. The D15-D0 terminals of IC 532 are coupled to the system BD15-BD0 lines, respectively. The HD7, HD6 and HD0 terminals of IC 532 are coupled to the system CODEC_INIT, CODEC_RESET and DSP_IRQ lines, respectively. Referring to FIG. 16d, the HCNTL1, HCNTL0, HBIL, /HAS, HPIENA, HPI16, /BIO, READY and /HOLD terminals of IC 532 are coupled to +3.3V. Terminals /HCS, /HDS1, /HDS2, HR//W and HRDY of IC 532 are coupled to the system lines DSP_CS, BARM_OE, BARM_WE, BARM_R/W and DSP_HRDY, respectively. Referring to FIG. 16e, terminals /INT0, /INT1, /INT2, /INT3 and /NMI are coupled through respective 4.7 Kohm resistors to +3.3V. /INT1 and /INT2 are also coupled to the system DSP_LOAD line (FIG. 16f) and /HINT terminal (FIG. 16d) of IC 532, respectively. Returning to FIG. 16f, terminal TOUT of IC 532 is coupled to the system DSP_BEEP line. Terminal BFSR0 of IC 532 is coupled to terminal BFSX0. Terminal BCLKX0 of IC 532 is coupled to terminal BCLKR0. Terminals BFSX0, BDX0, BDR0, and BCLKR0 are coupled through respective 10 ohm resistors to the system XCODEC_DATA_SYNC, XCODEC_DATA_IN, CODEC_DATA_OUT and CODEC_DATA_CLK lines, respectively. Terminal BFSX1 of IC 532 is coupled to terminal BFSR1. Terminal BCLKX1 of IC 532 is coupled to terminal BCLKR1. Terminal BFSX2 of IC 532 is coupled to terminal BFSR2. Terminal BCLKX2 of IC 532 is coupled to terminal BCLKR2. Terminals BDR1 and BDR2 are coupled to ground. Referring to FIG. 16g, terminals TCK, TDI, TDO, TMS, /TRST, EMU0 and EMU1 of IC 532 are coupled to the system JTAG_CLK line, the system JTAG_TDI line, the system JTAG_TDO line, the JTAG_TMS line, pin 2 of a 2×7 pin Molex 713491039 connector 534, through a 4.7 Kohm resistor to +3.3V (FIG. 16e) and through a 4.7 Kohm resistor to +3.3V (FIG. 16e), respectively. Turning again to FIG. 16g, terminals TCK, TDI, TDO, TMS, EMU0 and EMU1 are also coupled to pins 11, 3, 7, 1, 13 and 14 of connector 534. Pin 5 of connector 534 is coupled to +3.3V. Pin 9 of connector 534 is coupled to pin 11. Pins 4, 8, 10 and 12 of connector 534 are coupled to ground. Referring now to FIG. 16h, terminals CLKMD3, CLKMD1, MP//MC and VSS of IC 532 are coupled to ground. Terminal CLKMD2 is coupled to +3.3V. Terminal CLKOUT is coupled to the system DSP_CLOCK OUT line. Terminal /RS is coupled to the system DSP_RESET line. Terminal X2/CLKIN is coupled to the CODEC_CLK line (FIG. 16i). The CODEC_CLK line is driven by a 24.576 MHz clock IC 535, the VDD and OE terminals of which are coupled to +3.3V, the GND terminal of which is coupled to ground and the OUT terminal of which is coupled through a 75 ohm resistor to the CODEC_CLK line. IC 535 illustratively is a Epson type SG-8002JC-PCC-ND 24.576 MH IC.

Referring now to FIGS. 17a-h, the system's audio coder/decoder comprises a audio codec IC 536 (FIGS. 17a-c), such as a Cirrus Logic type CS4205 audio codec. Signals are supplied to IC 536 from 6-pin, 3.5 mm connector 538 (FIG. 17d) through right- and left-channel unity gain buffer amplifier ICs 540, 542 (FIGS. 17d-e), respectively. ICs 540, 542 illustratively are Texas Instruments type INA134 amplifier ICs. Referring to FIG. 17f, the MONO_OUT terminal of IC 536 is coupled through a unity gain buffer amplifier 544, such as a National Semiconductor type LMV321 IC, to a speaker audio amplifier IC 546 (FIG. 17g) such as a National Semiconductor type LM4862M audio amplifier IC. Referring back to FIG. 17d, the right channel signal is coupled from pins 1 and 3 of connector 538 to terminals +IN and −IN, respectively, of IC 540. The left channel signal is coupled from pins 4 and 6 of connector 538 to terminals +IN and −IN, respectively, of IC 542. Terminals +IN and −IN of IC 540 and +IN and −IN of IC 542 are coupled through respective 301 ohm resistors to ground. The V+terminals of ICs 540, 542 are coupled to +12V. The V-terminals of ICs 540, 542 are coupled to −12V. Referring to FIG. 17e, the SENSE and VOUT terminals of IC 540 are coupled to an S1 terminal of an analog switch IC 548 such as a Maxim type DG403 analog switch IC. The SENSE and VOUT terminals of IC 542 are coupled to an S2 terminal of IC 548. The system RADIO1_AUDIO line is coupled to terminal S3 of IC 548. The system RADIO2 AUDIO line is coupled to terminal S4 of IC 548. The V+, V−, VL and GND terminals of IC 548 are coupled to +12V, −12V, +5V and ground, respectively.

Depending upon the IC 548 switch position, either the inputs on S1 and S2 or the inputs on S3 and S4 are provided through respective series 1 Kohm resistor-0.33 μF capacitor circuits (FIG. 17a) to LINE_IN_L and LINE_IN_R, respectively, of IC 536. The common terminal of each series 1 Kohm resistor-0.33 F capacitor circuit is coupled through a 0.01 μF capacitor to ground. Each of inputs LINE_IN_L and LINE_IN_R of IC 536 is coupled to the cathode of a respective Schottky diode, the anode of which is coupled to ground, and to the anode of a respective Schottky diode, the cathode of which is coupled to +5AV. Referring to FIG. 17b, the AVDD terminal of IC 536 is coupled to +5V through a 470 μH inductor. The DVDD terminals of IC 536 are coupled to +3.3V. The VREF terminal of IC 536 is coupled through the parallel combination of a 0.1 μF capacitor and a 1 μF capacitor to ground (FIG. 17a). The VREFOUT terminal of IC 536 is coupled to the + input terminal of amplifier 544 (FIG. 17f). Referring to FIG. 17c, the SDATA_IN, SDATA_OUT, BIT_CLK, SYNC, XTL_IN and /RESET terminals of IC 536 are coupled to the system CODEC_DATA_OUT, CODEC_DATA_IN, CODEC_DATA_CLK, CODEC_DATA_SYNC, CODEC_CLK and CODEC_RESET lines, respectively. The AVSS, NC4 and DVSS terminals of IC 536 are coupled to ground. The NC2 terminal of IC 536 is coupled to +5AV.

The MONO_OUT terminal of IC 536 is coupled through a 20 Kohm resistor to the—input terminal of amplifier 544 (FIG. 17f). The output terminal of amplifier 544 is coupled through a 20 Kohm resistor to its—input terminal. The output terminal of amplifier 544 is coupled through a 1 Kohm resistor to the system AUDIO_MONITOR line, and through the series combination of a 0.33 μF capacitor and a 10 Kohm resistor to the −IN input terminal of audio amplifier IC 546 (FIG. 17g). A two pin connector 550 for connection of an audio speaker (not shown) is coupled across the Vo01 and Vo2 terminals of IC 546. A 20 Kohm feedback resistor is coupled between terminals Vo1 and −IN. Terminals +IN and BYPASS are coupled together and to ground through a 0.22 μF capacitor. Terminal VDD is coupled to +5V. Terminal GND is coupled to ground. Terminal SHUTDOWN is coupled through a 20 Kohm resistor to +5V, as well as to the collector of a transistor 552 (FIG. 17h), such as an ON Semiconductor type MMUN2211LT1 NPN transistor. The base of transistor 552 is coupled through a 10 Kohm resistor to the system SPEAKER_ENABLE line. The base is also coupled to ground through a 10 Kohm resistor. The emitter of transistor 552 is coupled to ground.

The system includes a radio module comprising a pair 556 (FIG. 18a), 558 (FIG. 18b) of radio ICs, such as Microtune type 1384WFC radio ICs. A 1-to-2 bidirectional multiplexer IC 560 (FIG. 18c), such as a Philips Semiconductor type PCA9542AD multiplexer IC, controls radios 556, 558 via the I2C bus. A dual channel, digital potentiometer 562 (FIG. 18d), such as an Analog Devices AD5282-50 Kohm potentiometer, controls the output levels of the radios 556, 558 which are available on the system. Each radio 556, 558 includes an F connector for coupling an antenna (not shown) to the Antenna Input terminal of the radio 556, 558. The +8.5V terminal of each radio 556, 558 is coupled to +8.5V. The Vcc terminal of each radio 556, 558 is coupled to +5V. The SD0, SC0, SD1 and SC1 terminals of IC 560 (FIG. 18c) are coupled through respective 3.3 Kohm resistors to +5V. The SD0 and SC0 terminals of IC 560 are also coupled to the SDA and SCLK terminals, respectively, of radio 556. The SD1 and SC1 terminals of IC 560 are also coupled to the SDA and SCLK terminals, respectively, of radio 558. The Software Output terminals of radios 556, 558 are coupled to the SEL1 and SEL2 terminals, respectively, of an analog switch IC 563 (FIG. 18e). Again, analog switch IC 563 may be a Maxim type DG403 analog switch IC. The V+, V−, VL and GND terminals of IC 563 are coupled to +5V, −5V, +5V and ground, respectively. The FM MPX Output terminals of radios 556 (FIG. 18a), 558 (FIG. 18b) are coupled to terminals S1 and S2, respectively, of IC 563 (FIG. 18e). The FM MPX Output terminals of radios 556 (FIG. 18a), 558 (FIG. 18b) are also coupled through respective 20 Kohm resistors to ground. The AM AF Output terminals of radios 556, 558 are coupled to terminals S3 and S4 of IC 563 (FIG. 18e). The AM AF Output terminals of radios 556 (FIG. 18a), 558 (FIG. 18b) are also coupled through respective 33 Kohm resistors to ground.

The Field Strength output terminal of radio 556 (FIG. 18a) is coupled through series 5.9 Kohm and 33 Kohm resistors to the VIN+ input terminal of an analog-to-digital converter IC 564 (FIG. 18f), such as a Texas Instruments type AD5S1000 analog-to-digital converter IC. The Field Strength output terminal of radio 558 (FIG. 18b) is coupled through series 5.9 Kohm and 33 Kohm resistors to the VIN+ input terminal of a analog-to-digital converter IC 566 (FIG. 18g), again, such as a Texas Instruments type AD5S1000 analog-to-digital converter IC. The SCL and SDA terminals of IC 564 (FIG. 18f) are coupled to the SC0 and SD0 terminals, respectively, of IC 560 (FIG. 18c). The SCL and SDA terminals of IC 566 (FIG. 18g) are coupled to the SC1 and SD1 terminals, respectively, of IC 560 (FIG. 18c). The common terminal of each 5.9 Kohm and 33 Kohm resistor (FIGS. 18f, g) is coupled through a 3.01 Kohm resistor to ground. The VIN+ terminal of each of ICs 564, 566 is coupled through a respective 0.1 μF capacitor to ground. The G1-G4, +8.5V Gnd and gnd terminals of radios 556, 558 (FIGS. 18a, b) are coupled to ground. The VCC terminal of each of ICs 564, 566 is coupled through a respective Murata BLM21PG221SN1 ferrite bead to +5V, and through a respective parallel combination of a 10 μF capacitor and a 0.1 μF capacitor to ground. The GND and −VIN terminals of each of ICs 564, 566 are coupled to ground.

The D1 and D3 output terminals of IC 562 (FIG. 18d) are joined and coupled through the series combination of a 27.4 Kohm resistor and a 27.4 Kohm resistor (FIG. 18h) to the output terminal of an amplifier IC 568, such as a Texas Instruments type TL074 amplifier IC. The common terminal of the two 27.4 Kohm resistors is coupled through a 0.001 μF capacitor to ground and through a 61.9 Kohm resistor to the—input terminal of IC 568. The output terminal of IC 568 is coupled to the—input terminal of IC 568 through a 150 pF capacitor. The + input terminal of IC 568 is coupled to ground. The D2 and D4 output terminals of IC 562 are joined and coupled through the series combination of a 27.4 Kohm resistor and a 27.4 Kohm resistor to the output terminal of an amplifier IC 570, again, such as a Texas Instruments type TL074 amplifier IC. The common terminal of the two 27.4 Kohm resistors is coupled through a 0.001 μF capacitor to ground and through a 61.9 Kohm resistor to the—input terminal of IC 570. The output terminal of IC 570 is coupled to the—input terminal of IC 570 through a 150 pF capacitor. The +input terminal of IC 570 is coupled to ground.

The output terminals of ICs 568, 570 are coupled to the A1, A2 terminals, respectively, of IC 562 (FIG. 18d). The VL and notSHDN terminals of IC 562 are coupled to +3.3V. The VDD terminal of IC 562 is coupled to +R5V. The VSS terminal of IC 562 is coupled to −R5V. The AD0, AD1, GND, B1 and B2 terminals of IC 562 are coupled to ground. The W1 and W2 terminals of IC 562 are coupled to the + input terminals of respective amplifier ICs 572, 574 (FIG. 18i). Amplifier ICs 572, 574 illustratively are Texas Instruments type TL074 amplifier ICs. The output terminal of IC 572 is coupled through a 20 Kohm resistor to its—input terminal. The—input terminal of IC 572 is coupled to ground through a 20 Kohm resistor. The output terminal of IC 574 is coupled through a 20 Kohm resistor to its—input terminal. The—input terminal of IC 574 is coupled to ground through a 20 Kohm resistor. The output terminal of IC 572 is coupled to the system RADIO1_AUDIO line. The output terminal of IC 574 is coupled to the system RADIO2_AUDIO line.

Referring now to FIGS. 19a-f, power supplies for the system include a +8.5V regulator IC 576, such as a Linear Technologies type LT1763 regulator IC. The IN terminal of IC 576 is coupled to +12V supply and through a 0.1 μF capacitor to ground. The OUT terminal, on which appears +8.5V, is coupled through a 0.01 μF capacitor to the BYP terminal of IC 576, through a series voltage divider including a 240 Kohm resistor and a 39.2 Kohm resistor to ground, and through a 47 μF capacitor to ground. The common terminal of the 240 Kohm and 39.2 Kohm resistors is coupled to the ADJ terminal of IC 576. The GND terminals are coupled to ground.

Referring to FIG. 19b, the system power supplies also include a −5V regulator IC 578, such as a National Semiconductor type LM79L05 −5V regulator IC. The IN-terminals are coupled to a −12V supply and to ground through a 0.33 μF capacitor. The OUT-terminal, on which appears regulated −5V (−R5V), is coupled to ground through a 10 μF capacitor. The GND terminal of IC 578 is coupled to ground.

Referring to FIG. 19c, the power supplies further include a passive +5V to +Regulated 5V supply including a 470 μH inductor coupled to +5V. At its other terminal, coupled to ground through the parallel combination of a 10 μF capacitor and a 0.1 μF capacitor, appears +R5V.

Referring to FIG. 19d, the power supplies further include a +5V to +3.3V supply including a +5V to +3.3V IC regulator 580, such as a Texas Instruments type TPS75533 IC regulator. +5V is coupled to the IN terminal of IC 580, which is also coupled to ground through the parallel combination of a 47 μF capacitor and a 0.1 μF capacitor. +3.3V appears on the OUTPUT terminal of IC 580, which is coupled to ground through a 100 μF capacitor. The notEN, GND TAB and GND terminals of IC 580 are coupled to ground.

Referring to FIGS. 19e, f, the system POWER_RESET line, +1.8V and +1.5V supplies (FIG. 19f) are provided by a voltage regulator IC 582, such as a Texas Instruments type TPS70402 voltage regulator IC. +5V (from FIG. 19d) is coupled to the VIN1 and VIN2 terminals of IC 582 (FIG. 19e), which are also coupled to ground through parallel 0.22 μF capacitors. A manual reset button 584 is coupled between the notMR terminal of IC 582 and ground. The notRESET terminal of IC 582 is coupled to the system POWER_RST line (FIG. 19f). The notRESET terminal of IC 582 is also coupled through a 10 Kohm pull-up resistor to +3.3V. The VOUT1 terminals of IC 582 are coupled through the series combination of a 14.3 Kohm resistor and a 30.1 Kohm resistor to ground. The common terminal of the 14.3 Kohm and 30.1 Kohm resistors is coupled to the FB1 terminal of IC 582. A 100 μF capacitor is also coupled between the VOUT1 terminals of IC 582 and ground. +1.8V appears at the VOUT1 terminals of IC 582. The VOUT2 terminals of IC 582 are coupled through the series combination of a 6.81 Kohm resistor and a 30.1 Kohm resistor to ground. The common terminal of the 6.81 Kohm and 30.1 Kohm resistors is coupled to the FB2 terminal of IC 582. A 100 μF capacitor is also coupled between the VOUT2 terminals of IC 582 and ground. +1.5V appears at the VOUT2 terminals of IC 582. The GND/HSINK, PPAD/HSINK and GND terminals of IC 582 are coupled to ground.

Referring now to FIGS. 20a-c, and as discussed above, the decoder can be made as a stand-alone unit, or can be rack-mountable including, for example, a card cage chassis adapted for receiving multiple, for example, sixteen, monitoring ports, (an) internal AC power supply(ies), connectors accessible from the back of the chassis, and status and power indicators readable from the front of the chassis. These options are illustrated in FIGS. 20a-c.

Referring to FIG. 20a, the single rack space rack mount includes a six pin connector 586 including a pin 1 coupled to +12V, pins 2 and 3 coupled to +5V, pins 4 and 5 coupled to ground, and a pin 6 coupled to −12V. Referring to FIG. 20b, the card cage option includes a 2×10+2 connector 588. Pins 2 and 4 of connector 588 are coupled to +12V. Pins 8, 10 and 12 are coupled to +5V. Pins 1 and 3 are coupled to −12V. Pins 7, 9, 11, 13 and 14 are coupled to the system LED1, LED2, LED3, LED4 and AUDIO_MONITOR lines, respectively. Pins 15-20, G1 and G2 are coupled to ground. Referring to FIG. 20c, the standalone option includes a five pin DIN connector 590, pin 5 of which is coupled to +12V. Pin 3 of connector 590 is coupled to +5V. Pin 4 is coupled to −12V. Pins 1 and 2 of connector 590 are coupled to ground.

Referring to FIG. 21, Power On is indicated by an LED 592 on the front panel. The anode of LED 592 is coupled through a 1 Kohm resistor to +5V. The cathode of LED 592 is coupled to ground. LED 592 illustratively is a Lumex type LXH103LID LED.

What is claimed is:

1. A network including a headend, the network serving a geographical area, the network including at least one source for providing a first signal related to a current or predicted condition of the geographic area, a decoder for decoding the first signal, the decoder transmitting the decoded first signal across the network, an encoder for receiving the decoded first signal and generating a second signal for transmitting across the network to user apparatus in the geographic area for reproduction by the user apparatus.

2. The apparatus of claim 1 wherein the decoder provides the capability for the encoder to request at least one of an audio file and audio packets.

3. The apparatus of claim 1 wherein the decoder is adapted to determine if the first signal is valid, and if the decoder determines that the first signal is not valid, not transmit the decoded first signal across the network.

4. The apparatus of claim 1 wherein the decoder is adapted to determine if the first signal is a duplicate of a previously received first signal, and if the decoder determines that the first signal is a duplicate, not transmit the decoded first signal across the network.

5. The apparatus of claim 1 wherein the decoder is adapted to permit at least one parameter to be established, and if the decoder determines that the received first signal does not meet the established at least one parameter, not transmit the decoded first signal across the network.

6. The apparatus of claim 5 wherein the at least one parameter is at least one of a specific geographical area and a specific event.

7. The apparatus of claim 1 wherein the decoder is adapted to record an audio first signal.

8. The apparatus of claim 1 including multiple encoders serving different geographical areas, the decoder being adapted to determine which of the multiple encoders serves the geographical area to which a first signal received by the decoder relates and transmit the decoded first signal across the network to that encoder.

9. The apparatus of claim 1 wherein the decoder is adapted to determine if the encoder is conditioned to receive the decoded first signal and generate the second signal for transmitting across the network to user apparatus in the geographic area, and if the decoder determines that the encoder is not conditioned to receive the decoded first signal and generate the second signal for transmitting across the network to user apparatus in the geographic area, queue the decoded first signal.

10. The apparatus of claim 9 wherein the decoder is adapted to queue the decoded first signal until at least one of the following events transpires: a subsequent first signal is received, the subsequent first signal having greater priority than said first signal; the encoder is conditioned to receive the decoded first signal; and, a time stamp associated with the first signal expires.

11. The apparatus of claim 1 wherein the decoder is adapted to respond to a request by the encoder for a decoded first signal by sending the requested decoded first signal over the network to the encoder.

12. The apparatus of claim 1 wherein the decoder includes memory for maintaining a log of received first signals.

13. The apparatus of claim 5 wherein the decoder includes memory for storing the at least one parameter and maintaining a log of received first signals.

14. The apparatus of claim 5 further including a computer coupled to the network, the at least one parameter being provided to the decoder from the computer.

15. The apparatus of claim 5 wherein the decoder is adapted to run a web server, the network being coupled to the Internet, the at least one parameter being provided to the decoder via the web server.

16. The apparatus of claim 1 adapted to decode Frequency Shift Keying.

17. The apparatus of claim 1 wherein the decoder is coupled to the network through an Ethernet port.

18. The apparatus of claim 1 wherein the network includes multiple branches, each branch including at least one source for providing a first signal related to a current or predicted condition of the geographic area served by that branch, a decoder for decoding first signals from the at least one source for providing first signals related to a current or predicted condition of the geographic area served by that branch, the decoder transmitting the decoded first signal from the at least one source for providing first signals related to a current or predicted condition of the geographic area served by that branch across the network, an encoder for receiving the decoded first signal and generating a second signal for transmitting across the network to user apparatus in the geographic area.

19. A method of delivering a decoded first signal related to a current or predicted condition of a geographic area across a network serving the geographical area to user apparatus, the network including a headend, at least one source for providing an undecoded first signal related to the current or predicted condition of the geographic area, the method comprising decoding the first signal, transmitting the decoded first signal across the network, receiving the decoded first signal and generating a second signal for transmitting across the network to user apparatus in the geographic area and reproducing the second signal on the user apparatus.

20. The method of claim 19 including requesting at least one of an audio file and audio packets.

21. The method of claim 19 including determining if the first signal is valid, and if the first signal is determined not to be valid, not transmitting the decoded first signal across the network.

22. The method of claim 19 including determining if the first signal is a duplicate of a previously received first signal, and if the first signal is determined to be a duplicate, not transmitting the decoded first signal across the network.

23. The method of claim 19 including permitting at least one parameter to be established, determining whether the received first signal meets the established at least one parameter, and if the received first signal is determined not to meet the established at least one parameter, not transmitting the decoded first signal across the network.

24. The method of claim 23 wherein permitting at least one parameter to be established includes permitting at least one of a specific geographical area and a specific event to be established as said at least one parameter.

25. The method of claim 19 including recording an audio first signal.

26. The method of claim 19 wherein receiving the decoded first signal and generating a second signal for transmitting across the network to user apparatus in the geographic area includes providing multiple encoders, each of the multiple encoders serving different geographical areas, determining which of the multiple encoders serves the geographical area to which a received first signal relates and transmitting the decoded first signal across the network to that encoder.

27. The method of claim 19 including determining if the encoder is conditioned to receive the decoded first signal and generate the second signal for transmitting across the network to user apparatus in the geographic area, and if the encoder is determined not to be in conditioned to receive the decoded first signal and generate the second signal for transmitting across the network to user apparatus in the geographic area, queueing the decoded first signal for subsequent transmission.

28. The method of claim 27 wherein queueing the decoded first signal for subsequent transmission includes queueing the decoded first signal for subsequent transmission until at least one of the following events transpires: a subsequent first signal is received, the subsequent first signal having greater priority than said first signal; the encoder is conditioned to receive the decoded first signal; and, a time stamp associated with the first signal expires.

29. The method of claim 19 including responding to a request by the encoder for a decoded first signal by sending the requested decoded first signal over the network to the encoder.

30. The method of claim 19 including maintaining a log of received first signals.

31. The method of claim 23 including storing the at least one parameter and maintaining a log of received first signals.

32. The method of claim 23 further including providing the at least one parameter to the decoder from a computer.

33. The method of claim 23 including coupling the network to the Internet and providing the at least one parameter to the decoder via a web server.

34. The method of claim 19 including decoding Frequency Shift Keying.

35. The method of claim 19 including coupling the decoder to the network through an Ethernet port.

36. The method of claim 19 wherein the network includes multiple branches, each branch including at least one source for providing a first signal related to a current or predicted condition of the geographic area served by that branch, the method including decoding first signals from the at least one source for providing first signals related to a current or predicted condition of the geographic area served by that branch, transmitting the decoded first signal from the at least one source for providing first signals related to a current or predicted condition of the geographic area served by that branch across the network, receiving the decoded first signal, and generating a second signal for transmitting across the network to user apparatus in the geographic area.

37. A device including an input port for receiving Emergency Alert System (EAS)-formatted information, the device translating the EAS-formatted information to a second format, the device including an output port at which the information translated into the second format is provided.

38. The device of claim 37 wherein the output port at which the information translated into the second format is provided comprises an output port at which the information translated into Transmission Control Protocol/Internet Protocol (TCP/IP) is provided.

39. The apparatus of claim 1 adapted to decode Dual Tone Multi-Frequency (DTMF) tones.

40. The apparatus of claim 1 adapted to decode a sensor input via an analog-to-digital (A/D) converter.

41. The method of claim 19 including decoding Dual Tone Multi-Frequency (DTMF) tones.

42. The method of claim 19 including decoding a sensor input via an analog-to-digital (A/D) converter.
